(19) United States
(12) Patent Application Publication
(10) Pub. No.: US 2023/0069223 A1
(43) Pub. Date: Mar. 2, 2023

(54) VERIFIED TRANSACTIONS THROUGH INTEGRATIONS

(71) Applicant: Block, Inc., San Francisco, CA (US)

(72) Inventors: Disha Patel, San Francisco, CA (US); Natalie Tarabay, San Francisco, CA (US); Alexander Leung, Ontario (CA)

(21) Appl. No.: 17/552,347

(22) Filed: Dec. 15, 2021

Related U.S. Application Data
(60) Provisional application No. 63/239,413, filed on Sep. 1, 2021.

(51) Int. Cl. G06Q 20/38; G06Q 20/06; G06K 9/62; G06N 20/00

(52) U.S. Cl. CPC G06Q 20/38215; G06Q 20/389; G06Q 20/065; G06K 9/6256; G06N 20/00

(57) ABSTRACT

Verified transactions through integrations of social network and payment service computing platforms are described. A payment service computing platform may generate a token associated with a first account associated with a payment service, the token being configured to facilitate a number of transfers of an amount from the first account to one or more second accounts. The payment service computing platform may further receive a first request, from an electronic device of a second user associated with the one or more second accounts, to redeem the amount associated with the token, facilitate acquisition of one or more assets for the second user, wherein the one or more assets are determined by the second user or based at least in part on a machine-learning model trained to infer a preference of the first or second user, and associate the one or more assets with a second account of the second user.

### CROSS REFERENCE TO RELATED APPLICATION

This patent application claims priority to U.S. Provisional Patent Application Ser. No. 63/239,413, filed Sep. 1, 2021, which is hereby incorporated in its entirety by reference.

### TECHNICAL FIELD

Payment service computing platforms may allow the efficient transfer of funds between users. In some examples, such users can be “peers” in a “peer-to-peer” transaction. In some examples, such users can be a merchant and a customer in a transaction. A payment service computing platform may provide and service a mobile application that allows users to navigate to a user interface (UI) within the mobile application to facilitate such transfers. The UI can facilitate additional or alternative operations as availed through the payment service computing platform.

### BRIEF DESCRIPTION OF THE DRAWINGS

FIG. 1A is a first example of an environment for performing techniques described herein, according to an embodiment of the present subject matter.

FIG. 1B is a second example of an environment for performing techniques described herein, according to an embodiment of the present subject matter.

FIG. 1C is a third example of an environment for performing techniques described herein, according to an embodiment of the present subject matter.

FIG. 2 is a flow diagram of a method for generating unalterable trust signals to enable a first user to confirm the identity of a second user prior to initiating a payment transaction, according to an embodiment of the present subject matter.

FIG. 3 is a flow diagram of a method for transferring, or preventing a transfer of, an electronic payment from a first user to a second user based on a social trust score, according to an embodiment of the present subject matter.

FIGS. 4A-4I are one or more running examples for generating unalterable trust signals to enable a first user to confirm the identity of a second user prior to initiating a payment transaction, according to an embodiment of the present subject matter.

FIG. 5 is a flow diagram of a method for enabling users purchase one or more assets or to mirror an allocation of assets of another user, according to an embodiment of the present subject matter.

FIG. 6 is a flow diagram of a method for enabling users to create, customize, or share asset profiles, according to an embodiment of the present subject matter.

FIGS. 7A-7T are one or more running examples for enabling users to create, customize, or share asset profiles, according to an embodiment of the present subject matter.

FIGS. 7U-7X are one or more running examples for enabling users to purchase one or more assets or to mirror an allocation of assets of another user, according to an embodiment of the present subject matter.

FIG. 8 is a flow diagram of a method for providing a token that may be shared publicly, activated for redemption, or applied to purchase one or more assets, according to an embodiment of the present subject matter.

FIG. 9 is a flow diagram of a method for transferring ownership interest in an asset based on a redeemed token or associating the ownership interested in the asset with an asset profile, according to an embodiment of the present subject matter.

FIGS. 10A-10D are one or more running examples for providing a token that may be shared publicly, according to an embodiment of the present subject matter.

FIGS. 10E-100 are one or more running examples for providing a token that may be shared between users, according to an embodiment of the present subject matter.

FIG. 11 is an example environment of a server(s) that can communicate over a network with user devices to enable verified transactions through integrations of social network and payment service computing platforms, according to an embodiment of the present subject matter.

FIG. 12 is an example environment of a server(s) that can communicate over a network with user devices to enable verified transactions through integrations of social network and payment service computing platforms, according to an embodiment of the present subject matter.

FIG. 13 illustrates example data store(s) that can be associated with an example environment, according to an embodiment of the present subject matter.

FIG. 14 is an example environment where the environment of FIG. 11 is integrated with the environment of FIG. 12 to enable payments at the point-of-sale using assets associated with user accounts, according to an embodiment of the present subject matter.

FIG. 15 is an illustrative block diagram illustrating a system for performing techniques described herein, according to an embodiment of the present subject matter.

### DETAILED DESCRIPTION

Verified transactions through integrations of social network and payment service computing platforms are described. In an example, such integrations can facilitate generation of unalterable “trust signals” for improving the accuracy and security of payment transactions between users of the payment service computing platform. Trust signals, in one example, can be described as quantitative indicators of a level of trust associated with an individual transaction. In an additional or alternative example, such integrations can facilitate the creation, customization, or sharing of profiles (e.g., asset profiles), which can, in an example, enable users to quickly and effortlessly purchase assets based on other users' asset profiles. Further, such integrations can enable transfers of redeemable tokens between users of the social network or payment service computing platforms. Redeemable tokens can be used for purchasing assets, or portions thereof, automatically without further input from recipient users.

A payment application serviced by a payment service computing platform may facilitate transactions and other operations as described herein. In at least one example, the payment application can allow efficient transfer of assets (e.g., fiat currency, securities (e.g., stocks, bonds, mutual funds), cryptocurrencies, gift cards, etc.) between users. Such transfers can be “efficient” in that they can happen electronically, in real-time or near real-time, due to a complex integration of software and hardware components configured to facilitate such transfers. In some examples, a transfer of assets can be between two or more users who are “peers” in a “peer-to-peer” transaction. In some examples, a transfer of assets can be between a merchant and a customer.

Electronic payments or other transfers of assets, such as those facilitated by the payment service computing platform described herein, introduce problems that did not exist prior to the introduction of such electronic payments or other transfers of assets. For example, when a transaction is performed using cash, the payor hands the payee the cash and can confirm that the payee is in fact the intended payee. Further, if the payee is not the intended payee, the payor can refrain from making the payment. Similarly, in conventional technologies, many transfers of funds that are not cash transfers utilize a complex network of banks, which require rigorous identity verification and other techniques to ensure payments are made to the proper payee. With electronic payments or other transfers of assets, such as those facilitated by the payment service computing platform described herein, identities of payees can be more difficult to ascertain and, once an electronic payment is made, reversing or refunding the electronic payment can be difficult if not impossible. If a refund is possible, such refunds can be slow and computationally costly in that several network calls and data transmissions can be necessitated to effectuate such refunds.

For example, a sending user or a payor may transfer an electronic payment to an unintended recipient user or payee “Jane Smith 1” before realizing that the actual intended recipient user is “Jane Smith 2.” In this example, the unintended recipient user may be accidently and inadvertently identified as the recipient user, or the unintended recipient user may have fraudulently induced the sending user to send them the payment. For example, in an attempt to deceive sending users, the unintended recipient “Jane Smith 1” may have copied the user profile information of “Jane Smith 2” into a user-created profile (e.g., using a picture of “Jane Smith 2”), and there may be no way for sending users to ensure the veracity of this information. Upon realizing the misdirected payment, the sending user may request a reversal of the transaction from the payment service or request repayment from the unintended recipient. The reversal process can involve the sending user initiating a payment dispute process with the payment service, which may include cumbersome, complex, and time-consuming tasks to be performed by the sending user before the erroneous electronic payment can be repaid. In such an example, the processes for reversing an unintended, or fraudulently induced payment, are inefficient and consume computing resources of the payment system and respective user electronic devices. As noted above, some erroneous payments are not reversible.

Verified transactions through integrations of social network and payment service computing platforms are described. In some examples, techniques described herein relate to a payment service computing platform that leverages integrations with social network platform(s) to mitigate misdirected or fraudulent payments, such as those described above with reference to “Jane Smith 1” and “Jane Smith 2.” For instance, at a time of a payment between two or more users, the payment service computing platform can access historical data from the payment service computing platform (e.g., user data stored in a data store of the payment service computing platform) or third-party data received from third-party computing platform(s) integrated with the payment service computing platform (e.g., social network computing platform(s)) to generate “trust signals.” A “trust signal,” as used herein, may be an indicator of a level of trust associated with an individual transaction. For example, a trust signal may be indicative of a likelihood that a potential recipient of a payment is a known, or correct, recipient. In some examples, trust signals can be based on social nodes, which can predicate for example whether a pre-existing relationship exists between the two users or if there is a potential for these two users to engage in a transaction. That is, social nodes, as used herein, can refer to nodes that are representative of previous relationships or interactions between users, or other users that are socially connected to such users, and these social nodes may be indicative of levels of trust associated with individual transactions. In some examples, social nodes can be quantitative representations of previous relationships or interactions. A trust signal, however, does not necessarily correspond to an association (or a relationship) between users. For example, a trust signal can include an amount of time a potential recipient user has used the payment service.

Individual users can be shown indications of trust signals—via user interfaces presented by payment applications of the payment service computing platform—to ensure a known, or correct, recipient is receiving the payment. In some examples, the indications of the trust signals may include an amount of time a potential recipient user has used the payment service, whether a potential recipient user can be found in a set of contacts of a sending user (e.g., based on a contacts list), a number of users who have also completed electronic payments with, or otherwise interacted with, a potential recipient user whose user profile is being viewed by a sending user (e.g., “Jane Smith 2 has received payments from 10 users associated with you”), degrees of separation between the two users (e.g., “someone you know received payments from Jane Smith 2”), the presence or absence of an indirect relationship, or the like. In some examples, the trust signals can further be constructed based on user transaction data, which may include user purchase history, user payment history, user attributes, user credit history, user assets, and so forth, as tracked over time by the payment service computing platform. In some examples, indications of these trust signals can be public (i.e., viewable to any user of the payment service computing platform), unalterable (e.g., “read-only”), anonymized (i.e., having had identifying particulars or details of users mentioned therein removed), or the like when presented to users of the payment service computing platform. Indications of such trust signals can be useful for verifying recipients or mitigating misdirected or fraudulent payments. As an example, if Abby is transferring Bobby funds via a transaction, the payment service computing platform can show Abby the social network connections or payment history between Bobby and other users known with certainty to be associated with Abby. This can ensure that Bobby is the correct recipient of the funds.

In some examples, two or more of the trust signals may be combined and summarized by the payment service computing platform to generate a social trust score corresponding to the user profile of the potential recipient user. In some examples, a social trust score can be a quantitative representation of trust between two or more users and can be determined based at least in part on combining and weighting individual trust signals. In some examples, the trust signals can be used to generate social trust scores that can be determined based on machine-trained models (e.g., models trained by machine-learning mechanisms, such as unsupervised machine-learning, supervising machine-learning, deep learning, and so forth), statistical models, or the like. In some examples, a social trust score may be used to determine whether to prevent an electronic payment or to request confirmation from the sending user before proceeding with an electronic payment. That is, in some examples, social trust scores can be compared to a threshold or other metric to determine whether to modify or otherwise alter a conventional payment process to prevent an electronic payment or to request confirmation from the sending user before proceeding with an electronic payment. The threshold can be personalized or customized for a sending user, for example, based on preferences of the sending user or a risk metric associated with the sending user, which in some examples, can be based on transaction data or other interaction data associated with the sending user.

As described above, techniques described herein may improve payment service systems and associated computing platforms by providing for automated, scalable generation of one or more trust signals that may increase confidence that the user corresponding to the user profile being viewed by the sending user is indeed the intended recipient user. By de-identifying and anonymizing users in the indications of the trust signals, the privacy of those users can be respected and enforced. Accordingly, the described techniques may thus reduce the possibility of sending users inadvertently, or fraudulently, providing electronic payments to unintended recipient users, and further streamline the processing workload and data store management of the payment service computing platform by reducing instances of payment disputes due to accidental transfers, requesting and completing return transactions, and so forth. Specifically, by providing indications of the trust signals to preempt users from sending erroneous electronic payments and other electronic financial transactions and the subsequent reversal processes, the size, complexity, and capacity of the data centers and servers hosting the payment service computing platform may be reduced due to reduced processing workload (e.g., less tasks, applications, requests, and so forth) and gratuitous creation of data store instances (e.g., payment disputes due to accidental transfers or other potentially unnecessary system flagging of electronic payment transactions).

Existing technologies also lack the ability for users to engage in transactions socially. Accordingly, in some examples, techniques described herein can leverage the integration of social network and payment service computing platforms to facilitate “social investing.” That is, in at least one example, the payment service computing platform can enable users to purchase assets (e.g., securities, cryptocurrencies, gift cards, etc.) that substantially “mirror” the asset allocations (e.g., asset allocation percentages) of other users, such as friends, influencers, or other social network connections. As an example, if 60% of Charlie's asset allocation is Company A stock and 40% Bitcoin, the payment service computing platform can enable Danielle to invest in a manner that mirrors Charlie's asset allocation with minimal effort (e.g., fewer interactions with the payment service computing platform than in conventional technologies). “Mirroring” or “mimicking” an asset allocation can mean an exact replica of the asset allocation, or a substantially similar asset allocation. Continuing with the example above, Danielle can “mirror” Charlie's asset allocation by investing a specified value amount (e.g., $100) that is allocated as 60% Company A stock and 40% Bitcoin. As another example, Danielle's asset allocation may be similar, but different, than Charlie's (e.g., Danielle's asset allocation may be 65% Company A stock and 35% Bitcoin). In this example, Danielle's asset allocation may be considered as “mirroring” Charlie's asset allocation if her asset allocation shares an attribute with Charlie's (e.g., invest more in Company A stock than in Bitcoin). Accordingly, “mirroring,” as used herein, does not have to result in the exact same asset allocation or asset class, but can represent allocations or asset classes that have common attribute(s), such as same or similar performance, same or similar volatility, same or similar assets, same or similar diversification, same or similar returns, same or similar industry, etc. The ability to seamlessly mirror the asset allocation strategy of a particular user or group of users further improves the operational capacity of the payment service computing platform by streamlining the processes for discovering and placing orders, allowing for computational resources to be more appropriately used.

In particular examples, in addition to selecting to “mirror” the asset allocation percentages of the one or more users, a user (e.g., Danielle, in the example above) may also input the specified value amount to be used for purchasing an asset(s). Based at least in part on the mirrored asset allocation percentages and the specified value amount, the payment service computing platform may determine whole units or fractional units for each of the assets to be purchased in accordance with the specified value amount to mirror the asset allocation percentages of the one or more users. As an example, the payment service computing platform may determine a weighting value based on the mirrored asset allocation percentages and apply the weighting value to the specified value amount. This may determine the amount that will be used to purchase the assets, and if that amount is insufficient to purchase whole units of the assets, then fractional units may be purchased, which is an improvement upon existing technologies that do not allow for purchasing fractional units. In an example, if $30 of the specified value amount is allocated to the purchase of Company A stock, where the share price of Company A stock is $60 per share, then a half (0.5) unit of Company A stock may be purchased. In some examples, a ledger system can be used to facilitate such fractional purchases. Such a ledger system can reduce interactions between the payment service computing platform and external asset networks (e.g., cryptocurrency exchanges, stock exchanges, etc.) such that external transactions can be batched and performed at times other than when assets are transferred or otherwise purchased using techniques described herein. The ledger system can therefore enable real-time transactions without the delay caused by conventional techniques. The payment service computing platform, according to the techniques described herein, therefore provides further simplified procedures for placing and initiating orders for the selected assets.

In order to enable users to mirror other user asset allocations, users may be permitted to share asset “profiles” among groups of users of the payment service computing platform or third-party computing platforms. The groups of users may be user-defined or generated by a machine-learning model trained to identify groups of users according to relevant criteria for an individual user. For example, in particular examples, a machine-learning model (e.g., unsupervised machine-learning, supervising machine-learning, deep learning, and so forth) may be trained and retrained over time utilizing the vast (e.g., “big data”) user transaction data that may be stored on the databases of payment service computing platform, such that the machine-learning models may accurately identify groups of users likely to influence and cause the user to engage more purposefully with the payment service computing platform. The groups of users may each have respective asset profiles and associated assets that may be serviced by the payment service computing platform or third-party computing platforms. In particular examples, the respective user asset profiles may each include performance metrics, assets owned by the user, asset allocations (e.g., asset allocation percentages), asset time held metrics, and users or assets interacted with by other users, all of which may be individually, privately, or publicly shared based on user preference. Through the generation, storage, and sharing of the asset profiles, the payment service computing platform may engender more efficient discovery of asset acquisition techniques, individual assets or groups of assets, or techniques employed by like-minded individuals. Moreover, the reduction in time spent by users searching for and initiating individual asset transfers reduces computational resources.

In some examples, shared asset profiles can be viewable by users of the payment service computing platform or third-party computing platforms. In some examples, users may control how much of their asset profile is public or private at any point in time. For example, in particular examples, an individual user may limit viewing, interacting, “mirroring,” or other access to all or some aspects of her asset profile to specified users (e.g., gated by request), her following users, or a “friend” network. In particular examples, the individual user may also restrict viewing, interacting, “mirroring,” or other access to all or some aspects of her asset profile by deploying a paywall enabled by the payment service computing platform, such that the individual user may solicit payed subscriptions to access her asset profile. Therefore, the payment service computing platform may utilize permissions or rules to maintain appropriate levels of user privacy while enabling the sharing and seamless adoption of user-generated asset information and advice.

In particular examples, individual users may share their asset profiles with entities external to the payment service computing platform (e.g., third-party computing platforms(s)). For example, in particular examples, individual users may share images, videos, dynamic webpage links, quick response (QR) codes, augmented reality (AR) or virtual reality (VR) objects, or one or more other instances corresponding to their asset profiles via multimedia messaging, email, social media posting, social media ephemeral content, AR/VR object interactions, and so forth. These features may allow individual users to expand their community of investors by allowing the individual users to invite and influence external entities to interact with their asset profiles and encourage engagement, all the while controlling how much of the user's asset profile is viewable at any point in time. In particular examples, individual users may also be allowed to create, customize, and manage pooled funds, in which the individual user can purchase and sell assets on behalf of a group of users having the same determined interest or other association to the individual user. For example, users can create a pool of investors based at least in part on social connections. That is, a group of similar (e.g., based on machine-learning models or user data) users can form a community for sharing investing tips and, in some examples, for pooling funds to purchase assets. Such social network and payment platform integration can facilitate such asset communities and social investing.

Thus, in accordance with the forgoing examples, a payment service computing platform may prompt and encourage users to interact and engage with the payment service computing platform more frequently. For example, activities such as (e.g., creating, updating, and customizing user asset profiles, sharing asset profiles with “friends” on the platform or external to the platform, managing and adjusting asset allocation percentages based on real-time market data and user interaction data, communicating asset strategies among “friends” or “followers,” all provide additional features to the payment service computing platform and efficiently encourage financial literacy and engagement without materially impacting the use of the computational resources of the payment service computing platform and interacting devices. Additionally, the foregoing examples may allow users to better understand and manage the risks of their assets and to pool with other investors having similar interests determined based on machine-learning surfaced data, such as user interaction data, transaction history data, or data associating a group of users.

Further, by allowing individual users to share and “mirror” the asset allocation percentages of one or more “friend” users or other users the individual user “follows,” the foregoing examples may streamline the processing workload and data store management of the payment service computing platform by reducing instances of high-frequency purchasing and selling of individual assets and by reducing the number of iterations of purchases of individual assets (e.g., since “mirroring” allows for the individual assets to be purchased all at once as a package). Specifically, by allowing individual users to share and “mirror” the asset allocation percentages of one or more “friend” users or other users the individual user “follows,” the size, complexity, and capacity of the data centers and servers hosting the payment service computing platform may be reduced due to reduced scaling of processing workload resources (e.g., reduced tasks, reduced applications, reduced requests, and so forth) and data store capacity (e.g., reduced scaling of data store management and capacity for individual instances of individual assets of each of thousands or millions of users).

Moreover, in some examples, the payment service computing platform can utilize integrations with social network computing platforms to enable users to gift assets, or portions thereof, to other users via “tokens.” That is, a user can transfer assets or funds for acquiring assets to other users via the payment service computing platform or via a social network computing platform on acceptance of the gift via application of a token. In some examples, the acceptance of a token (or interaction therewith) can cause the transfer or purchase of an asset associated therewith automatically (without further interaction or input from the recipient). In some examples, tokens may be shared publicly by a first party, activated for redemption by a second party, and applied to purchase one or more assets by the second party. In particular examples, through offering purchase of fractional shares of any asset and providing immediate transfer of asset ownership through the use of payment service holding accounts, the payment service computing platform may provide features that are impracticable in traditional investing or asset acquisition platforms. That is, in traditional investing or asset acquisition platforms, fractional shares are not feasible. Further, gifting of assets or portions thereof is not feasible. To facilitate such gifting using conventional technologies would be time intensive and too slow to be practical.

In some examples, techniques described herein utilize a token that may be shared publicly, activated for redemption by a user, or applied to purchase an asset regardless of the asset's base price. In some examples, tokens may be shared in a variety of suitable formats, including, for example, dynamic webpage links, alphanumeric identifiers, images, videos, non-fungible tokens (NFTs), QR codes, and one or more augmented reality (AR) virtual reality (VR) objects, or extended reality (XR) objects or other instances, and may further be shared along any communication media including multimedia messaging, email, social media posting, social media ephemeral content, AR/VR/XR object interactions, and so forth. The token may be used by the payment service to grow its user base, by individual users to send gifts or bargain “boosts” (e.g., a percentage off, a cash-back offer, a “round-up” stock or cryptocurrency offer, etc.) by brands to incentivize asset ownership, by users of the payment service to increase their following on the payment service, and so forth. Such gifting can streamline the purchase or sale of assets that are not easily or conventionally gifted as described herein. In some examples, above-referenced techniques for mitigating misdirected or fraudulent payments or facilitating social investing can be applied to gifting as described herein.

In particular examples, the payment service computing platform may utilize one or more machine-learning models to generally facilitate social commerce, and more specifically, infer interests of the recipient user and recommend or determine assets to which the token may be applied. The payment service computing platform may use the machine-learning model(s) to analyze transaction data and/or user interaction data associated with users of the payment service already having asset profiles to identify and recommend assets, asset profiles, or asset profiles to the users upon redemption of the token. In particular examples, recommendations may be based on, for example, a transaction history of or involving the user on the payment service, friends or contacts of the user who are members of the payment service, the asset profile of the friends or contacts of the user, other users similar to the user, and so forth. That is, techniques described herein can generate personalized or customized recommendations relating to assets to be gifted to other users, user profiles to be followed, or redemptions of gifted funds.

Thus, the present techniques are directed toward providing a payment service computing platform that utilizes machine-learning model(s) to infer interests of individual users and recommends and determines assets to which a token can be applied. For example, in certain examples, the payment service computing platform may analyze transaction data and user interaction data associated with users on the payment service computing platform already having asset profiles to identify and recommend assets, asset profiles, or asset profiles to the individual users upon redemption of the token, or automatically purchase the assets on behalf of the user or the user who has gifted or initiated the token. Recommendations may be based on, for example, a transaction history of or involving the user on the payment service, friends or contacts of the user who are members of the payment service, the asset profile of the friends or contacts of the user, other users similar to the user, and so forth. In addition to performing functions that would be otherwise impractical in typical asset transfer platforms, the payment service computing platform embodying the techniques described herein may facilitate more efficient discovery of assets of interest to individual users. This reduces the time spent searching for assets, reduces potential confusion of the individual users, and reduces the computational resources devoted by the payment service computing platform and associated electronic devices during otherwise inefficient searches. For example, repeatedly mining large sets of data for each and every user may be computationally expensive, and thus by providing techniques utilizing machine-learning model(s) to infer interests of individual users, the processing workloads of the computational resources devoted by the payment service computing platform may be markedly reduced (e.g., by reducing redundant data mining or other data searching).

In particular examples, techniques described herein may encourage and prompt users of the payment service that do not yet have an asset profile or one or more external entities to interact and engage with the payment service computing platform more frequently and more purposefully. For example, in particular examples, the payment service computing platform may identify and recommend an offer for an asset (e.g., predetermined value amount of cryptocurrency, a certificate of deposit, one or more stock shares, and so forth) to the one or more users or the one or more external entities that may be redeemed upon the one or more users or the one or more external entities registering an account with the payment service or creating an asset profile. In this way, the present examples may prompt and influence users on the payment service computing platform that do not yet have an asset profile or one or more external entities to interact and engage with the payment service computing platform more frequently and more purposefully. This may further streamline the processing workload and data store management of the payment service computing platform by limiting advertisements and communications to only targeted users determined based on inferred user interests and the determined likelihood that these users will interact and engage with the payment service computing platform.

Further, as described herein, the integration of the payment service computing platform with social network computing platforms can utilize a ledger system (e.g., internal ledgers, external ledgers, distributed ledgers, etc.) to facilitate the transfer of ownership interest (e.g., in fractional units) of assets when users engage in electronic payments, social investing, or gifting with tokens. In particular examples, through offering purchase of fractional shares (which are not feasible in traditional investing platforms) of any asset and providing immediate transfer of asset ownership through the use of payment service holding accounts (e.g., “wallets”), the payment service computing platform may provide features that are impracticable in traditional investing platforms. For example, even when an exchange market is closed, a transfer of ownership of an asset may still occur because the payment service can purchase assets in advance and maintain the assets in payment service holding accounts for users to acquire at any time, including at times when an exchange market may be closed, all while keeping track of credits and debits through the use of ledgers, as described herein. Further, in the case of cryptocurrency, wherein transactions are known to be slow and require significant computing resources, the ledger system can enable transfers of ownership in real-time or near real-time, which provides an improvement over existing, conventional techniques.

Further, user interface improvements are disclosed herein, such as user interface improvements that minimizing the number of user interactions with a user interface displayed on an electronic device at times when users are engaged in electronic payments, social investing, or gifting with tokens. For instance, the example user interfaces that enable users to mirror the asset allocation of another user on the payment service computing platform, as well as the methods/operations of displaying those user interfaces, or the methods/operations of receiving user input via those user interfaces, as described herein, can allow a user to seamlessly mirror the asset allocation strategy of a particular user or group of users in a just a few interactions with a user interface (e.g., a few “clicks”). Such user interface improvements help to conserve computing resources. Additional or alternative problems and solutions are described below.

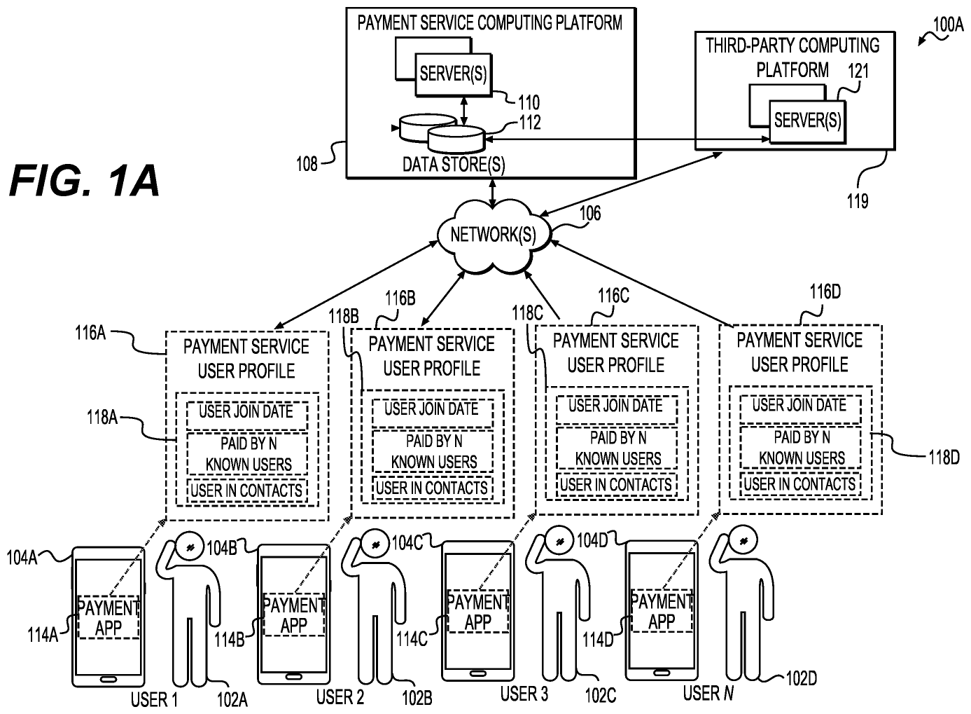

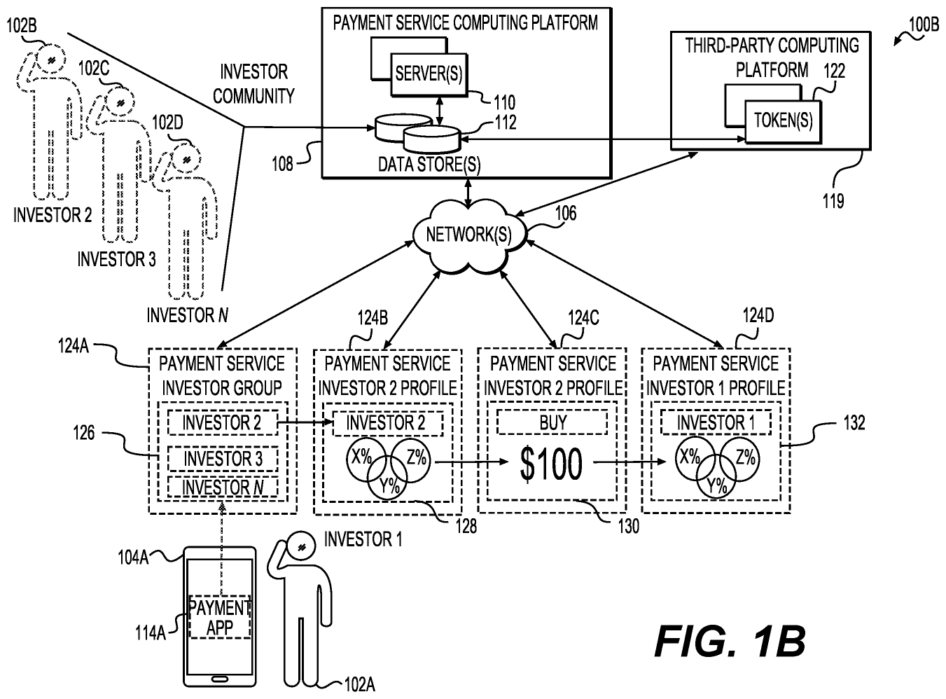

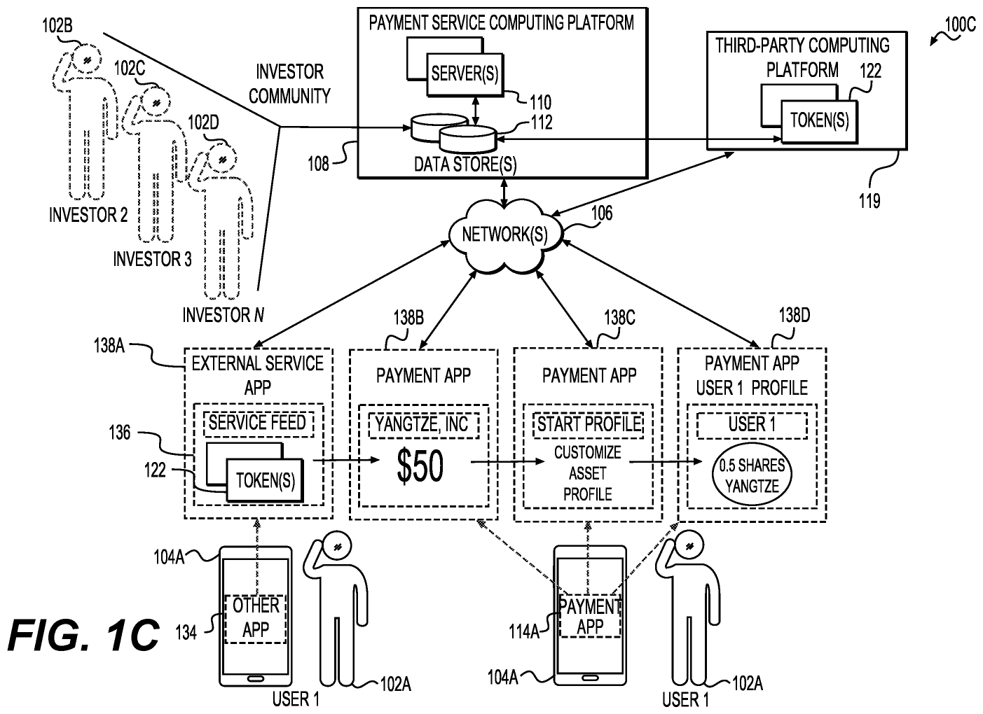

Techniques described herein can be performed by functional components of an environment. FIGS. 1A-1C illustrates three instances of the environment in which techniques described herein can be performed.

FIG. 1A illustrates an example environment 100A that may be suitable for a payment service computing platform to utilize integrations with social network platform(s). For example, the environment 100A may be suitable for generating trust signals using data collected by the payment service computing platform during routine operations to facilitate sending users ensuring that a selected recipient is an intended recipient, particularly in the context of an electronic payment or asset transfer, in accordance with presently disclosed examples. As depicted, the example environment 100A may include a number of users 102A, 102B, 102C, and 102D each being associated with respective user electronic devices 104A, 104B, 104C, and 104D that may be suitable for allowing the number of users 102A, 102B, 102C, and 102D to utilize respective applications, e.g., payment applications 114A, 114B, 114C, and 114D. The payment applications 114A-D may allow the respective users 102A-D to navigate to the various user interfaces described herein, to make electronic payments with other users (e.g., personal users, merchants, etc.), to purchase, or otherwise acquire, assets, to engage in social investing (e.g., mirroring asset allocations of other users), or to gift tokens that are redeemable for assets. In some examples, the payment applications 114A, 114B, 114C, and 114D can be different instances of a same payment application, which can be provided by the payment service computing platform 108.

As depicted by FIG. 1A, the respective user electronic devices 104A, 104B, 104C, and 104D may be coupled to a payment service computing platform 108 via one or more network(s) 106. In particular examples, the one or more network(s) 106 may include, for example, any of various wireless communications networks (e.g., cloud network, wireless local area network (WLAN), wide area network (WAN), personal area network (PAN), cellular network, wireless mesh network (WMN), WiMAX, generative adversarial networks (GAN), IPv6 over Low-Power Wireless PAN (6LowPAN), and so forth) that may be suitable for communicatively coupling the respective user electronic devices 104A, 104B, 104C, and 104D to the payment service computing platform 108.

In particular examples, the payment service computing platform 108 may include, for example, a cloud-based computing architecture suitable for hosting and servicing the respective payment applications 114A, 114B, 114C, and 114D executing on the respective user electronic devices 104A, 104B, 104C, and 104D. For example, in particular examples, the payment service computing platform 108 may include a Platform as a Service (PaaS) architecture, a Software as a Service (SaaS) architecture, and an Infrastructure as a Service (IaaS), Data as a Service (DaaS), Compute as a Service (CaaS), or other similar cloud-based computing architecture (e.g., “X” as a Service (XaaS)). The payment service computing platform 108 may be used to implement an associated payment service, as described herein.

In particular examples, as further depicted by FIG. 1A, the payment service computing platform 108 may include one or more processing devices 110 (e.g., servers) and one or more data stores 112. For example, in particular examples, the one or more processing devices 110 (e.g., servers) may include one or more general purpose processors, graphic processing units (GPUs), application-specific integrated circuits (ASICs), systems-on-chip (SoCs), microcontrollers, a field-programmable gate arrays (FPGAs), central processing unit (CPUs), application processor (Aps), visual processing units (VPUs), neural processing units (NPUs), neural decision processors (NDPs), or any other processing device(s) that may be suitable for providing processing or computing support for the respective payment applications 114A, 114B, 114C, and 114D executing on the respective user electronic devices 104A, 104B, 104C, and 104D. Similarly, the data stores 112 may include, for example, one or more internal data stores that may be utilized to store information (e.g., user transaction history data, user purchase history data, user attribute data, user credit history data, user asset profile data, user contextual data, user interaction data, user preference data, and so forth) associated with the respective number of users 102A, 102B, 102C, and 102D. Additional information associated with the data stores 112 is provided below.

In particular examples, the one or more data stores 112 may include, for example, one or more data structures designed for recording asset ownership for various users 102A, 102B, 102C, and 102D. As an example and not by way of limitation, the payment service computing platform 108 may store one or more ledgers (e.g., internal ledgers, external ledgers, distributed ledgers, etc.) for tracking assets held by the payment service computing platform 108—each such asset being held by the payment service computing platform 108 may be owned in whole or in part by the payment service computing platform 108 itself or in whole or in part by one or more users of the payment service computing platform 108. The ledger(s) may store service balances associated with the payment service computing platform 108 representing quantities of assets held by the payment service computing platform 108. The service balances may include, for example, a fiat currency balance for each of one or more fiat currencies, a securities balance for each of one or more security assets, a cryptocurrency balance for each of one or more cryptocurrencies, other suitable data records, or any combination thereof. The payment service computing platform 108 may also store additional ledgers for each of a number of users 102A, 102B, 102C, and 102D. The ledger(s) may be stored as part of a user profile or asset profile for each of the users 102A, 102B, 102C, and 102D.

One or more ledgers may store user balances representing quantities of assets held by the payment service computing platform 108 and owned by one or more users 102A, 102B, 102C, and 102D. User balances may have similar contents to the service balances. The payment service computing platform 108 may use other data structures suitable for storing information representing ownership of assets. In some examples, user profiles or asset profiles can include ledgers (e.g., cryptocurrency ledgers, fiat currency ledgers, etc.) for any accounts managed by the payment service computing platform 108 on behalf of the users. In some examples, ledgers are logical ledgers, and the actual data can be represented in a single database. A ledger can reflect a credit when an account is funded. An account can be funded by transferring an asset in the form associated with the account from an external account (e.g., transferring a value of cryptocurrency to the payment service and the value is credited as a balance in a cryptocurrency ledger), by purchasing an asset in the form associated with the account from the payment service using an asset in a different form (e.g., buying a value of cryptocurrency from the payment service using a value of fiat currency reflected in a fiat currency ledger, and crediting the value of cryptocurrency in a cryptocurrency ledger), or by conducting a transaction with another user (customer or merchant) of the payment service wherein the account receives an asset. In some examples, the ledger can reflect a debit when assets are withdrawn from the account, for example. An asset(s) may be withdrawn from an account based on an electronic payment between users (a “payment” being a transfer of assets from one user to another user), a purchase or sale of an item, a transfer of an asset from one account to another account, a conversion of an asset from one form to another form, or the like. While in some examples, the present disclosure refers to crediting or debiting a ledger with a value, it can be appreciated that, in some examples, the actual value that is credited or debited may actually be slightly greater or less than the stated value to account for transaction fees or exchange rates. Additional details associated with the ledger system are provided below.

In particular examples, the payment service computing platform 108 may be a hosting and servicing platform for the respective payment applications 114A, 114B, 114C, and 114D executing on the respective user electronic devices 104A, 104B, 104C, and 104D. For example, in particular examples, as further depicted by FIG. 1A, the respective payment applications 114A, 114B, 114C, and 114D may each include, for example, respective user interfaces 116A, 116B, 116C, and 116D for displaying, among other data, respective user profiles (e.g., “Payment Service User Profile”), or information associated therewith, associated with users 102A, 102B, 102C, 102D and performing electronic payments between the one or more of users 102A, 102B, 102C, and 102D, merchant purchases by one or more of users 102A, 102B, 102C, and 102D, electronic trading of assets by one or more of users 102A, 102B, 102C, and 102D, and so forth.

In particular examples, in accordance with the presently disclosed techniques, the payment service computing platform 108 may be utilized to generate trust signals, which can be used to present indications thereof, as represented by 118A, 118B, 118C, and 118D. That is, for the purpose of this discussion, a trust signal can comprise a signal, or other indication, that is associated with a user of the payment service computing platform 108 that can indicate credibility (or “trust”) of a user to enter into a financial relationship with another user on the payment platform. In some examples, trust signals can be based on social nodes, which can be used to define and memorialize, in a digital format, a user's relationships—explicitly or implicitly—with other people. Social nodes may be digital representations of online communities to which a user belongs, often including the members of such communities (e.g., a family, a group of friends, alums of a university, employees of a company, members of a professional association, etc.). In at least one example, a trust signal or a social node can be determined based on user transaction data (e.g., user transaction history data, user purchase history data, user attribute data, user credit history data, user profile data, asset profile data of a user, user contextual data, user interaction data, user preference data, and so forth) stored privately (e.g., not visible or otherwise accessible to other users) by the payment service computing platform 108. Information pertaining to their actions on an account can be more meaningful than other profile attributes, such as likes, followers, or name. In some examples, trust signals or social nodes can be determined based at least in part on third-party data from third-party computing platform(s) 119 (e.g., including server(s) 121) integrated with the payment service computing platform 108 (e.g., social network computing platform(s)). Such integrations can be facilitated by one or more application programming interface(s) (API(s)) or the like. For example, in particular examples, one or more of users 102A, 102B, 102C, and 102D may consent, for example, for the respective payment applications 114A, 114B, 114C, and 114D running in the background while one or more of the users 102A, 102B, 102C, 102D, for example, utilizes the third-party computing platform(s) 119. Some trust signals may be stronger due to a direct connection between two users represented by a social node, and an indirect connection via one or more other users may be perceived less strong. In some examples, strengths of the trust signals may be determined in addition to or as an alternative to degrees of separation (e.g., “someone you know received payments from Jane Smith 2”) between the users and attributes of the payment transactions (e.g., dollar value of a transaction between two users known to each other indirectly, or the frequency of transactions between user A and user C may allow user A and user B known to user C to have high trust signal value). In some examples, the strength of different trust signals can be used to determine which trust signals to surface to users and/or can be used for weighting in determining social trust scores (e.g., stronger trust signals are weighted more than weaker trust signals).

In particular examples, the payment service computing platform 108 may utilize the user transaction data or third-party data to generate trust signals for users of the payment service. For example, in particular examples, trust signals may include an amount of time each respective user 102A, 102B, 102C, and 102D has used the payment service or a date on which the each respective user 102A, 102B, 102C, and 102D joined the payment service (e.g., “User Join Date”), where joining the payment service includes setting up an account serviced by the payment service computing platform 108. In some examples, trust signals may include whether a potential recipient user (e.g., user 102B) is included (e.g., can be located) in a list (or a set) of contacts associated with a sending user (e.g., user 102A), or the like. In some examples, user profiles and/or social networks can be compared to determine relationships between the sending user or recipient user, and trust signals may be generated based on the determined relationships. For example, by comparing user profiles (e.g., by comparing transaction histories associated with each user profile), the payment service computing platform 108 may determine that N number of users (e.g., users 102C and 102D) have completed electronic payments with the sending user (e.g., user 102A) or the potential recipient user (e.g., user 102B). In some examples, the payment service computing platform 108 may identify users having a relationship with the sending user (e.g., user 102A) and may determine, from transaction histories of those identified users, one or more payments that have been made between the potential recipient user (e.g., user 102B) and one or more of the identified users who are associated with the sending user (e.g., user 102A). In some examples, a number of payments made between the potential recipient user (e.g., 102B) and the identified users who are related to the sending user (e.g., user 102A) may be determined or a number of the identified users who have made a payment(s) to, or received a payment(s) from, the potential recipient user (e.g., 102B) may be determined. In some examples, other user interactions may be determined by analyzing or comparing user profiles, such as payment attempts (e.g., requests for money), that weren't actually completed, messages exchanged between users via an in-app messaging tool or an external messaging platform integrated with the payment service computing platform 108, views, clicks, or impressions of user profiles by other users, and the like. In some examples, the payment service computing platform 108 may utilize one or more machine-learning models to determine and identify trust signals. For example, in particular examples, the one or more machine-learning models may include, for example, any statistics-based algorithms that may be suitable for finding patterns across large amounts of user transaction data or user interaction data.

In some examples, trust signals may be generated based at least in part on a set of “social nodes” between the first user and the second user. In at least one example, the set of social nodes can comprise one or more social nodes. As used herein, a “social node” may refer to one or more nodes (e.g., other users, transaction history data points, data objects, metadata, objects of interests, user interactions, and so forth) of a social network of users on the payment service computing platform 108 or otherwise accessing the payment service computing platform 108 that may indicate a relationship, social or otherwise, between various users or one or more nodes that may be learned (e.g., utilizing one or more machine-learning models) over time to determine granular social relationships between various users. In at least one example, the set of social nodes can be determined based at least in part on user data stored in the data store(s) 112, third-party data accessed from one or more third-party computing platforms 119, or the like. In some examples, an individual social node may correspond to a payment made between a pair of users of the payment service computing platform 108. Additionally, or alternatively, an individual social node may correspond to an existing relationship between a pair of users (e.g., a user being included in a list of contacts associated with another user, a user being a “friend” or “follower” of another user on a social network platform, users being associated with a same group, or the like). Thus, a social node corresponds, in some way, to an association (or a relationship) between users, whereas a trust signal does not necessarily correspond to an association between users, but it can. An example of a trust signal that does not correspond to an association between users is an amount of time a potential recipient user has used the payment service. That is, a user who has used the payment service for a longer period of time may have garnered more trust than a user who has very recently established an account with the payment service. Thus, a trust signal can more generally indicate a level of trust associated with a given transaction, and it does not have to, but it can, be based on an association (or a relationship) between users.

In particular examples, the trust signals (or alternatively the set of social nodes) may be combined and summarized by the payment service computing platform 108 to generate a social trust score representing a “strength” of a trusted relationship between a sending user (e.g., user 102A) and a potential recipient user (e.g., user 102B). This social trust score is interchangeably referred to herein as a “confidence score.” In some examples, a social trust score can be a quantitative representation of trust between two or more users and can be determined based at least in part on combining and weighting individual trust signals. In some examples, the social trust score corresponds to the number of social nodes determined by the payment service computing platform 108, or degrees of separation between two users (e.g., “someone you know received payments from Jane Smith 2”). That is, if the number of social nodes is eight, the social trust score may be eight, in some examples. In other examples, the social trust score may be computed based at least in part on the social node(s) determined by the payment service computing platform 108. In some examples, individual social nodes can be weighted heavier than other social nodes and such weighting can be used to generate a social trust score. In some examples, the payment service computing platform 108 may, utilizing one or more machine-learning models, determine a social trust score (e.g., from zero to 100, from zero to 1, etc.).

In particular examples, the set of social nodes determined by the payment service computing platform 108 may be combined and summarized to generate a social trust score corresponding to the user profiles of the sending or recipient users. For example, in one example, if the potential recipient user is in the contacts list of the sending user and has also received electronic payments from, for example, more than five users known to the sending user, the payment service computing platform 108 may generate a “high” social trust score (e.g., above a threshold), indicating that the trusted relationship between the sending user and the potential recipient user is relatively strong. On the other hand, for example, if the potential recipient user is not in the contacts list of the sending user and has received electronic payments from, for example, less than three users known to the sending user, the payment service computing platform 108 may generate a “low” social trust score (e.g., below a threshold), indicating that the trusted relationship between the sending user and the potential recipient user is relatively weak. In some examples, a social trust score can be compared to a threshold or other metric to determine whether to permit an electronic payment or whether to alter a payment process, for example by requesting approval for the electronic payment to be completed. In some examples, the threshold can be personalized or customized for individual users. For example, a sending user of an electronic payment may be associated with a social trust score threshold that is personalized to the sending user based on the sending user's preferences or a risk metric associated with the sending user, which, in some examples, can be based on transaction data or other interaction data associated with the sending user.

Trust signals can be used for presenting indications thereof to users participating in electronic payments, for example, to enable a sending user to verify the identity of a receiving user. Examples of such indications are presented in FIG. 1A as indications 118A, 118B, 118C, and 118D. Presentation of such indications can be useful for mitigating misdirected payments. Further, trust signals can be used for interrupting or modifying a transaction flow to request confirmation of an electronic payment prior to initiating the electronic payment. Such interruption or modification can again be useful for mitigating misdirected payments. In some examples, one or more suggestions may be provided to a user of the payment service to help improve, or otherwise modify, the trust signals, thereby mitigating misdirected payments. For example, a suggestion may be provided to a user to transfer an electronic payment to another user in order to improve a corresponding trust signal. Such actionable suggestions can enable modification of trust signals in real-time or near-real-time.

In particular examples, the present techniques may further include the application of the trust signals to merchants (e.g., on merchant profile pages). For example, if a first user (e.g., user 102A) is about to transfer an electronic payment to a second user (e.g., user 102B) wherein the second user (e.g., user 102B) represents a merchant (e.g., a business, company, retailer, or a similar entity), trust signals may be generated and indicated to the first user (e.g., user 102A) via the payment applications 114A to enable the first user (e.g., a customer of the merchant) to confirm the identity of the merchant prior to initiating the payment transaction. This can help mitigate misdirected payments in transactions of customers with merchants, such as with electronic commerce (e-commerce) transactions where merchants offer items for sale via an electronic marketplace or via point-of-sale terminals at brick-and-mortar stores. In particular examples, the present techniques may further include the application of the trust signals to creators (e.g., on artist profiles of streaming platforms). For example, if a first user (e.g., user 102A) is about to transfer an electronic payment to a second user (e.g., user 102B) wherein the second user (e.g., user 102B) represents an artist (a singer, a creator, etc.), trust signals may be generated and indicated to the first user (e.g., user 102A) via the payment applications 114A to enable the first user (e.g., fan of the artist) to confirm the identity of the artist prior to tipping the artist. This can help mitigate misdirected payments in quick transactions between the artist and the music fan. In this case, additional trust signals may be derived from the fan's interaction with artist's/merchant's content and not just a direct relationship between the artist and fan.

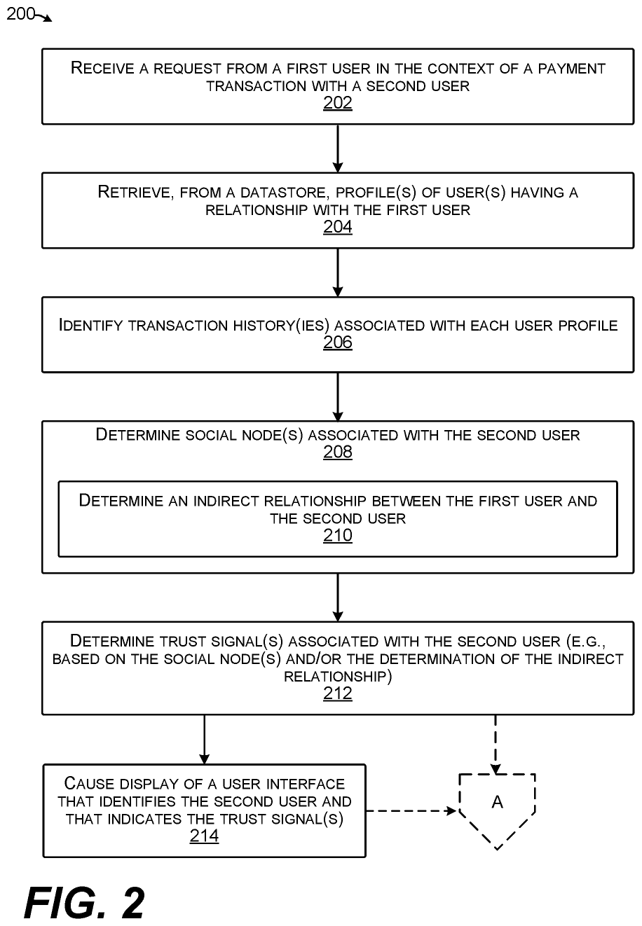

In this way, as will be further appreciated with respect to FIGS. 2, 3, and 4A-4I, the present examples may provide indications of one or more trust signals that may dynamically modify confidence that a user 102B, for example, corresponding to the user profile being viewed by the sending user 102A, for example, is indeed the intended recipient user 102B. Techniques described herein enable de-identifying and anonymizing users in the indications of the trust signals such that the privacy of users 102A, 102B, 102C, and 102D of the payment service may be respected and enforced. For example, by anonymizing users in the indications 118A, 118B, 118C, and 118D of the trust signals to indicate, for example, a number of associated users that have completed transactions with a user, but not necessarily identifying the associated users, the privacy of those associated users related to their transaction history can be preserved while still providing for the benefits of the trust signals described herein. Further, such trust signals or indications thereof, as described herein, are “unalterable” or “read-only” such that they cannot be altered by users of the payment service computing platform 108. As such, techniques described herein provide more reliable and accurate trust signals or indications thereof than what is available with conventional techniques. Accordingly, the described techniques may thus reduce the possibility of sending users inadvertently providing electronic payments to unintended recipient users, and further streamline the processing workload of the processing devices 110 (e.g., server) and data store(s) 112 management on the payment service computing platform 108 by reducing instances of payment disputes due to accidental transfers, requesting and completing return transactions, and so forth.

FIG. 1B illustrates an example environment 100B that may be suitable for a payment service computing platform to utilize integrations with social network platform(s). For example, the environment 100B may be suitable for enabling users to create, customize, or share asset “profiles” among a user-selectable or identified group of users of the payment service computing platform, or for purchasing one or more assets or mirroring an allocation of assets of another user, in accordance with presently disclosed examples. The example environment 100B can be the same or similar environment as the environment 100A. In FIG. 1B, however, the users 102B, 102C, 102D are referred to as “investors.” As depicted, the example environment 100B may include one or more investors 102A being associated with a respective user electronic device 104A that may be suitable for allowing the one or more one or more investors 102A to utilize the payment applications 114A (e.g., “Payment application”). In particular examples, as further depicted by FIG. 1B, the user electronic device 104A may be communicatively coupled to a payment service computing platform 108 and a third-party computing platform 119 via one or more network(s) 106.

For example, in particular examples, the data stores 112 may store, for example, profiles (e.g., asset profiles) of an investor community including investors 102B (e.g., “Investor 2”), 102C (e.g., “Investor 3”), and 102D (e.g., “Investor N”). The investor community may include a group of investors each having an asset profile including one or more assets owned by the respective investor and maintained by the payment service computing platform 108. For example, in particular examples, the asset profiles corresponding to the community of investors may include, for example, performance metrics, assets owned by the respective investor 102B, 102C, 102D, asset allocation percentages, asset time held metrics, and investors with whom the respective investor 102B, 102C, 102D has interacted, or assets with which the respective investor 102B, 102C, 102D has interacted, all of which may analyzed by the payment service computing platform 108 in anonymized or de-identified manner and be individually, privately, or publicly shared based on user preference.

In particular examples, the payment service computing platform 108 may be a hosting and servicing platform for the payment application 114A executing on the user electronic device 104A. For example, in particular examples, as further depicted by FIG. 1B, the payment application 114A may include, for example, a user interface 124A for generating and displaying the asset profiles of the social community of investors to the investor 102A (e.g., Investor 1) and for performing electronic trading, sharing, or mirroring of assets and asset profiles between, for example, the investor 102A (e.g., Investor 1) and the social community of investors 102B (e.g., “Investor 2”), 102C (e.g., “Investor 3”), and 102D (e.g., “Investor N”).

In particular examples, in accordance with the presently disclosed techniques, the payment service computing platform 108 may be utilized to enable users to create, customize, or share asset profiles, or to purchase one or more assets or mirror an allocation of assets of another user. In particular examples, the investor 102A (e.g., Investor 1) may create and customize her own asset profile. In some examples, aspects of the asset profile can be based on the investor community. For example, the payment service computing platform 108 can identify one or more other investors from the investor community and can recommend asset profiles of such identified investor(s) to the investor 102A. In some examples, the other investor(s) can be identified based on a user selection, membership in the same investor community, or via a machine-learning mechanism. For example, in particular examples, the investor community may include, for example, a group of investors who are part of a “friend” network (e.g., a list of contacts, an external social network, etc.) of the investor 102A (e.g., Investor 1), a group of investors having a comparably large following (“influencers” or “creators”), a group of investors having the same interest of the investor 102A (e.g., Investor 1) determined based on user interactions, transaction history, or third-party data (e.g., social network connections or activity), a group of investors having an asset allocation that is currently “trending,” and so forth.

For example, in particular examples, as depicted, the payment service computing platform 108, may present a first user interface 124A including representations 126 of the investors 102B (e.g., “Investor 2”), 102C (e.g., “Investor 3”), and 102D (e.g., “Investor N”) to the investor 102A (e.g., Investor 1) in the investor community. In some examples, the representations 126 can be static or dynamic. As an example, dynamic representations 126 can be scrollable (e.g., horizontal, infinitely scrollable list or vertical, infinitely scrollable list).

In the example of FIG. 1B, the investor 102A (e.g., “Investor 1”) may select an interactive element 126 corresponding to the investor 102B (e.g., “Investor 2”) to view the asset profile of investor 102B (e.g., “Investor 2”) via the user interface 124B and the asset allocation percentages 128 of assets owned by the investor 102B (e.g., “Investor 2”). Continuing, the investor 102A (e.g., Investor 1) may select to “mirror” the asset allocation percentages 128 (e.g., “X %,” “Y %,” “Z %”) of the investor 102B (e.g., “Investor 2”). Continuing, the investor 102A (e.g., “Investor 1”) may also input a specified value amount 130 (e.g., “$100”) of which to invest, as illustrated by the user interface 124C.

Based on the mirrored asset allocation percentages 128 (e.g., “X %,” “Y %,” “Z %”) and the specified value amount 130 (e.g., “$100”), the payment service computing platform 108 may determine whole units or fractional units for each of the assets in the asset profile of the investor 102B (e.g., “1.3 shares of asset X,” “5 shares of asset Y,” “0.2 shares of asset Z”) to be purchased in accordance with the specified value amount (e.g., “$100”). As an example, the payment service computing platform 108 may determine a weighting value based on the mirrored asset allocation percentages 128 and apply the weighting value to the specified value amount 130. This may determine the amount that will be used to purchase the assets. If the specified value amount 130 is sufficient to purchase whole units of the assets, then whole units may be purchased. In a basic example, if $30 of the specified value amount 130 is allocated to the purchase of asset X, where the share price of asset X is $10 per share, then three whole units of asset X may be purchased. On the other hand, if $30 of the specified value amount 130 is allocated to the purchase of asset Y, where the share price of asset Y is $60 per share, then a half (0.5) unit of asset Y may be purchased. Having purchased a mirrored allocation of assets (e.g., “X,” “Y,” “Z”) in accordance with the specified value amount 130 (e.g., “$100”), the investor 102A (e.g., “Investor 1”) may then complete the creating and customization of her asset profile 132, as illustrated by the user interface 124D.

In some examples, the investor 102A (e.g., Investor 1) may also select to “mirror” the asset allocation percentage of a predefined subset of the assets owned by the investor 102B (e.g., Investor 2″). In other examples, the predefined subset, for example, may be selected by the investor 102B (e.g., “Here's a Recommended Pack of”), the investor 102A (e.g., “Investor 1”), or automatically by the payment service computing platform 108. For example, in particular examples, the predefined subset may include, for example, a pack of assets selected based on the determined interest of the investor 102A (e.g., “Investor 1”) (e.g., tech stocks, energy stocks, automotive stocks, stocks of companies with women CEOs, stocks of only beauty and fashion companies, stocks of only companies based in Northern California, stocks of only start-up companies, one or more of various cryptocurrencies, a specific cryptocurrency, and so forth).

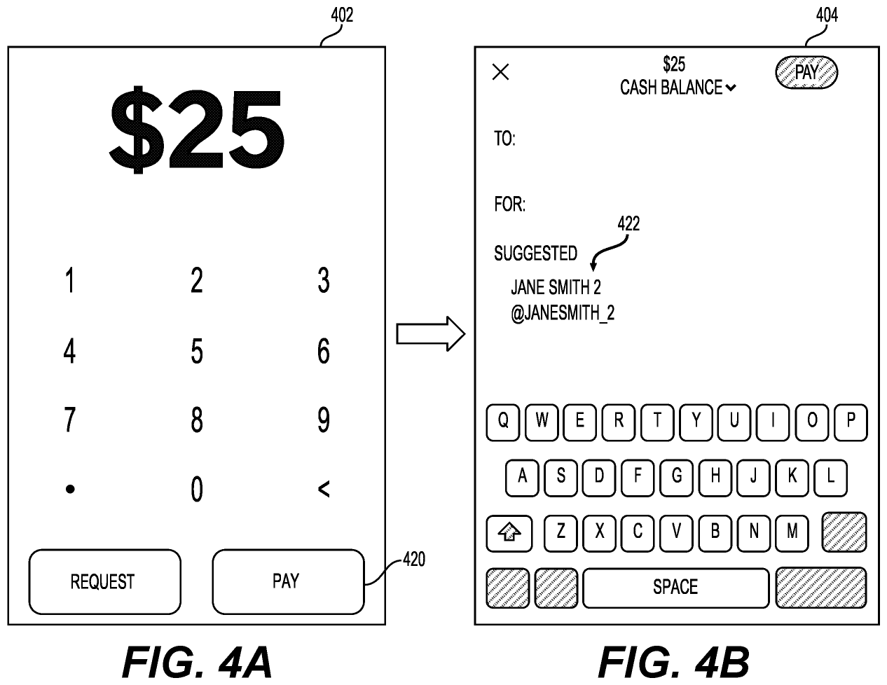

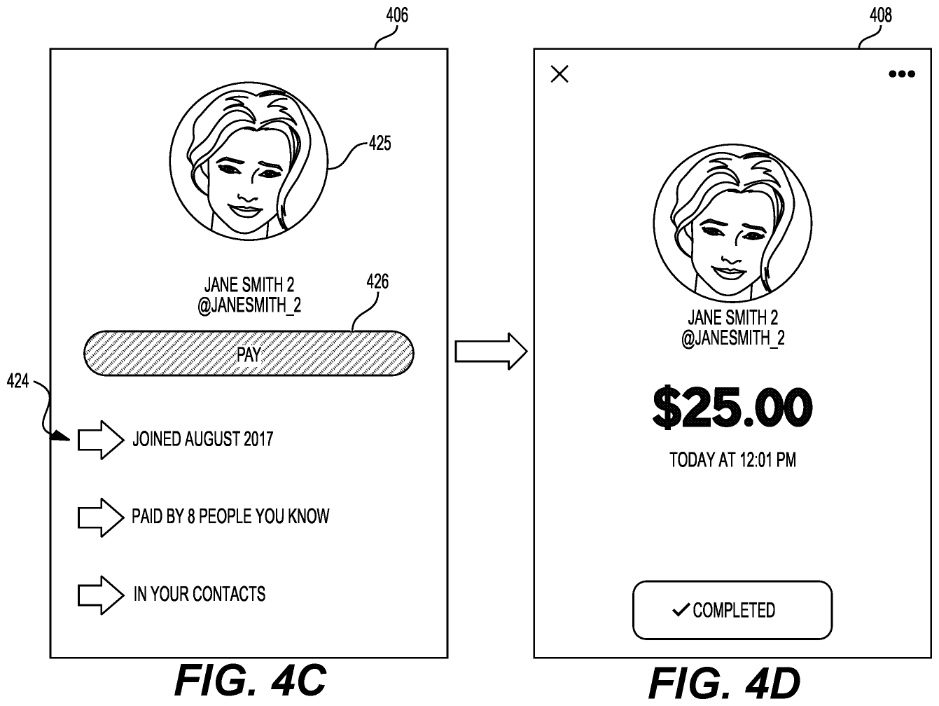

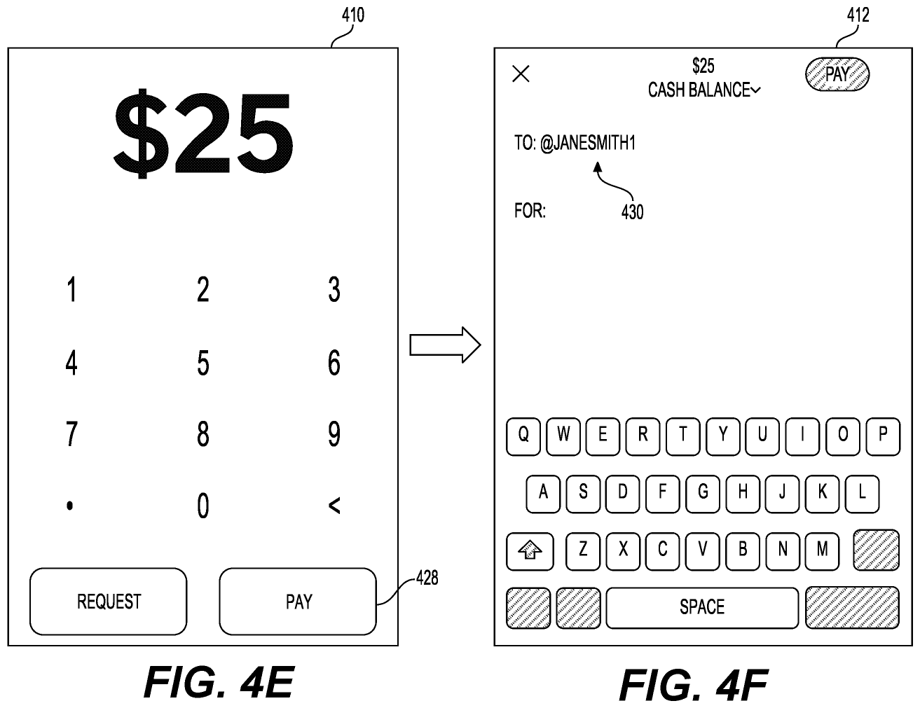

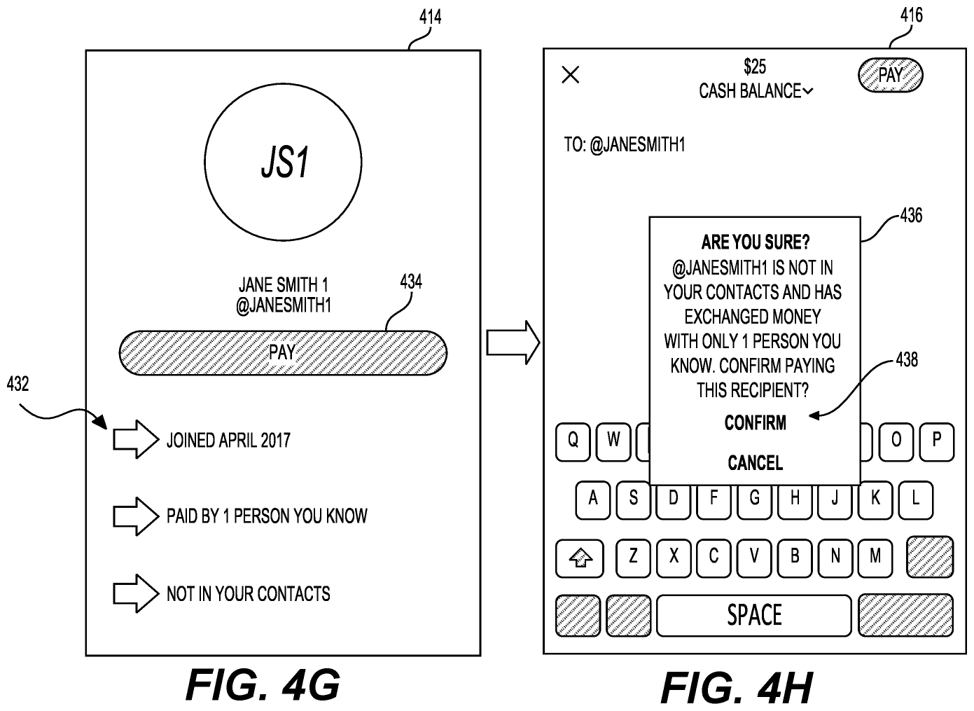

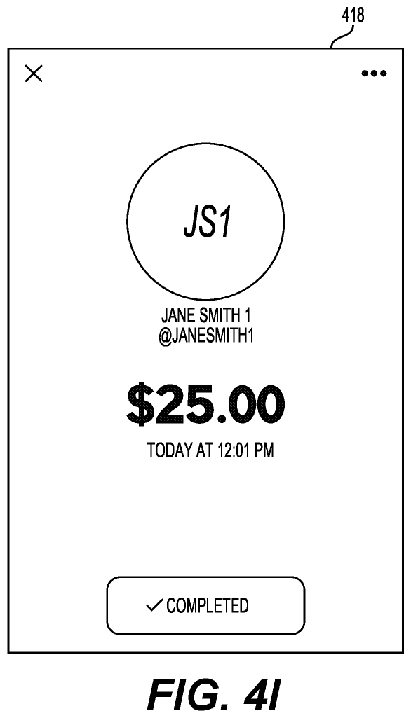

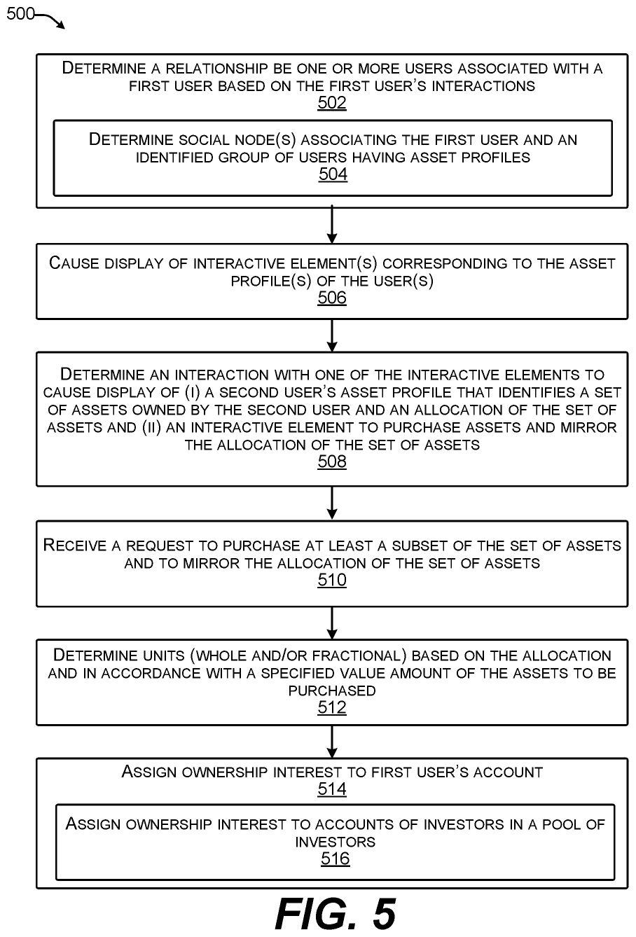

As will be further appreciated with respect to FIGS. 4 and 5A-5T, investors 102A, 102B may control how much of their asset profiles 118B, 118D are public or private at any point in time. For example, referring again to FIG. 1B, the investor 102B (e.g., “Investor 2”) may limit viewing, interacting, “mirroring,” or other access to all or some aspects of her asset profile 118B to only specified users (e.g., gated by request), her following users, or a “friend” network. In particular examples, the investor 102B (e.g., “Investor 2”) may also restrict viewing, interacting, “mirroring,” or other access to all or some aspects of her asset profile 118B by deploying a paywall enabled by the payment service computing platform 108, such that the investor 102B (e.g., “Investor 2”) may solicit paid subscriptions (e.g., one-time payment subscription, semi-monthly payment subscription, monthly payment subscription) to access her asset profile 118B.

In particular examples, individual investors 102A, 102B, 102C, 102D may share their asset profiles, tokens 122 corresponding to assets (gifting of tokens 122 is described in further detail below), or other instances with entities external to the payment service computing platform 108 utilizing, for example, a third-party computing platform 119. For example, in particular examples, the individual investors 102A, 102B, 102C, 102D may share images, dynamic webpage links, quick response (QR) codes, augmented reality (AR) or virtual reality (VR) objects, or one or more other instances corresponding to their asset profiles via the third-party computing platform 119 (e.g., multimedia messaging service platform, email service platform, social media service platform, social media ephemeral content, AR/VR object environment, and so forth). This may allow individual investors 102A, 102B, 102C, 102D to expand their community of investors by allowing the individual investors 102A, 102B, 102C, 102D to invite and encourage external entities to interact with their asset profiles and encourage added asset and engagement, all the while controlling how much of the individual investor's 102A, 102B, 102C, 102D asset profile is viewable at any point in time.

In particular examples, as will be further appreciated by FIGS. 5, 6 and 7A-7W, the individual investors 102A, 102B, 102C, 102D may also create, customize, and manage pooled funds, in which, for example, an individual investor 102A can purchase and sell assets on behalf of a group of investors 102B, 102C, 102D having the same determined interest or other association to the investor 102A. For example, investor 102A may join an investor community, and, in response, the asset profile or account of the joining investor 102A may be associated with the asset profiles or accounts of the current members of the investor community, or with a group identifier that associates the users, accounts, user profiles, asset profiles, or the like. In particular examples, once the investor 102A joins her asset profile to the community of investors, any one of the community of investors, including the investor 102A, may be designated as a “broker” or an “asset manager” by the consent of the other investors to be allowed to create, customize, and manage pooled funds for the entire community of investors. For example, if the investor 102A is designated as the “broker” or the “asset manager,” the investor 102A can purchase and sell assets (e.g., stocks, bonds, mutual funds, exchange-traded funds (ETFs), cryptocurrencies, non-fungible tokens (NFTs), and so forth) on behalf of the community of investors. For example, in particular examples, once the investor 102A is designated as a “broker” or an “asset manager,” the payment service computing platform 108 may associate future asset purchases or sells performed by the investor 102A with respect to her asset profile and mirroring those future asset purchases or sells with respect to the asset profiles of the community of investors without any of the community of investors having to perform any tasks themselves. The funds of the investor community may be pooled in various ways. In some examples, investors in the community of investors may ante (or buy in) for any desired amount, and the respective allocation percentages of each investor who anted (or bought in) may be tracked such that, without further deposits to the pooled funds, the individual investor may retain her ownership percentage. As the broker makes investments and as the community receives returns on those investments, the ownership percentage may remain fixed unless the community of investors agrees to change those percentages, such as if one of the investors in the community adds more funds to the pooled funds.

Thus, in accordance with the foregoing examples, a payment service computing platform 108 may be provided that prompts and encourages investors 102A, 102B, 102C, 102D to interact and engage with the payment service computing platform 108 more frequently (e.g., creating, updating, and customizing user asset profiles; sharing asset profiles with “friends” on the payment service computing platform 108 or on an third-party computing platform 119; managing and adjusting asset allocation percentages based on real-time market data and user interaction data, communicating asset strategies among “friends” or “followers”; and so forth). Additionally, the foregoing examples may allow investors 102A, 102B, 102C, 102D to invest in less risky assets and to pool with other investors 102A, 102B, 102C, 102D having similar interests determined based on machine-learning model surfaced data, such as user interaction data, transaction history data, or data associating a particular group of the investors 102A, 102B, 102C, 102D.

Further, by enabling individual investors 102A, 102B, 102C, 102D to share and “mirror” the asset allocation percentages of one or more “friend” users or other users the individual user “follows,” the foregoing examples may streamline the processing workload and data store management of the payment service computing platform 108 by reducing instances of high-frequency purchasing and selling of individual assets and by reducing the number of iterations of purchases of individual assets (e.g., since “mirroring” allows for the individual assets to be purchased all at once as a package). Specifically, by allowing individual investors 102A, 102B, 102C, 102D to share and “mirror” the asset allocation percentages of one or more “friend” users or other users the individual investor user “follows,” the size, complexity, and capacity of the processing devices 110 (e.g., servers) and data stores 112 hosting the payment service computing platform 108, for example, may be reduced due to reduced scaling of processing workload of the processing devices 110 (e.g., reduced tasks, reduced applications, reduced requests, and so forth) and data store 112 capacity (e.g., reduced scaling of data store management and capacity for individual instances of individual assets of each of thousands or millions of users).

FIG. 1C illustrates an example environment 100C that may be suitable for a payment service computing platform to utilize integrations with social network platform(s). For example, the environment 100C may be suitable for providing a token that may be shared publicly, activated for redemption, or applied to purchase one or more assets, in accordance with presently disclosed examples. For the purpose of this discussion, a token can comprise a redeemable stock offer, a redeemable cryptocurrency offer, a redeemable amount of fiat currency to be used to purchase stock(s) or cryptocurrency, a gift card, etc. In at least one example, the environment 100C can be the same or similar to the environments 100A and 100B.

In particular examples, one or more tokens 122 may be shared publicly through a third-party computing platform 119 (e.g., external or remote from the payment service computing platform 108), and may be activated for redemption by the user 102A and applied to purchase an asset regardless of the asset's base price. For example, in particular examples, the one or more tokens 122 may be shared in a variety of suitable formats, including, for example, dynamic webpage links, tokens, QR codes, one or more augmented reality (AR) or virtual reality (VR) objects, or other instances.

In particular examples, the one or more tokens 122 may be shared via the payment service computing platform 108, or, in particular examples, may be shared via the third-party computing platform 119 and provided to the user 102A by way of a third-party service application 134 (e.g., multimedia messaging application, short messaging application, email application, social media application, AR/VR application, and so forth). For example, in particular examples, the third-party computing platform 119 may include, for example, a multimedia messaging service platform, a short messaging service platform, an email service platform, a social media platform (e.g., that may allow the tokens 122 to be shared as an image post, an embedded video post, or ephemeral content post), AR/VR environment, and so forth. Specifically, in particular examples, the one or more tokens 122 may be utilized by the payment service computing platform 108 to grow its user base, by individual users to send gifts, by brands to incentivize asset ownership, by users of the payment service to increase their following on the payment service, and so forth.

In particular examples, the payment service computing platform 108 may utilize one or more machine-learning models (e.g., supervised machine-learning models, unsupervised machine-learning models, deep-learning machine-learning models, and so forth) to infer interests of the user 102A and recommend assets to which the one or more tokens 122 may be applied. For example, in particular examples, the payment service computing platform 108 may analyze transaction data and user interaction data associated with investors 102B (e.g., “Investor 2”), 102C (e.g., “Investor 3”), and 102D (e.g., “Investor N”) to identify and recommend assets, asset profiles, or asset profiles to the user 102A upon redemption of the one or more tokens 122. In particular examples, the machine-learning models (e.g., unsupervised machine-learning, supervising machine-learning, deep learning, and so forth) may be trained and retrained over time utilizing the vast user transaction data or user interaction data (e.g., “Big Data” that may be maintained and managed by the payment service computing platform, such as user transaction history data, user purchase history data, user attribute data, user credit history data, user asset profile data, user asset data, user contextual data, user interaction data, user preference data, and so forth) that may be stored on the databases of payment service computing platform 108.

In particular examples, assets identified by the payment service platform 108 for review by a user 102A may be based on, for example, a transaction history of or involving the user 102A on the payment service computing platform 108, friends or contacts of the user 102A who are also have accounts on the payment service computing platform 108, the asset profile of the friends or contacts of the user 102A, other users similar to the user 102A, and so forth. For example, as depicted by FIG. 1C, in particular examples, the user 102A may receive a token 122 as a post to a social media feed 136 of the user 102A as the user 102A is interacting with the third-party service application 134 on the user electronic device 104A, as depicted by the user interface 138A.

In particular examples, the user 102A may interact with the token 122, which may link to a payment application 114A associated with the user 102A. For example, in particular examples, the token 122 may be selected by the user 102A on the third-party service application 134 and the third-party service application 134 may launch to a web page, the payment application 114A, an instant application (e.g., a portion of the payment application 114A), or other object instance in which the user may view and interact with asset information relating to the token 122. As further depicted, the payment application 114A may display a user interface 138B including an amount (e.g., $50) associated with the token 122 and one or more suggestions of companies (e.g., “Yangtze, Inc.”) to which to apply the token 122 (e.g., upon the user 102A creating an asset profile on the payment service computing platform 108, if the user 102A does not already have an asset profile). In some examples, such suggestion(s) can be based on outputs of machine-learning model(s) or can otherwise be based at least in part on user data associated with the user.

In particular examples, the user 102A may confirm the redemption of the token 122 and, if they do not currently have an asset profile on the payment service computing platform 108, select to create an asset profile on the payment service computing platform 108, as illustrated by user interface 138C (e.g., “Start Profile”). In particular examples, as illustrated by the user interface 138D, whole units or fractional units of “Yangtze, Inc.” (e.g., 0.5 shares of Yangtze, Inc.) may be purchased by the payment service computing platform 108 for the user 102A in accordance with the specified value (e.g., $50) of the token 122 and the determined share price of “Yangtze, Inc.” through the redemption of the token 122. For example, the user interface 138D depicts an example illustration of the created asset profile of the user 102A.

In this way, the present examples may prompt and encourage users of the payment service computing platform 108 that do not yet have an asset profile or one or more external entities to interact and engage with the payment service computing platform 108 more frequently and more purposefully. This may further streamline the processing workload of the processing devices 110 (e.g., servers) and data store 112 management on the payment service computing platform 108 by limiting advertisements and communications to only targeted users 102A, for example, determined based on inferred user 102A interests and the determined likelihood that the targeted user 102A may interact and engage with the payment service computing platform 108.

FIG. 2 is a method 200 for generating unalterable (e.g., “read-only”) trust signals using data collected by the payment service computing platform to facilitate sending users ensuring that a selected recipient is an intended recipient in the context of an electronic payment or asset transfer, in accordance with presently disclosed examples. The method 200 may be performed utilizing server(s) 110 that may include hardware (e.g., a general purpose processor, a graphic processing unit (GPU), an application-specific integrated circuit (ASIC), a system-on-chip (SoC), a microcontroller, a field-programmable gate array (FPGA), a central processing unit (CPU), an application processor (AP), a visual processing unit (VPU), a neural processing unit (NPU), a neural decision processor (NDP), or any other processing device(s) that may be suitable for processing image data), software (e.g., instructions running/executing on one or more processors), firmware (e.g., microcode), or some combination thereof.

The method 200 may begin at block 202 with the server(s) 110 receiving a request from a first user in the context of a transaction, e.g., payment transaction, with a second user. In some examples, the first user and the second user may have accounts with the payment service computing platform 108. In other examples, the second user may have an account with a third party payment service computing platform, and the payment service computing platform 108 may utilize an API(s) to enable transactions between the first user having an account with the payment service computing platform 108 and the second user having an account with a third party payment service computing platform. In some examples, the request received at block 202 may be a request to view a second profile (e.g., user profile) of a second user of a payment service. The request may be received at block 202 in association with (or in the context of) a payment transaction with the second user (e.g., an electronic payment to the second user). In some examples, the first user is a sending user who has an intent to transfer an electronic payment (e.g., a “$25” electronic payment) to a recipient user. Accordingly, in some examples, the request is received at block 202 in response to the sending user selecting an interactive element (e.g., “View Profile”, “Pay”, etc.) presented on a user interface of an electronic device of the first user, or in response to the sending user providing user input (e.g., typing, speaking, etc.) that specifies an intended recipient user (e.g., based on an identifier, such as a phone number, email address, unique identifier having a particular syntax for the payment service computing platform 108, etc.) who is to receive the payment, or in response to the sending user selecting a displayed suggestion of the intended recipient user who is to receive the payment. In some examples, the request is received at block 202 as a message transmitted from an electronic device of the first user to the payment service computing platform 108. In some examples, the user profile associated with the second user is a user profile of a personal user (e.g., “Jane Smith”). In other examples, the user profile associated with the second user is a merchant profile of a merchant (e.g., ABC retail store). That is, the first user, in some examples, may be initiating a payment transaction with a merchant. In an illustrative example, the first user may be purchasing an item (e.g., a product, service, etc.) from a merchant using a payment application executing on the electronic device of the first user, and, just as with a personal, human user, the first user would like to be reasonably confident that the merchant corresponding to the user profile being viewed by the sending user is indeed the intended recipient merchant.

The method 200 may continue at block 204 with the server(s) 110 retrieving, from a data store 112 maintained by the payment service computing platform 108, one or more profiles (e.g., user profiles) of users having a relationship (e.g., an existing relationship) with the first user. This allows the payment service computing platform 108 to determine whether there are any stored user profiles associated with other users of the payment service computing platform 108 (and/or a third party payment service computing platform) that have a relationship to the first user profile of the first user who sent the request received at block 202. In some examples, the first user may not have any relationships with other users (e.g., the first user may have recently established an account with the payment service computing platform 108 and the request received from the first user at block 202 may be the first user's first request on the payment service computing platform 108. In this case, the server(s) 110 may retrieve one or more profiles of users sharing an attribute(s) with the first user (e.g., a same city of residence, etc.) or may initiate an alternative process, whereby one or more additional inputs or operations may be requested prior to enabling the transaction to proceed. In another example, the server(s) 110 may generate a test transaction, for example of a small amount, monitor the transaction and accordingly use that as a first relationship between the two parties. For example, if the other party tags that transaction as a fraudulent transaction, then the server(s) 110 may void the relationship. In yet another example, the server(s) 110 may integrate with third parties (e.g., social networking platforms, financial platforms, etc.) to factor in relationship, direct or indirect within specific separation degree, outside the payment platform.

The method 200 may continue at block 206 with the server(s) 110 optionally identifying a transaction history associated with each user profile of the one or more user profiles retrieved at block 204. In some examples, the transaction history(ies) identified at block 206 may include a user purchase history, a user attribute, a user credit history, a user asset, or a combination thereof. In some examples, the payment service computing platform 108 may determine and identify, from a user data store maintained by the payment service computing platform 108, whether an intended second (recipient) user has previously successfully received one or more electronic payments from one or more of a set of users associated with the first (sending) user. In particular examples, the user data store maintained by the payment service computing platform 108 may be constructed based on user transaction data, which may include user purchase history, user attributes, user credit history, user assets, and so forth.

The method 200 may continue at block 208 with the server(s) 110 determining a set of social nodes associated with at least the second user. In at least one example, the set of social nodes can comprise one or more social nodes. As used herein, a “social node” may refer to one or more nodes (e.g., other users, transaction history data points, data objects, metadata, objects of interests, user interactions, and so forth) of a social network of users on the payment service computing platform 108 that may indicate a social relationship between various users on the payment service computing platform 108 or one or more nodes that may be learned (e.g., utilizing one or more deep-learning models) over time to determine granular social relationships between various users on the payment service computing platform 108. In at least one example, the set of social nodes can be determined based at least in part on the profile(s) retrieved at block 204, user data stored in the data store(s) 112, third-party data accessed from one or more third-party service computing platforms, or the like. For example, an individual social node may correspond to an existing relationship between the first user and the second user (e.g., the second user being included in a list of contacts associated with the first user). That is, a social node may be determined at block 208 if the second user can be found in a list of contacts associated with the first user, where the list of contacts may be based on the user profile(s) retrieved at block 204. Additionally, or alternatively, the set of social nodes may include, for example, users who have also completed electronic payments with the second user (e.g., “Jane Smith 2 has received payments from 10 users associated with you”). Accordingly, in some examples, an individual social node may correspond an indirect relationship between the first user and the second user determined at sub-block 210. That is, the method 200 may continue at sub-block 210 with the server(s) 110 determining, based at least in part on the one or more user profiles, an indirect relationship between the first user and the second user (or an absence of an indirect relationship). An example of determining an indirect relationship between the first user and the second user is determining one or more payments made between the second user and at least one of the users associated with the profile(s) retrieved at block 204. For example, a payment made to the second user by user(s) associated with a retrieved user profile(s) may establish an indirect relationship between the first user and the second user. Additionally, or alternatively, a payment made to a user(s) associated with a retrieved user profile(s) by the second user may establish an indirect relationship between the first user and the second user. The first user may have an indirect relationship with the second user if, for example, the first user has a relationship with one or more users who have a relationship with the second user. In another example, the first user may have an indirect relationship with the second user based on an interaction (e.g., a direct relationship) outside of the payment service.

The method 200 may then continue at block 212 with the server(s) 110 determining trust signal(s) associated with the second user. In some examples, the trust signal(s) is/are determined at block 212 based at least in part on the determination at sub-block 210 of the indirect relationship between the first user and the second user (e.g., based at least in part on the one or more payments made between the second user and at least one of the users associated with the profile(s) retrieved at block 204). In some examples, the trust signal(s) is/are determined at block 212 based at least in part on the social node(s) determined at block 208. In one example, a trust signal determined at block 212 may be a number of the one or more payments made between the second user and at least one of the users associated with the profile(s) retrieved at block 204 (e.g., if the second user was paid eight times by people related to the first user, the trust signal determined at block 212 may be “eight payments,” or the like). In one example, a trust signal determined at block 212 may be a number of users who have also completed electronic payments with the user of a user profile being viewed by a sending user (e.g., “Jane Smith 2 has received payments from 10 users associated with you”). In another example, a trust signal determined at block 212 may be a date on which the second user established an account with the payment service computing platform 108, which is sometimes referred to herein as a “join date” or an “instantiation date.” In particular examples, the generated trust signals may include an amount of time each user has been a member of (or otherwise used) the payment service serviced by the payment service computing platform 108. In yet another example, a trust signal determined at block 212 may be an indication of whether the second user is included in a list of contacts associated with the first user (e.g., based on a mobile contacts list, the list of user profiles retrieved at block 204, etc.). In some examples, determining a trust signal(s) at block 212 may include generating unalterable (e.g., “read-only”) trust signals. In particular examples, the payment service computing platform 108 may utilize the private user transaction data or third-party data to generate public, anonymized, and unalterable (e.g., “read-only”) trust signals for each user (or user profile) of the payment service serviced by the payment service computing platform 108. In particular examples, by generating public, anonymized, and unalterable (e.g., “read-only”) trust signals, the payment service computing platform 108 may provide trust signals that provide a “ground truth” that sending users utilizing the payment service computing platform 108 can trust with certainty that a selected recipient is indeed an intended recipient of an electronic payment. Indeed, while conventional payment service computing systems rely solely on data that may be inputted by the payment service users themselves, the present payment service computing platform 108 can utilizes private transaction data or third-party data accessible from third-party computing platforms to generate trust signals such that indications of those trust signals provided via user interfaces do not identify any of the users and thus provides a more efficient and secure payment service computing platform 108.

The method 200 may then continue at block 214 with the server(s) 110 causing a first user interface to be displayed via a payment application executing on an electronic device associated with the first user, wherein the first user interface comprises: (i) an indication of an identity of the second user and (ii) an indication(s) of the trust signal(s) determined at block 212. For example, the first user interface may present, to the first user, the user profile of the second user, which may provide the first user with information associated with the second user, determined based at least in part on the second user profile. It is to be appreciated that profiles of users can be accessed and/or surfaced while a user is involved in a payment flow (e.g., while sending or requesting a payment). Additionally, or alternatively, users may be able to access profiles of users prior to executing a payment in order to confirm a recipient. For example, the profiles of users may show up within an interstitial on a payment user interface that allows scanning of information, such as trust signals, social nodes, and social scores, and seeing it change in real-time and near-real-time as the transaction information changes. In other examples, the user leaves the payment interface to access user profile information. In some examples, the first user interface may present, to the first user, an indication of a trusted/untrusted relationship between the first user and the second user based on the trust signal(s) determined at block 212. For example, the first user interface may indicate that the second user was “Paid or Interacted with by People You Know,” that the second user was “Paid or Interacted with by 8 People You Know,” or the like. In some examples, the indication(s) of the trust signal(s) presented via the first user interface may include a read-only trust signal(s) that cannot be altered. In some examples, one or more users may be anonymized in the indication(s) of the trust signal(s) presented via the first user interface. For example, instead of naming the users who have paid the second user, an indication of the trust signal may specify that the second user was paid by a “people” or “users” that the first user knows, without identifying those people/users. In this way, the present examples may determine, and display indications of, one or more trust signals that may increase confidence that the user corresponding to the user profile being viewed by the sending user is indeed the intended recipient user. Further, by de-identifying and anonymizing users in the indications of the trust signals displayed via the user interface, the privacy of all users of the payment service can be respected and enforced.

In some examples, there can be a feedback mechanism that allows the user to experiment with the information displayed to a second user in the user profile of a first user. For example, based on machine learning and training historical data relevant to the first user and users similar to the first user, the user profile of the first user can vary based on attributes of the current transaction between the first user and the second user. In an example scenario, in a first transaction, the first user is receiving $5 from the second user, accordingly a first set of trust signals, social nodes or social trust scores are displayed, and in a second transaction, the first user is receiving $100 from the second user, accordingly a second set of trust signals, social nodes or social trust scores are displayed, where the second set is different from the first set. This is to say that depending on a perceived risk with a transaction, the trust signals can be dynamically modified and displayed to the second user to indicate to the second user that a first transaction may have lower likelihood of fraudulent behavior than a second transaction.

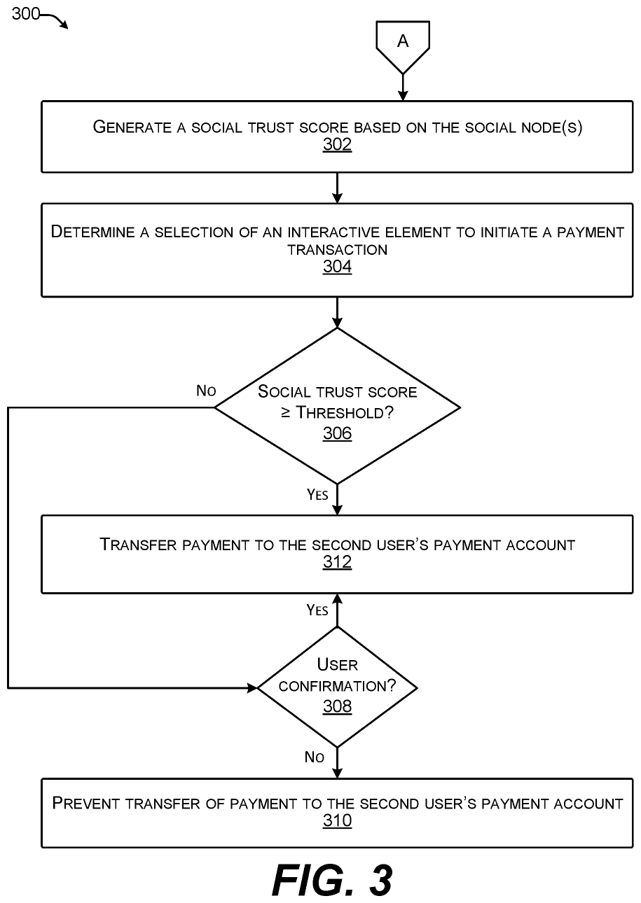

FIG. 3 illustrates a flow diagram of a method 300 for transferring, or preventing a transfer of, an electronic payment from a first user to a second user based on a social trust score, in accordance with presently disclosed examples. The method 300 may be performed utilizing server(s) 110 that may include hardware (e.g., a general purpose processor, a graphic processing unit (GPU), an application-specific integrated circuit (ASIC), a system-on-chip (SoC), a microcontroller, a field-programmable gate array (FPGA), a central processing unit (CPU), an application processor (AP), a visual processing unit (VPU), a neural processing unit (NPU), a neural decision processor (NDP), or any other processing device(s) that may be suitable for processing image data), software (e.g., instructions running/executing on one or more processors), firmware (e.g., microcode), or some combination thereof. As shown by the off-page reference “A” in FIGS. 2 and 3, the method 300 may continue from blocks 212 or 214 of the method 200.

The method 300 may begin at block 302 with the server(s) 110 generating a social trust score based at least in part on the set of social nodes determined at sub-block 210 of the method 200. This social trust score is sometimes referred to herein as a “confidence score.” In some examples, the social trust score corresponds to the number of social nodes determined at sub-block 210 of the method 200. That is, if the number of social nodes is eight, the social trust score may be eight, in some examples. In other examples, the social trust score may be computed based at least in part on the social node(s) determined at sub-block 210. For example, in particular examples, the payment service computing platform 108 may, utilizing one or more machine-learning models, determine a social trust score (e.g., from zero to 100, from zero to 1, etc.) for evaluating the “strength” of the trusted relationship between the first user and the second user. In particular examples, the set of social nodes determined at sub-block 210 of the method 200 may be combined and summarized by the payment service computing platform 108 to generate a social trust score corresponding to individual of the user profiles of the sending or recipient users. For example, in one example, if the potential recipient user is in the contacts list of the sending user and has also received electronic payments from, for example, more than five users known to the sending user, the payment service computing platform 108 may generate a “high” social trust score (e.g., above a threshold), indicating that the trusted relationship between the sending user and the potential recipient user is relatively strong. On the other hand, for example, if the potential recipient user is not in the contacts list of the sending user and has received electronic payments from, for example, less than three users known to the sending user, the payment service computing platform 108 may generate a “low” social trust score (e.g., below a threshold), indicating that the trusted relationship between the sending user and the potential recipient user is relatively weak.

The method 300 may then continue at block 304 with the server(s) 110 determining a selection of an interactive element by the first user to initiate a payment transaction. This interactive element may be presented in the first user interface at block 214 of the method 200 and may be selectable for initiating a payment transaction between the first user and the second user for a payment amount specified by the first user or requested by the second user. It is to be appreciated, however, that other ways of initiating a payment transaction may be performed at block 304 (e.g., the user uttering a voice command to “pay” the second user, or other forms of user input) to cause the payment service computing platform 108 to receive a request from the first user to initiate an electronic payment to the second user.

The method 300 may then continue at decision 306 with the server(s) 110 determining whether the social trust score generated at block 302 meets or exceeds (e.g., is equal to greater than) a threshold. The threshold can be personalized or customized for a user, such as the first (sending) user, the second (recipient) user, or both. In an example, the threshold evaluated at decision 306 is based on preferences of the first (sending) user or a risk metric associated with the first (sending) user, which in some examples, can be based on transaction data or other interaction data associated with the first (sending) user. On one hand, if the social trust score is determined not to meet or exceed the threshold, the method 300 may continue at decision block 308 with the server(s) 110 determining whether an indication of a confirmation is received from the electronic device of the first user indicating that the first user confirms to proceed with the payment transaction despite the below-threshold social trust score. For example, after the first user selects the interactive element at block 304 to initiate the payment transaction, the payment service computing platform 108 may generate, and cause to be displayed, a notification (e.g., “Are You Sure?”) to indicate to the first (sending) user that the second (recipient) user is not a trusted user based on the social trust score (e.g., that the second (recipient) user is not in the contacts of the first (sending) user, has not received payment from any users known to the first (sending) user, etc.), and the first (sending) user may select an additional interactive element associated with the notification to confirm that the first user wishes to proceed with the payment transaction despite the relatively-low social trust score. Accordingly, if no confirmation is received at decision block 308, the method 300 may continue at block 310 with the server(s) 110 preventing a payment amount corresponding to the payment transaction from being transferred from a first account of the first user to a second account of the second user, or otherwise disallowing an electronic payment from the first user to the second user. As an illustrative example, in particular examples, as will be further appreciated below with respect to FIGS. 4A-4I, the confirmation decision block 308 may include, for example, generating and displaying a notification (e.g., fail-safe notification) that includes an option for the sending user to provide another confirmation that she would like to proceed with the electronic payment to the potential recipient user even though the sending user's (e.g., first user) determined social trust relationship to the potential recipient user (e.g., second user) is not particularly strong (e.g., a social trust score below the threshold). In particular examples, the displayed notification may also include an option for the sending user to forgo providing the electronic payment to the potential recipient user by not providing confirmation (e.g., selecting to cancel the electronic payment). As a non-limiting example, in particular examples, in response to determining that the social trust score fails to satisfy the threshold, the payment service computing platform 108 may present, to the first user, a notification that the second user is not in the stored contacts of the first user or that the second user has not previously received an electronic payment from a threshold number of users having the predetermined relationship to the first user, and the first user may select a “cancel” interactive element via the user interface to provide an indication to the payment service computing platform 108 that the first user does not wish to proceed with the payment transaction at decision block 308, and the method 300 may then proceed to block 310 where the electronic payment is prevented (or disallowed).

On the other hand, if the social trust score meets or exceeds the threshold at decision block 306 or if a confirmation is received at decision block 308 (e.g., if the first user selects a “confirm” interactive element via the user interface to proceed with the payment transaction despite a below-threshold social trust score), the method 300 may continue at block 312 with the server(s) 110 transferring a payment amount corresponding to the payment transaction from a first account of the first user to a second account of the second user, or otherwise allowing an electronic payment from the first user to the second user. For example, the payment service computing platform 108 may update (e.g., credit or debit) ledger(s) (e.g., to indicate a withdrawal of a payment amount from the first user's account or a deposit of the same payment amount to the second user's account). It is to be appreciated that a transfer of an electronic payment may occur in response to the determination of the selection of the interactive element at block 304 without executing the logic to generate the social trust score and determine whether the social trust score meets or exceeds the threshold. In other words, the user may decide for herself, based on the indication(s) of the trust signal(s) displayed at block 214 of the method 200, whether to proceed with the payment transaction. The mechanism to request user confirmation and potentially prevent the transfer of a payment to the second user based on the social trust score is an optional, supplementary failsafe mechanism to mitigate misdirected payments.

Accordingly, the described techniques (e.g., the methods 200 and 300) may reduce the possibility of sending users inadvertently providing electronic payments to unintended recipient users, and further streamline the processing workload and data store management of the payment service computing platform 108 by reducing instances of payment disputes due to accidental transfers to incorrect recipients, requesting and completing return transactions, and so forth. Specifically, by determining, and causing display of indications of, the trust signals to preempt users from sending erroneous electronic payments and other electronic financial transactions and the subsequent reversal processes, the size, complexity, and capacity of the processing devices 110 (e.g., servers) and data stores 112 hosting the payment service computing platform 108 may be reduced due to reduced processing workload (e.g., reduced tasks, reduced applications, reduced requests, and so forth) and gratuitous creation of data store instances (e.g., payment disputes due to accidental transfers or other potentially unnecessary system flagging of electronic payment transactions).

FIGS. 4A-4I illustrate one or more running examples of the present techniques for generating unalterable (e.g., “read-only”) trust signals using data collected by the payment service computing platform during routine operations to facilitate sending users ensuring that a selected recipient is an intended recipient in the context of an electronic payment (e.g., “$25”), as discussed above with respect to FIGS. 2 and 3. FIGS. 4A-4I illustrate one or more user interfaces or one or more instances of a user interface that can be presented by an application, web browser, or other functional component on the user electronic device 104A. In some examples, the user interface(s) or instance(s) thereof can include user interface elements, which can be text, graphics, images, videos, or other elements, rendered or otherwise presented via the user interface(s) or instances thereof. In some examples, a user interface element can be selectable, such that the user interface element is an “interactive element” to initiate or otherwise trigger an action or process.

FIGS. 4A-4D depict running examples of respective user interfaces 402, 404, 406, and 408 that may be caused (e.g., by the payment service computing platform 108) to be displayed on a user electronic device (e.g., user electronic device 104A) when a selected recipient is an intended recipient (e.g., “Jane Smith 2”) in the context of an electronic payment or asset transfer. In contrast, FIGS. 4E-4I depict running examples of respective user interfaces 410, 412, 414, 416, and 418 that may be caused (e.g., by the payment service computing platform 108) to be displayed on a user electronic device (e.g., user electronic device 104A) when a selected recipient is not the intended recipient (e.g., “Jane Smith 1”) in the context of an electronic payment (e.g., “$25”).

For example, the user interface 402 of FIG. 4A illustrates that a sending user wishes to send a “$25” electronic payment to a recipient user. In response to the user then selecting interactive element 420 (e.g., “Pay”), the user interface 404 of FIG. 4B may be displayed, in which a suggestion 422 of the intended recipient user (“Jane Smith 2”) is displayed (e.g., displayed in response to a sending user typing into the search field one or more initial letters “Ja . . . ” of the intended recipient user “Jane Smith 2”). In response to the user then selecting the displayed suggestion 422 of the intended recipient user (“Jane Smith 2”), the user profile of the intended recipient user (“Jane Smith 2”) may be displayed, as illustrated by user interface 406 of FIG. 4C. Accordingly, a selection of the suggestion 422 is an example of user input that may cause the request to be received at block 202 of the method 200. For example, a selection of the suggestion 422 by the first user may cause the electronic device to send a request to view a user profile of a second user (e.g., “Jane Smith 2”) of a payment service. In this example, the request received by the server(s) 110 in response to a selection of the suggestion 422 is received in association with (or in the context of) a payment transaction with the second user (e.g., an electronic payment to the second user) because the first user indicates an intent to transfer an electronic payment (e.g., a “$25” electronic payment) to the second user (e.g., “Jane Smith 2”).

In particular examples, information determined based on the user profile of the intended recipient user (“Jane Smith 2”) can be displayed by the user interface 406. The user interface 406 is an example of the first user interface that can be displayed at block 214 of the method 200. In at least one example, as described herein (e.g., with respect to block 212 of the method 200) the payment service computing platform 108 can determine or generate trust signals based on the privately stored user information (e.g., user transaction history data, user purchase history data, user attribute data, user credit history data, user profile data, asset profile data of a user, user contextual data, user interaction data, user preference data, and so forth) associated with the intended recipient user (“Jane Smith 2”) or third-party data accessible from third-party computing platform(s). The user interface 406 may include indications 424 (or representations) of these trust signals (e.g., “Joined August 2017,” “Paid by 8 People You Know,” and “In Your Contacts”). These indications 424 are “public” in the sense that they are viewable by the first user who is viewing the user profile of the second user via the user interface 406. In some examples, the indication(s) 424 of the trust signal(s) presented via the user interface 406 may be unalterable (e.g., read-only) indications 424 that cannot be altered. In some examples, one or more users may be anonymized in the indication(s) 424 of the trust signal(s) presented via the first user interface. For example, the “8 people” referenced in the indication 424 of the trust signal are anonymized in the sense that they cannot be identified by the information displayed via the user interface 406. In this way, the present examples may determine, and display indications 424 of, one or more trust signals that may increase confidence that the user corresponding to the user profile being viewed via the user interface 406 is indeed the intended recipient user. Further, by de-identifying and anonymizing users in the indications 424 of the trust signals displayed via the user interface 406, the privacy of all users of the payment service can be respected and enforced.

In particular examples, the user interface 406 may also include an indication 425 (or other representation) of an identity (e.g., a photo thumbnail image) of the intended recipient user (“Jane Smith 2”). Because the sending user can readily see that the intended recipient user (“Jane Smith 2”) has received electronic payments from at least 8 users known to the sending user, and thus having the confidence that the selected recipient user is indeed the intended recipient user (“Jane Smith 2”), the sending user may then select the interactive element 426 to complete sending the “$25” electronic payment to the intended recipient user (“Jane Smith 2”) (as illustrated by user interface 408 of FIG. 4D). Selection of the interactive element 426 may be determined at block 304 of the method 300. In some examples, the selection of the interactive element 426 may be followed by the operations performed at blocks 306 and 312. For example, the payment service computing platform 108 may have generated a social trust score associated with the second user (“Jane Smith 2”) based at least in part on a set of social nodes between the first user and the second user, and may have determined that the social trust score meets or exceeds a threshold, and, thus, the payment amount of $25 may be transferred from the first user's account to the second user's (“Jane Smith 2's”) account, as depicted by the user interface 408 of FIG. 4D.

The user interface 410 of FIG. 4E illustrates another example in which the sending user wishes to send a “$25” electronic payment to a recipient user. In response to the user then selecting interactive element 428 (e.g., “Pay”), the user interface 412 of FIG. 4F may be displayed, in which an identifier 430 (e.g., “@JANESMITH”) of a recipient user (“Jane Smith 1”) is populated in the “To:” field shown in FIG. 4F. For example, “@JANESMITH” may be displayed in response to a sending user typing into the search field one or more initial letters “Ja . . . ” of the recipient user “Jane Smith 1”). In response to the user then selecting the displayed user identifier 430 (e.g., “@JANESMITH”) of the recipient user (“Jane Smith 1”), the user interface 414 of FIG. 4G may be displayed. Accordingly, a selection of the user identifier 430 is an example of user input that may cause the request to be received at block 202 of the method 200. For example, a selection of the displayed user identifier 430 by the first user may cause the electronic device to send a request to view a user profile of a second user (e.g., “Jane Smith 1”) of a payment service. In this example, the request in response to a selection of the displayed user identifier 430 is received by the payment service computing platform 108 in association with (or in the context of) a payment transaction with the second user (e.g., an electronic payment to the second user) because the first user is about to transfer an electronic payment (e.g., a “$25” electronic payment) to the second user (e.g., “Jane Smith 1”). Accordingly, the user profile of the recipient user (“Jane Smith 1”) may be displayed to the sending user, as illustrated by user interface 414 of FIG. 4G. The user interface 414 may also include the indications 432 of trust signals (e.g., “Joined April 2017,” “Paid by 1 Persons You Know,” and “Not In Your Contacts”). The sending user may then select the interactive element 434 (e.g., “Pay”) to proceed with sending the “$25” electronic payment to the recipient user (“Jane Smith 1”), or the sending user may decide not to proceed (e.g., by refraining from selecting the interactive element 434) based on the indications 432 of the trust signals displayed via the user interface 414.

In response to a determination by the payment service computing platform 108 that the interactive element 434 has been selected (e.g., at block 304 of the method 300), the operations performed at blocks 306, 308, and 312 of the method 300 may be performed. For example, the payment service computing platform 108 may have generated a social trust score associated with the second user (“Jane Smith 1”) based at least in part on a set of social nodes between the first user and the second user, and may have determined that the social trust score does not meet or exceed a threshold, and, thus, the notification 436 may be displayed via the user interface 416 of FIG. 4H in order to request confirmation from the first user before proceeding with the transfer of the payment amount of $25 from the first user's account to the second user's (“Jane Smith 1's”) account. For instance, the payment service computing platform 108 may determine that the recipient user (“Jane Smith 1”) is not in the contacts of the sending user and that the recipient user (“Jane Smith 1”) has exchanged money with only one other user known to the first user. Accordingly, the payment service computing platform 108 may not allow the “$25” electronic payment to be transferred to the recipient user (“Jane Smith 1”) without receiving confirmation from the first user that the first user wishes to proceed with the payment transaction. That is, the payment service computing platform 108 may generate and cause to be displayed a notification 436 within the user interface 416, along with one or more selectable options 438.

In the example of FIG. 4H, the sending user may select one or more of the selectable options 438 (e.g., “Confirm” or “Cancel”) displayed by the notification 436. In some examples, a selection of the “Confirm” option 438 may cause the payment service computing platform 108 to receive the user confirmation at block 308 of the method 300. For example, a selection of the displayed “Confirm” option 438 by the first user may cause the electronic device to send, to the payment service computing platform 108, a confirmation to proceed with the payment transaction. Accordingly, in response to receiving the user confirmation based on selection of the “Confirm” option 438, the payment service computing platform 108 may complete the transfer of the payment from the first user's account to the second user's account, as depicted in the user interface 418 of FIG. 4I.

FIG. 5 illustrates a flow diagram of a method 500 for enabling users to purchase one or more assets or to mirror an allocation of assets of another user, in accordance with presently disclosed examples. The method 500 may be performed utilizing server(s) 110 that may include hardware (e.g., a general purpose processor, a graphic processing unit (GPU), an application-specific integrated circuit (ASIC), a system-on-chip (SoC), a microcontroller, a field-programmable gate array (FPGA), a central processing unit (CPU), an application processor (AP), a visual processing unit (VPU), a neural processing unit (NPU), a neural decision processor (NDP), or any other processing device(s) that may be suitable for processing image data), software (e.g., instructions running/executing on one or more processors), firmware (e.g., microcode), or some combination thereof.

The method 500 may begin at block 502 with server(s) 110 determining a relationship between a first user and one or more users based at least in part on interaction data associated with the first user and the one or more users. Each of the one or more users determined at block 502 may have a profile (e.g., an asset profile) serviced by a payment service associated with the payment service computing platform 108. In some examples, determining the relationship at block 502 may include determining, at sub-block 504, one or more social nodes associating the first user and an identified group of users having asset profiles and associated assets maintained or serviced by the payment service. In some examples, the one or more users determined to have the relationship with the first user at block 502 may be a part of a “friend” network (e.g., a list of contacts, an external social networking platform, etc.) of the first user, a user having a comparably large following (“influencer,” “influencer-marketing user,” or “creator”), a user having the same interest or owning the same assets as the first user determined based on user interactions and transaction history, a user having an asset allocation that is currently “trending,” and so forth. In some examples, the relationship may be determined at block 502 using a machine-learning model, for example, based on user interaction data associated with the first user's interactions on the payment service computing platform 108. In some examples, the relationship determined at block 502 may be an indirect relationship, such as a relationship of the first user with a user(s) who has/have a relationship with the one or more users, or a relationship based on an interaction (e.g., a direct relationship) outside of the payment service. Determining the relationship at block 502 (or determining the social node(s)) at sub-block 504) may be triggered in various ways. For example, the payment service computing platform 108 may receive, from a payment application 114A executing on an electronic device of the first user, a request to view asset profile(s) of user(s) associated with the first user, or the user may launch the payment application 114A, and, in response, the payment service computing platform 108 may determine the one or more users (or the social node(s) associating the first user and the identified group of users having asset profiles maintained by the payment service). The respective asset profiles associated with the identified group of users may each include performance metrics, assets owned by the user, asset allocations (e.g., percentages), asset time held metrics, a listing of one or more users or assets interacted with by other users, all of which may be individually, privately, or publicly shared based on user preference.

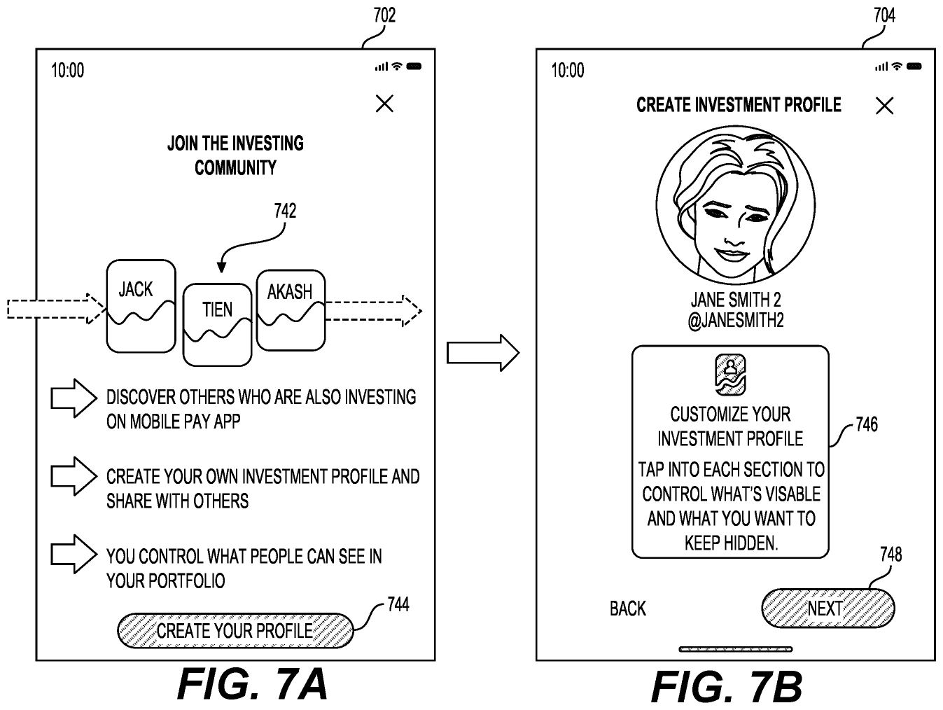

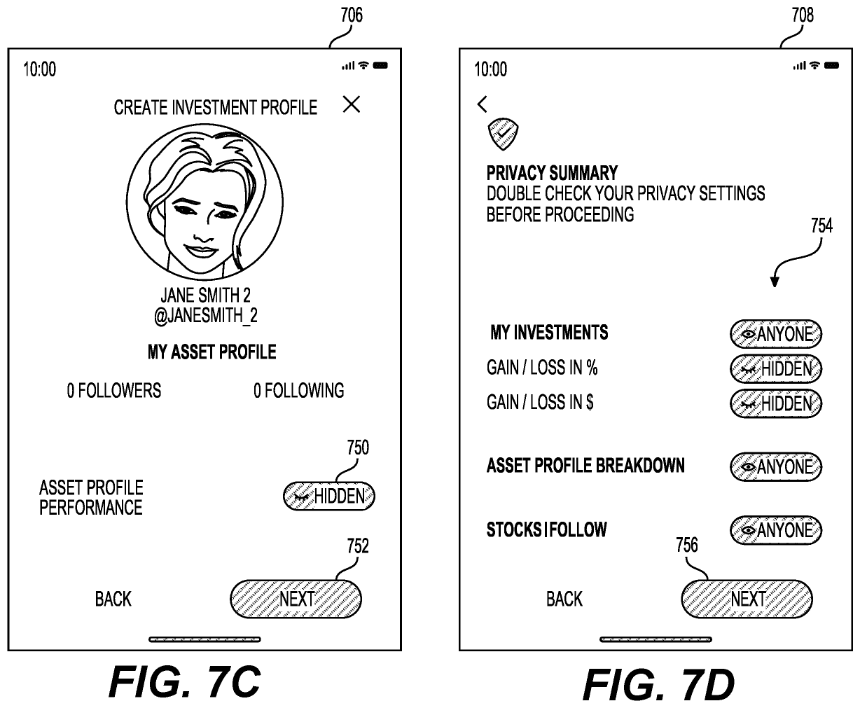

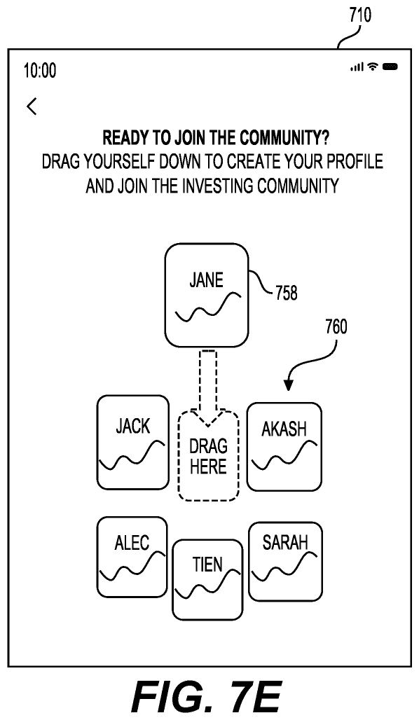

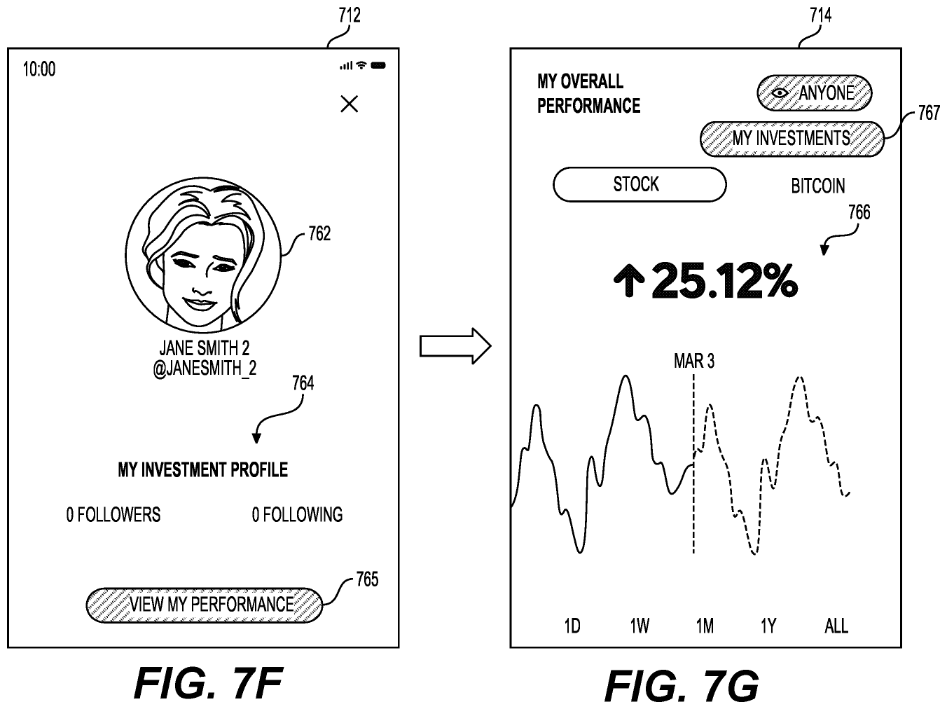

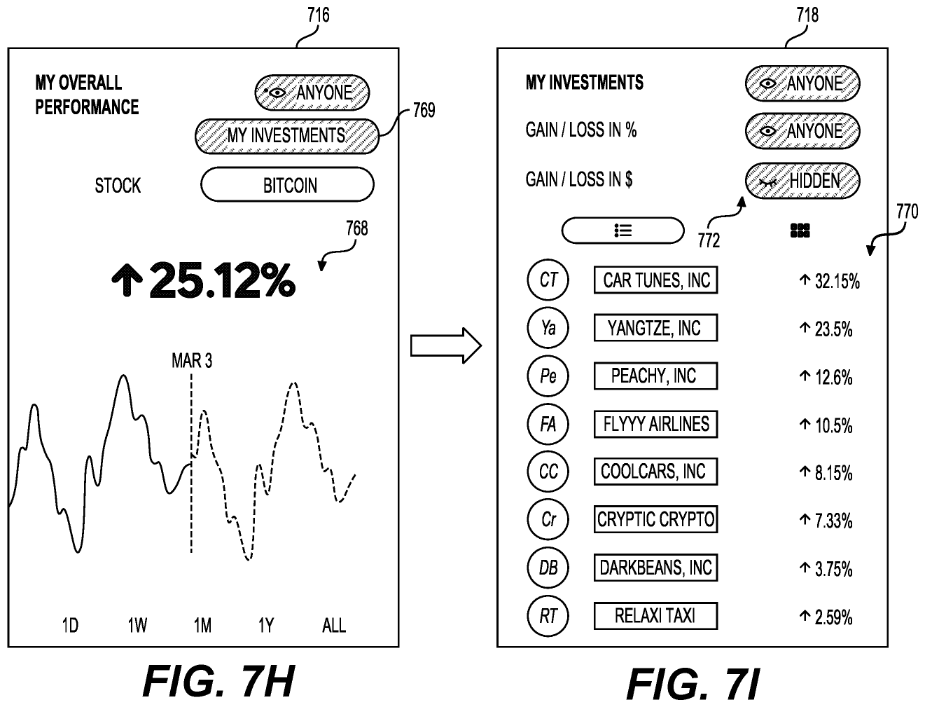

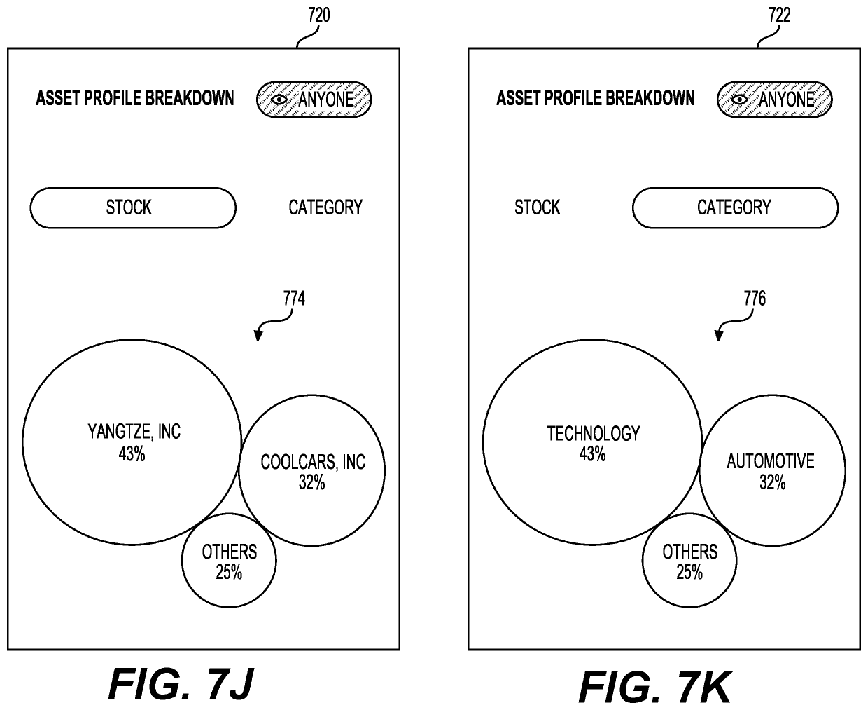

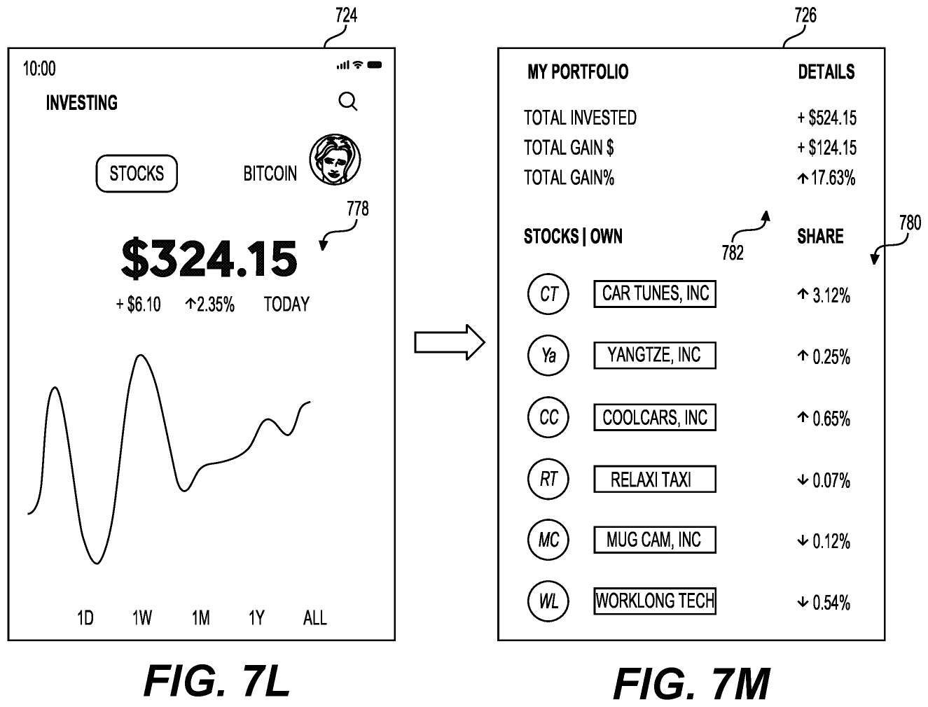

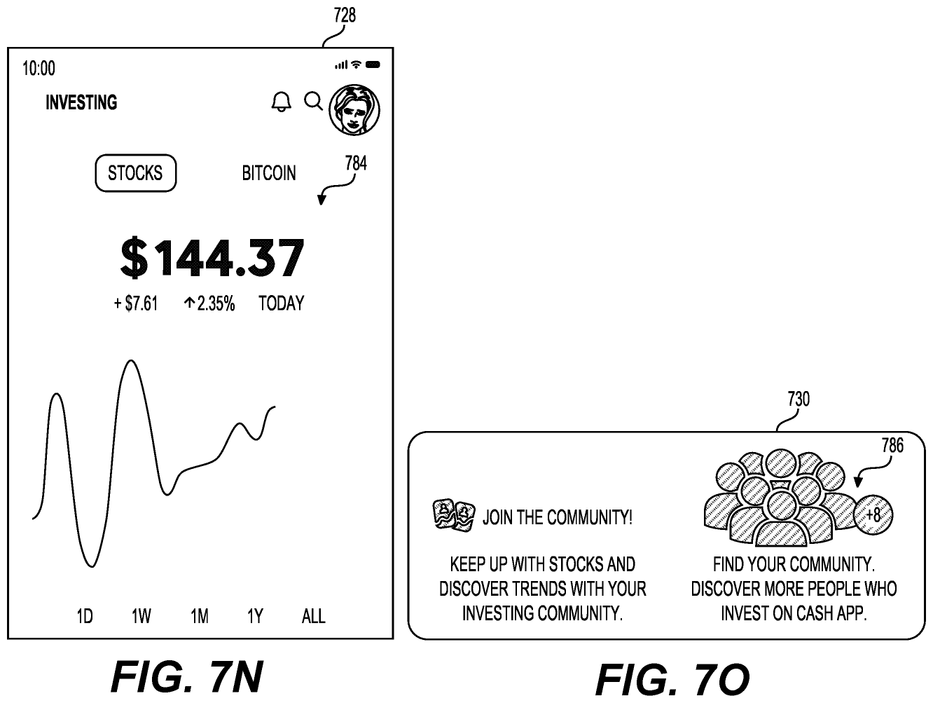

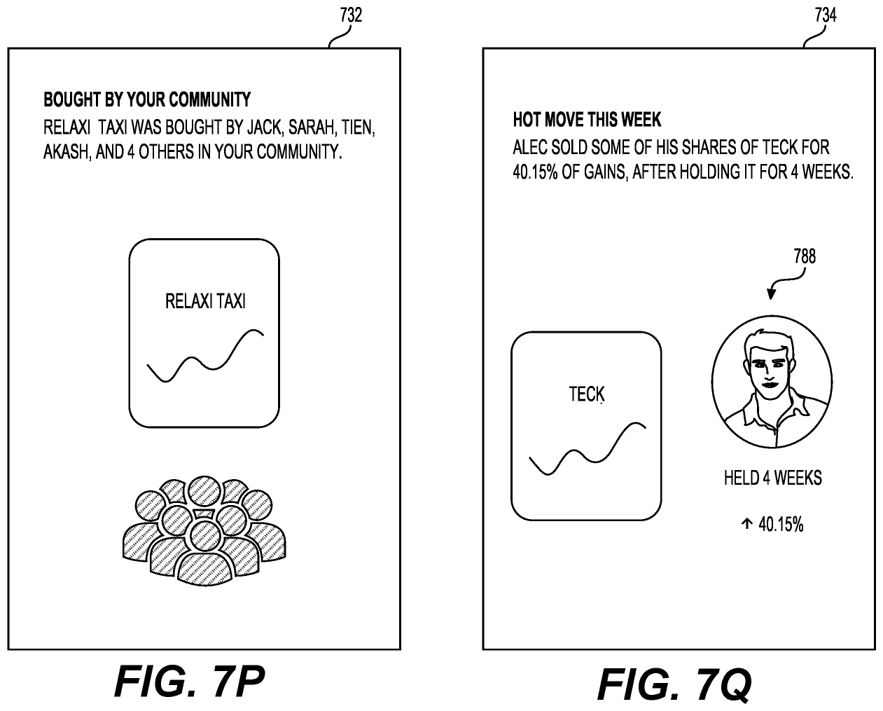

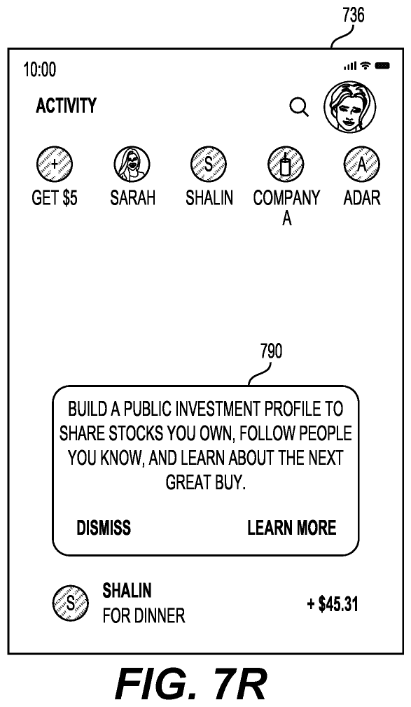

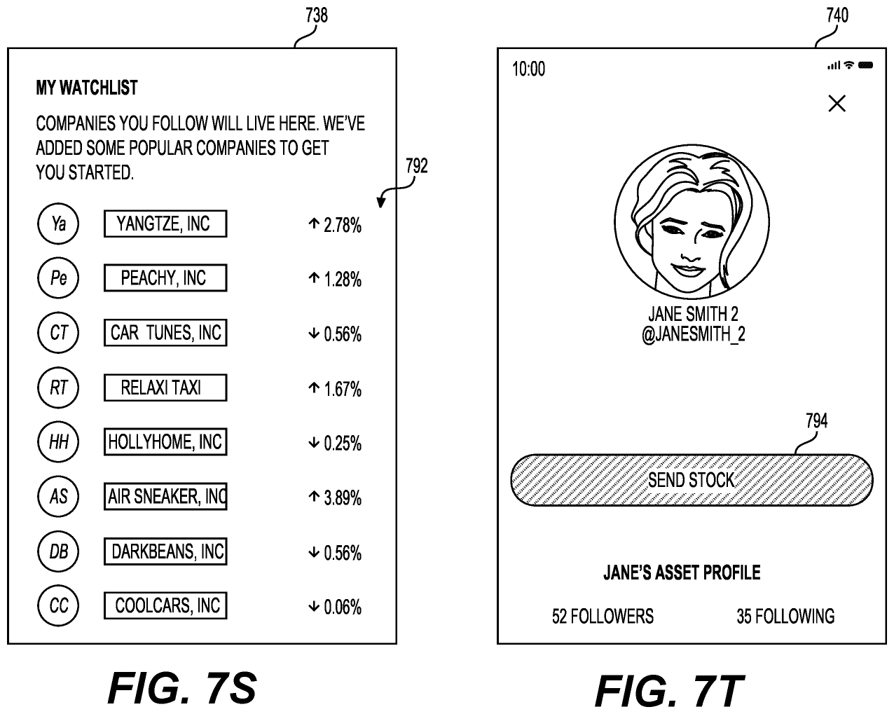

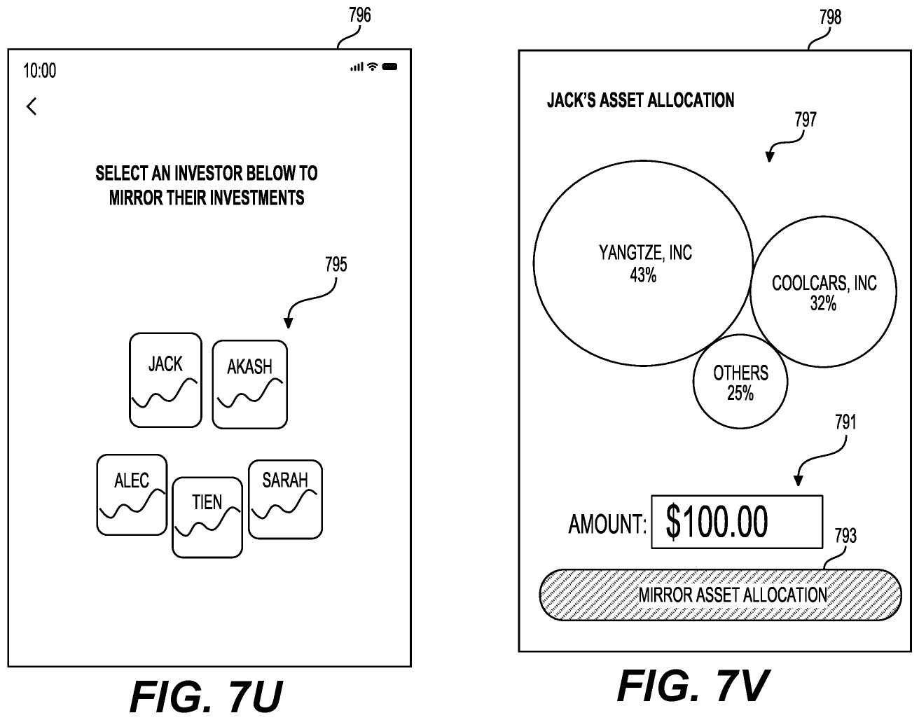

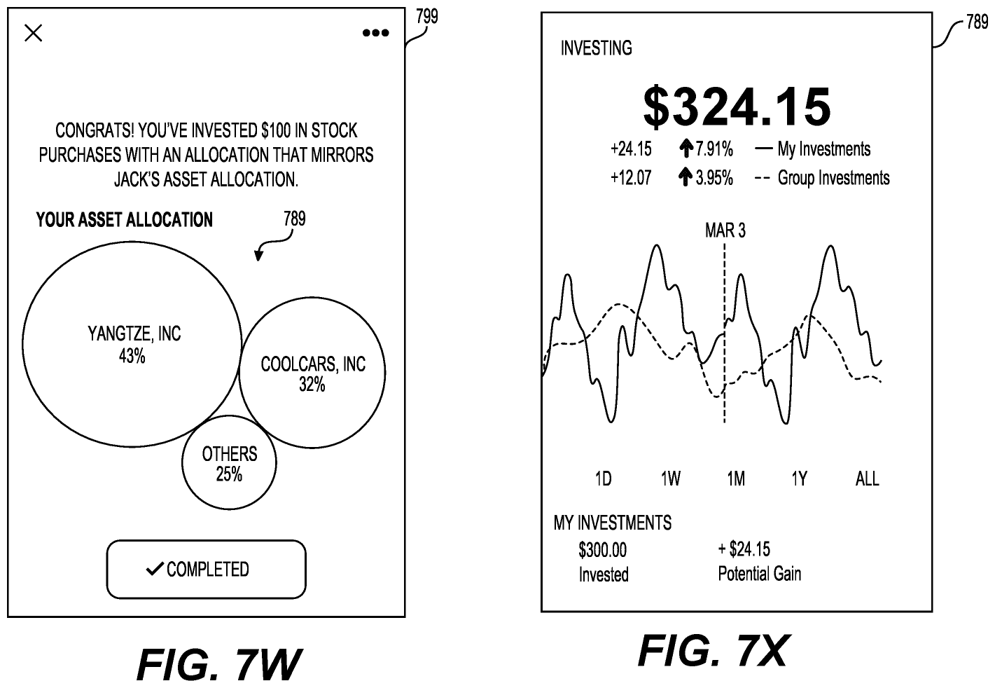

The method 500 may then continue at block 506 with the server(s) 110 causing display of one or more interactive elements corresponding to individual asset profiles of the determined user(s) (e.g., the identified group of users). The interactive elements may be displayed as tiles, icons, or similar user interface elements. In some examples, the interactive elements can be scrollable or otherwise interactive. An example of the interactive elements that can be displayed at block 506 is shown in FIG. 7U.

The method 500 may then continue at block 508 with the server(s) 110 determining a selection of one of the interactive elements (e.g., a first interactive element) to cause display of (i) an asset profile of a second user, the asset profile identifying a set of assets (e.g., stocks, bonds, mutual funds, ETFs, cryptocurrencies, NFTs, such as NFTs associated with music, art, or the like, and so forth) owned by the second user and an allocation of the set of assets, as well as (ii) a second interactive element that is configured to be interacted with (e.g., selectable) to request to purchase assets that correspond to (e.g., mirror) the allocation of the set of assets owned by the second user. The user interface 798 of FIG. 7V, described in detail below, is an example of a user interface that can be displayed at block 508. That is, the assets owned by the second user may be displayed with a name of the asset, indications of a percentage ownership amount in each of the set of assets, and, in some examples, visual indicators that represent the asset allocation percentage, such as circles of varying sizes. In other examples, the assets owned by the second user may be displayed in a list, a table, or the like. The display of the asset profile and the second interactive element at block 508 may be implemented in the payment service computing platform 108 or another connected platform. In some examples, the display of the asset profile of the second user to the first user is based on a setting that authorizes the first user to view the asset profile of the second user (e.g., the second user having set her asset profile to “public”). In some examples, the first user may be authorized to view the second asset profile based on other factors, such as if the first user follows the second user, if the first user is included in a list of contacts of the second user, etc. In some examples, the allocation of the set of assets may be identified in the asset profile of the second user as an asset allocation percentage that indicates percentage ownership amount in each of the set of assets. In particular examples, the first user may create and customize her own asset profile in this way, based at least in part on an interaction by the first user with an interactive element corresponding to a particular user of the one or more users determined at block 502.

The method 500 may then continue at block 510 with the server(s) 110 receiving a request to purchase at least a subset of the set of assets based at least in part on a interaction with the second interactive element displayed at block 508. In at least one example, the request can be associated with a specified value amount of the subset to be purchased, and a selection to “mirror” the asset allocation percentages of the asset profile of the one or more users. For example, in addition to selecting to “mirror” the asset allocation percentages of the one or more users, the first user may also input a specified value amount to invest or otherwise use for purchasing assets. In some examples, mirroring may include mirroring at least a portion of a set of assets, replicating the allocation(s) or the asset class(es), or selective mirroring and inspired purchasing (e.g., the first user making individual selections of assets while viewing the second user's asset profile). In an illustrative example, Danielle can “mirror” Charlie's asset allocation by investing a specified value amount (e.g., $100) that is allocated as 60% Company A stock and 40% Bitcoin. As another example, Danielle's asset allocation may be similar, but different, than Charlie's (e.g., Danielle's asset allocation may be 65% Company A stock and 35% Bitcoin). In this example, Danielle's asset allocation may be considered as “mirroring” Charlie's asset allocation if her asset allocation shares an attribute with Charlie's (e.g., invest more in Company A stock than in Bitcoin). Accordingly, “mirroring,” as used herein, does not have to result in the exact same asset allocation or asset class, but can represent allocations or asset classes that have common attribute(s), such as same or similar performance, same or similar volatility, same or similar assets, same or similar diversification, same or similar returns, same or similar industry, etc. In some examples, a payment application executing on the electronic device of the user can automatically mirror the asset allocation percentages of the asset profile based on machine learning attributes of one or a combination of users that the user follows. In some examples, the user can create preferences as to performance, industries, etc. that can be used to find similar profiles (e.g., “like minded profiles”) and then create a mirrored profile.

In response to determining that the request to purchase is received, the method 500 may then continue at decision 512 with the server(s) 110 determining, based at least in part on the allocation of the set of assets, units for each of the assets of the subset to be purchased in accordance with a specified value amount of the subset to be purchased. For example, in particular examples, the payment service computing platform 108 may calculate, based on the specified value amount and the price per individual unit (e.g., share, Bitcoin, etc.) of the assets associated with the asset profile of the second user, the number of whole units or fractional units for each of the assets that may be purchased to satisfy the mirroring of the allocation of assets owned by the second user. In some examples, a determination of whole units verses fractional units at block 512 may be based on a determination that the specified value amount is greater than a threshold sufficient to purchase whole units for each of the assets based on the price of an individual unit of the assets. That is, if the payment service computing platform 108 determines that the specified value amount meets or exceeds the threshold sufficient to purchase whole units for each of the assets, then whole units may be determined at block 512. On the other hand, if the payment service computing platform 108 determines that the specified value amount does not meet or exceed the threshold such that the specified value amount is insufficient to purchase whole units for each of the assets (or that some remaining amount after the purchase of whole units is insufficient to purchase further whole units), then fractional units, or a combination of whole units and fractional units are determined at block 512. In some examples, the payment service computing platform 108 may determine whole units or fractional units for each of the assets to be purchased in accordance with the specified value amount and based on the mirrored asset allocation percentages.

The method 500 may continue at block 514 with the server(s) 110 assigning ownership interest of the units to an account associated with the first user. In some examples, the assigning at block 514 is based on a purchase of whole units of the assets based on the allocation of assets owned by the second user and the specified value amount. In other examples, the assigning at block 514 is based on a purchase of fractional units of at least one of the assets based on the allocation of assets owned by the second user and the specified value amount. For example, the payment service computing platform 108 may update (credit or debit) ledger(s) of a ledger system based on the amount of the asset being assigned (e.g., to indicates a withdrawal of the amount from a holding account of the payment service, or a deposit of the amount to the first user's account). Notably, a ledger (e.g., an internal ledger) maintained by the payment service computing platform 108 may be beneficial to complete an assignment of the ownership interest in real-time during the method 500. For example, even when an exchange market is closed, an assignment of ownership of an asset may still occur as a result of performing the method 500 because the payment service can purchase assets in advance and maintain the assets in payment service holding accounts for users to acquire at any time, including at times when an exchange market may be closed, all while keeping track of credits and debits through the use of ledgers, as described herein. Further, in the example of cryptocurrency, using the ledger system can expedite the transaction processing time such to enable assignments to occur in real-time or near real-time.

In some examples, the assigning at block 514 may include assigning, at sub-block 516, additional ownership interest of the units from the account associated with the payment service to respective accounts associated with a pool of investors, which may include the first user and the one or more users determined at block 502. That is, if the purchasing user represents an investment broker who is investing on behalf of an investor community, as described herein, the purchase of the asset(s) may result in an assignment of ownership interest in the asset(s) to the multiple accounts of the investor community of which the purchasing user is a member.

Thus, in accordance with the forgoing examples, a social networking and asset-sharing based payment service computing platform 108 may be provided that prompts and encourages users to interact and engage with the payment service computing platform 108 more frequently (e.g., creating, updating, and customizing user asset profiles; sharing asset profiles with “friends” on the platform or external to the platform; managing and adjusting asset allocation percentages based on real-time market data and user interaction data, communicating asset strategies among “friends” or “followers”; and so forth). Additionally, the foregoing examples may allow users to invest in less risky assets and to pool with other investors having similar interests determined based on machine-learning surfaced data, such as user interaction data, transaction history data, or data associating a group of users.

Further, by allowing individual users to share and “mirror” the asset allocation percentages of one or more “friend” users or other users the individual user “follows,” the foregoing examples may streamline the processing workload and data store management of the payment service computing platform 108 by reducing instances of high-frequency purchasing and selling of individual assets and by reducing the number of iterations of purchases of individual assets (e.g., since “mirroring” allows for the individual assets to be purchased all at once as a package). Specifically, by allowing individual users to share and “mirror” the asset allocation percentages of one or more “friend” users or other users the individual user “follows,” the size, complexity, and capacity of the data centers and servers hosting the payment service computing platform 108 may be reduced due to reduced scaling of processing device 110 (e.g., servers) workload (e.g., tasks, applications, requests, and so forth) and data store 112 capacity (e.g., reduced scaling of data store 112 management and capacity for individual instances of individual assets of each of thousands or millions of users).

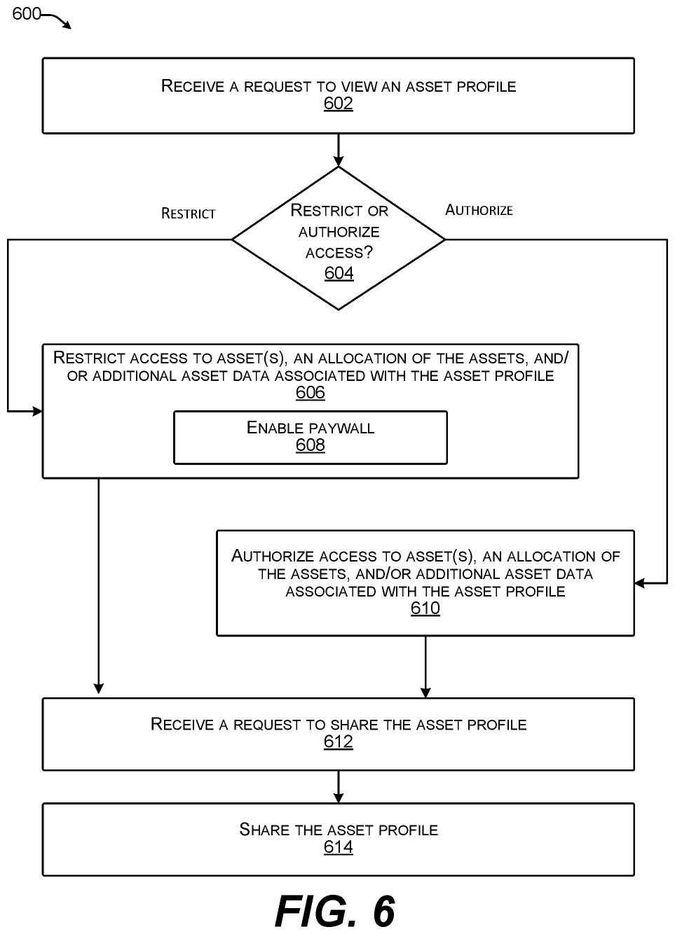

FIG. 6 illustrates a flow diagram of a method 600 for enabling users to share asset “profiles” with users of the payment service computing platform, in accordance with presently disclosed examples. The method 600 may be performed utilizing server(s) 110 that may include hardware (e.g., a general purpose processor, a graphic processing unit (GPU), an application-specific integrated circuit (ASIC), a system-on-chip (SoC), a microcontroller, a field-programmable gate array (FPGA), a central processing unit (CPU), an application processor (AP), a visual processing unit (VPU), a neural processing unit (NPU), a neural decision processor (NDP), or any other processing device(s) that may be suitable for processing image data), software (e.g., instructions running/executing on one or more processors), firmware (e.g., microcode), or some combination thereof.

The method 600 may begin at block 602 with server(s) 110 receiving, from a payment application executing on an electronic device associated with a user, a request to view an asset profile associated with the user. In other words, the user may wish to view her own asset profile in order to customize the asset profile and determine what aspects of her asset profile to share publicly with others and what aspects of her asset profile to keep private.

The method 600 may continue at decision block 604 with the server(s) 110 determining whether there has been a user selection corresponding to a request to restrict access to (e.g., viewing of) or authorize access to (e.g., viewing of) one or more of a set of assets identified in the asset profile, an allocation of the set of assets, or additional asset data associated with the asset profile. Users may control how much of their asset profile is public or private at any point in time. For example, an individual user may limit viewing, interacting, “mirroring,” or other access to all or some aspects of her asset profile to only specified users (e.g., gated by request), her following users, or a “friend” network. In another example, the individual user may restrict viewing, interacting, “mirroring,” or other access to all or some aspects of her asset profile by deploying a paywall enabled by the payment service computing platform 108, such that the individual user may solicit paid subscriptions to access her asset profile. If the payment service computing platform 108 determines a request to restrict access at decision block 604, the method 600 may continue at block 606 with the server(s) 110 restricting access to (e.g., preventing a user(s) from viewing) a set of assets identified in the asset profile, an allocation of the set of assets, or additional asset data associated with the asset profile. In some examples, the restricting access at block 606 may include enabling, at sub-block 608, a paywall restricting access to the one or more of the set of assets, the allocation of the set of assets, or the additional asset data associated with the asset profile. In some examples, enabling the paywall at sub-block 608 is based at least in part on a subscription status of the user being restricted from access. If the payment service computing platform 108 determines a request to authorize access at decision block 604, the method 600 may continue at block 610 with the server(s) 110 authorizing access to (e.g., allowing users to view) a set of assets identified in the asset profile, an allocation of the set of assets, or additional asset data associated with the asset profile.

The method 600 may continue at block 612 with the server(s) 110 receiving, from a payment application executing on the electronic device associated with the user, a request to share an instance corresponding to the asset profile associated with the user. For example, the user may request to share the entire asset profile, or only particular assets or allocations of assets, with a particular user(s), or to everyone on the payment service computing platform 108.

The method 600 may continue at block 614 with the server(s) 110 sharing the instance corresponding to the asset profile, such as sharing the instance via the payment application executing on electronic devices of one or more users. In some examples, the sharing of the instance at block 614 may include sharing the instance via a service external to the payment service computing platform 108, such as a social networking service associated with a social networking platform. In some examples, the instance may be shared with users who follow the sharing user or a predefined set of one or more users who are authorized, by the sharing user, to view the asset profile. In particular examples, individual users may share their asset profiles with entities external to the payment service computing platform 108. For example, in particular examples, individual users may share images, dynamic webpage links, quick response (QR) codes, augmented reality (AR) or virtual reality (VR) objects, or one or more other instances corresponding to their asset profiles via multimedia messaging, email, social media posting, social media ephemeral content, AR/VR object interactions, and so forth. This may allow individual users to expand their community of investors by allowing the individual users to invite and encourage external entities to interact with their asset profiles and encourage added asset and engagement, all the while controlling how much of the user's asset profile is viewable at any point in time. In particular examples, individual users may also be allowed to create, customize, and manage pooled funds, in which the individual user may purchase and sell assets on behalf of a group of users having the same determined interest or other association to the individual user.

FIGS. 7A-7T illustrate one or more running examples of the present techniques for enabling users to create, customize, or share asset “profiles” among a group of users of a payment service computing platform, as discussed above with respect to FIG. 6. Specifically, FIGS. 7A-7T depict respective user interfaces 702, 704, 706, 708, 710, 712, 714, 716, 718, 720, 722, 724, 726, 728, 730, 732, 734, 736, 738, and 740 that may be caused (e.g., by the payment service computing platform 108) to be displayed on a user electronic device (e.g., user electronic device 104A) through a payment application as the user 102A, for example, creates, customizes, or share asset “profiles” or purchases, sells, or manages assets (e.g., stocks, bonds, mutual funds, ETFs, cryptocurrencies, NFTs, and so forth) or engage with the payment application and payment service computing platform 108 and other users 102B, 102C, 102D.

For example, the user interface 702 of FIG. 7A illustrates one or more interactive elements 742 of individual users in an identified group of users (e.g., “Jack,” “Tien,” “Akash,” and so forth) that have asset profiles on the payment service computing platform 108. In some examples, the interactive element(s) 742 can be static or dynamic. In examples where such interactive element(s) 742 are dynamic, the interactive element(s) 742 can move across the user interface 702 automatically or based on user interaction with the user interface 702 (e.g., via a scroll or a swipe).

In some examples, the group of users can be selected by a user. In some examples, the group of users can be identified by the payment service computing platform 108, for example, using machine-learning or other techniques. In particular examples, the group of users (e.g., “Jack,” “Tien,” “Akash,” and so forth) that may be identified based on, for example, user transaction history data, user purchase history data, user attribute data, user credit history data, user asset profile data, user contextual data, user interaction data, user preference data, or other data privately stored on the payment service computing platform 108 or accessible from third-party computing platform. In some examples, the group of users (e.g., “Jack,” “Tien,” “Akash,” and so forth) may include influencer-marketing users (e.g., an “influencers,” a “creator,” or similar user having a comparably large “following” of users on the payment service computing platform 108 (as compared to most other users on the payment service computing platform 108) and possessing one or more social capital or cultural capital, such that user's asset behaviors, asset interactions, activity with other users, and so forth, may influence the asset behaviors and asset interactions her “following” of users), celebrity users, celebutante uses, currently “trending” users, users all having the same determined interests or other associations (e.g., tech workers, gamers, financiers, chess players, frequent coffee drinkers, bar-hoppers, automobile enthusiasts, fine-dining patrons, demographically associated group of users, geographically associated group of users, and so forth) that may be identified and surfaced based on the vast privately and safely stored user data or third-party data that may be leveraged by the payment service computing platform 108 to prompt and encourage the user 102A to engage with the payment service computing platform 108 more frequently and more purposefully (e.g., and thus increase user engagement metrics across the payment service computing platform 108, as well as an improved overall experience of interacting with the payment service computing platform 108 for the user 102A).

In at least one example, the user interface 702 can include one or more prompts to create or customize an asset profile. In at least one example, a user can interact with an interactive element 744 (e.g., “Create Your Profile”) to initiate a profile creation process. In response to the user 102A (e.g., “Jane Smith 2”) selecting the interactive element 744 to create and customize her own asset profile, the user interface 704 of FIG. 7B may be displayed. As illustrated, the user interface 704 may include a notification 746 directing the user 102A (e.g., “Jane Smith 2”) through the creating and customization process of her asset profile with respect to, for example, determining the asset information that the user 102A (e.g., “Jane Smith 2”) would like to share as “public” and that in which the user 102A (e.g., “Jane Smith 2”) would to remain “private.” As used herein, “public” means viewable by at least one other user on any platform, such as when another user(s) authorized to access the asset profile can view the asset information via the payment application described herein. As used herein, “private” means not viewable by any other user on any platform besides the user who created the asset profile, such as when another user is not authorized to view the asset profile or particular asset information of a particular user via the payment application described herein. It should be appreciated that any or all of the asset data of the asset profile of the user 102A (e.g., “Jane Smith 2”) may be selectively hidden (i.e., “private”) or shown (i.e., “public”) based on the discretion of the user 102A (e.g., “Jane Smith 2”). In response to the user 102A (e.g., “Jane Smith 2”) selecting an interactive element 748 (e.g., “Next”) to commence the asset profile creating process, the user interface 706 of FIG. 7C may be displayed. In some examples, selection of the interactive element 748 may cause the request to be received at block 602 of the method 600. The user interface 706 shows that user 102A (e.g., “Jane Smith 2”) may select an interactive element 750 to either show or hide the performance metrics of her asset profile.

In response to the user 102A (e.g., “Jane Smith 2”) selecting an interactive element 752 (e.g., “Next”) to continue the asset profile creating process, the user interface 708 of FIG. 7D may be displayed. The user interface 708 shows that user 102A (e.g., “Jane Smith 2”) may review and select public and privacy settings 754 to either show (i.e., share publicly) or hide (i.e., maintain privately) her individual assets, asset allocation percentages of her asset profile, the stocks followed by the user 102A (e.g., “Jane Smith 2”), and so forth. In some example, the interactive element 756 can enable the user 102A to continue the asset profile creating process. In some examples, the next step can include selecting an investor community to join. An “investor community” (sometimes referred to herein as a “community of investors”) may include one or more investors who have asset profiles maintained and serviced by the payment service associated with the payment service computing platform 108 and who have agreed to be part of an investment group where the investors can collaborate and invest in assets as a cohesive unit of pooled funds. The user may gain access to asset profiles of other users in an investor community by joining the investor community. In some examples, a user may be able to pool resources with other users in an investor community by joining the investor community. These are merely examples of why it may be beneficial for a user to join an investor community. In some examples, users can add or remove themselves from investing communities at any time, and such association/disassociation is not dependent on the asset profile creation process as described herein.

After selecting the interactive element 756, or at any other suitable time, the user interface 710 of FIG. 7E may be displayed. In at least one example, the user 102A (e.g., “Jane Smith 2”) may select (e.g., by performing a drag and drop user gesture on the user electronic device 104A) to associate her asset profile 758 to a community of investors 760 (e.g., “Jack,” “Akash,” “Alec,” “Tien,” and “Sarah”). Of course, the user 102A can join a community of investors 760 through additional or alternative mechanisms, such as searching for investors that the user 102A may be personally familiar with and selecting to follow those particular users (e.g., a “brute-force” formation of a community of investors 560), by selecting an interactive element (e.g., icon, text, etc.), etc.

When a user joins an investor community, the asset profile or account of the joining user may be associated with the asset profiles or accounts of the current members of the investor community, or with a group identifier that associates the users, accounts, user profiles, asset profiles, or the like. In particular examples, once the user 102A (e.g., “Jane Smith 2”) joins her asset profile 758 to the community of investors 760 (e.g., “Jack,” “Akash,” “Alec,” “Tien,” and “Sarah”), any one of the community of investors 760 (e.g., “Jack,” “Akash,” “Alec,” “Tien,” and “Sarah”), including the user 102A (e.g., “Jane Smith 2”), may be designated as a “broker” or an “asset manager” by the consent of the other users to be allowed to create, customize, and manage pooled funds for the entire community of investors 560 (e.g., “Jack,” “Akash,” “Alec,” “Tien,” and “Sarah”) and the user 102A (e.g., “Jane Smith 2”). For example, if the user 102A (e.g., “Jane Smith 2”) is designated as the “broker” or the “asset manager,” the user 102A (e.g., “Jane Smith 2”) would purchase and sell assets (e.g., stocks, bonds, mutual funds, ETFs, cryptocurrencies, NFTs, and so forth) on behalf of the community of investors 760 (e.g., “Jack,” “Akash,” “Alec,” “Tien,” and “Sarah”) and the user 102A (e.g., “Jane Smith 2”) herself, for example. For example, in particular examples, once the user 102A (e.g., “Jane Smith 2”) is designated as a “broker” or an “asset manager,” the payment service computing platform may associate future asset purchases or sells performed by the user 102A (e.g., “Jane Smith 2”) with respect to her investment account and mirroring those future asset purchases or sells with respect to the investment accounts of the community of investors 760 (e.g., “Jack,” “Akash,” “Alec,” “Tien,” and “Sarah”) without any of the community of investors 760 (e.g., “Jack,” “Akash,” “Alec,” “Tien,” and “Sarah”) having to perform any tasks themselves. The funds of the investor community may be pooled in various ways. In some examples, investors in the community of investors 760 may ante (or buy in) for any desired amount, and the respective allocation percentages of each investor who anted (or bought in) may be tracked such that, without further deposits to the pooled funds, the individual investor may retain her ownership percentage. As the broker makes investments and as the community receives returns on those investments, the ownership percentage may remain fixed unless the community of investors 760 agrees to change those percentages, such as if one of the investors in the community adds more funds to the pooled funds.

In particular examples, the user interfaces 712-726 of FIGS. 7F-7M may illustrate examples of the created asset profile 758 of the user 102A (e.g., “Jane Smith 2”), as may be displayed, for example, to another user or the user 102A herself viewing the asset profile 758 of the user 102A (e.g., “Jane Smith 2”). For example, user interface 712 of FIG. 7F illustrates a thumbnail image 762 of the user 102A (e.g., “Jane Smith 2”) and one or more indications 764 of a number of followers that follow the user 102A or users that are followed by the user 102A (e.g., “Jane Smith 2”). The user interface 712 may include an interactive element 765 (“View My Performance”) that, upon selection, causes display of the user interface 714. The user interface 714 of FIG. 7G illustrates a representation 766 of performance data associated with the asset profile of the user 102A (e.g., “Jane Smith 2”) and an indication that the performance data is publicly shared. In FIG. 7G, the performance data is associated with stock assets. The user may select “BITCOIN” in the user interface 714 to cause display of the user interface 716 of FIG. 7H, which illustrates performance data of cryptocurrency assets of the user 102A (e.g., “Jane Smith 2”) and an indication that the performance data of the cryptocurrency assets is publicly shared. In some implementations, the user interface 712 may include a virtual object of the user's payment card, a current location/or location of their last payment, or, for merchant profiles, boost or incentive offers available from a merchant, proximate merchant locations, or the like.

By selecting the interactive element 767 (“My Investments”) in the user interface 714 or the interactive element 769 (“My Investments”) in the user interface 716, the user interface 718 may be displayed. The user interface 718 of FIG. 7I illustrates the asset profile breakdown 770 of the stocks (e.g., “Car Tunes, Inc,” “Yangtze, Inc,” “Peachy, Inc,” “Flyyy Airlines,” “CoolCars, Inc,” “Cryptic Crypto,” “DarkBeans, Inc,” and “Relaxi Taxi”) owned by the user 102A (e.g., “Jane Smith 2”). As illustrated, the asset profile breakdown 770 also includes the stock symbols of the companies displayed together with the identity of the companies and the real-time market performance (e.g., gains, losses) of the individual stocks (e.g., “Car Tunes, Inc,” “Yangtze, Inc,” “Peachy, Inc,” “Flyyy Airlines,” “CoolCars, Inc,” “Cryptic Crypto,” “DarkBeans, Inc,” and “Relaxi Taxi”) owned by the user 102A (e.g., “Jane Smith 2”). In particular examples, the user 102A (e.g., “Jane Smith 2”) may select public and privacy settings 772, which may allow, for example, the user 102A (e.g., “Jane Smith 2”) to publicly share the stocks owned while maintaining more confidential information, such as the gains or losses of the user's asset profile, private or limited to “followers” or subscribers of the user 102A (e.g., “Jane Smith 2”).

In some examples, a user interface can present allocation data associated with the asset profile of the user 102A. For example, the user interface 720 of FIG. 7J includes representations 774 of asset allocation percentages of specific stocks assets (e.g., “Yangtze, Inc 43%,” “CoolCars, Inc 32%,” and “Others 25%”) owned by the user 102A (e.g., “Jane Smith 2”). The user interface 722 of FIG. 7K includes representations 776 of asset allocation percentages of categories (e.g., industry sectors) of stock assets (e.g., “Technology 43%,” “Automotive 32%,” and “Others 25%”) owned by the user 102A (e.g., “Jane Smith 2”).

The user interface 724 of FIG. 7L illustrates that the user 102A (e.g., “Jane Smith 2”) may view a representation 778 of daily performance data associated with her asset profile. The user interface 726 of FIG. 7M illustrates representations 780 of one or more individual stocks (e.g., “Car Tunes, Inc,” “Yangtze, Inc,” “CoolCars, Inc,” “Relaxi Taxi,” “Mug Cam, Inc,” and “WorkLong Tech”) that may be owned by the user 102A (e.g., “Jane Smith 2”), and further illustrates the representations 782 of gain/loss data for the individual stocks 780 owned by the user 102A (e.g., “Jane Smith 2”).

In particular examples, the user interfaces 728-740 of FIGS. 7N-7T may illustrate examples of the manner in which the payment service computing platform 108 may selectively prompt and encourage the user 102A (e.g., “Jane Smith 2”) to engage on the payment service computing platform 108 and with other users as the user 102A (e.g., “Jane Smith 2”) utilizes the payment service serviced by the payment service computing platform 108. For example, user interface 728 of FIG. 7N illustrates that the payment service computing platform 108 may detect that the user 102A (e.g., “Jane Smith 2”) is viewing a daily performance 778 and may then generate a user interface notification 730 of FIG. 7O, prompting the user 102A (e.g., “Jane Smith 2”) to engage with a identified group of users 786 that may be known to the user 102A (e.g., “Jane Smith 2”) or associated with the user 102A (e.g., “Jane Smith 2”).

In some examples, the user 102A can join a community of investors, for example, during asset profile creating, in response to the user interface notification 730, or the like. For the purpose of this discussion, the user 102A can belong to a community of investors 760 comprising “Jack,” “Akash,” “Alec,” “Tien,” and “Sarah.” The user interface 732 of FIG. 7P and user interface 734 of FIG. 7Q illustrate that the payment service computing platform 108 may monitor the asset activity of each user of the community of investors 760 to which the user 102A (e.g., “Jane Smith 2”) belongs. The payment service computing platform 108 may then notify the user 102A (e.g., “Jane Smith 2”) of any significant changes to the asset profiles of the community of investors 760 (e.g., “Jack,” “Akash,” “Alec,” “Tien,” and “Sarah”) to prompt and encourage the user 102A (e.g., “Jane Smith 2”) to engage with the payment service computing platform 108 or other users of the investor community of the user 102A (e.g., “Jane Smith 2”) with respect to improving her asset profile. For example, the user interface 732 indicates that “Relaxi Taxi” stock was recently bought by “Jack,” “Tien,” “Akash,” and “Sarah” and other users of the community of investors 760. This may prompt and encourage the user 102A (e.g., “Jane Smith 2”) to also purchase “Relaxi Taxi” stock. Similarly, the user interface 734 indicates that “Teck” stock was recently sold by “Alec” 788 and that the “Teck” stock has recently had significant price gains. This may prompt and influence the user 102A (e.g., “Jane Smith 2”), for example, to also sell or purchase some shares of “Teck.”

The user interface 736 of FIG. 7R illustrates that the payment service computing platform 108 may provide a notification 790 to prompt and encourage the user 102A (e.g., “Jane Smith 2”) to update her asset profile when the payment service computing platform 108 detects that the user 102A, for example, is performing an electronic payment, a request for payment, or a purchase that may be otherwise unrelated to the asset profile of the user 102A (e.g., “Jane Smith 2”). The user interface 738 of FIG. 7S illustrates a “watch list” 792 of the user 102A (e.g., “Jane Smith 2”), in which a “watch list” 792 of stocks (e.g., “Yangtze, Inc,” “Peachy, Inc,” “Car Tunes, Inc,” “Relaxi Taxi,” “HollyHome, Inc,” “Air Sneaker, Inc,” “DarkBeans, Inc,” and “CoolCars, Inc”) determined to be of interest to the user 102A (e.g., “Jane Smith 2”) is suggested by the payment service computing platform 108 (e.g., utilizing one or more machine-learning models). In some examples, the “watch list” 792 or any other list of assets presented to the user 102A can be determined based at least in part on user data or context data. For example, individual assets can be selected for presentation based at least in part on transaction data associated with the user 102A, user preferences, geolocation of the user, assets that have been purchased by users similar to the user 102A, assets that have been purchased by users in community(s) with which the user 102A is associated, etc. In at least one example, one or more machine-learning models can be used to determine which assets to include or the order in which such assets are presented.

In particular examples, the “watch list” of stocks 792 may be provided to prompt and encourage the user to purchase one or more stocks suggested in the “watch list” of stocks 792 or to “follow” the listed companies to stay up to date on market information (e.g., share prices, yields, performance, and so forth) with respect to the companies determined to be of interest to the user 102A (e.g., “Jane Smith 2”).

The user interface 740 of FIG. 7T illustrates that the user 102A (e.g., “Jane Smith 2”) may select an interactive element 794 (e.g., “Send Stock”) to send stocks (e.g., owned by the user 102A or included in the “watch list” of stocks 792) or other assets (e.g., cryptocurrencies, gift cards, etc.) to other users of the community of investors 760 (e.g., “Jack,” “Akash,” “Alec,” “Tien,” and “Sarah”) or to other users external to the payment service by way of the third-party computing platform 119, for example. In particular examples, the stocks or other assets (e.g., cryptocurrencies, gift cards, etc.) may be sent as a token though an email, text message, social media posting, or social media ephemeral content via the payment service computing platform 108 or the third party computing platform 119. Additional details are provided below.

FIGS. 7U-7X illustrate one or more running examples of the present techniques for enabling users to purchase one or more assets or to mirror an allocation of assets of another user, as discussed above with respect to FIG. 5. Specifically, FIGS. 7U-7X depict respective user interfaces 796, 798, 799, and 789 that may be caused (e.g., by the payment service computing platform 108) to be displayed on a user electronic device (e.g., user electronic device 104A) through a payment application as the user 102A, for example, creates, customizes, or share asset “profiles” or purchases, sells, or manages assets (e.g., stocks, bonds, mutual funds, exchange-traded fund (ETFs), cryptocurrencies, non-fungible token (NFTs), and so forth) or engage with the payment application and payment service computing platform 108 and other users 102B, 102C, 102D.

For example, the user interface 796 of FIG. 7U may display interactive elements 795 corresponding to individual asset profiles of an identified group of users. The interactive elements 795 are an example of those that may be displayed at block 506 of the method 500. In response to a selection of an interactive element 795 (e.g., “Jack”), the user interface 798 of FIG. 7V may be displayed. The user interface 798 is an example of Jack's asset profile identifying a set of assets owned by Jack and an allocation 797 of the set of assets. The user interface 798 also includes a field 791 for the user 102A to specify a value amount (e.g., $100), as well as an interactive element 793 to mirror Jack's asset allocation based on the specified value amount entered into the field 791. The user interface 798 is an example of a user interface that can be displayed at block 508 of the method 500. Accordingly, the user 102A can select the interactive element 793 to request to purchase assets that correspond to (e.g., mirror) the allocation 797 of the set of assets owned by the Jack, in the example of FIG. 7V. In the example of FIG. 7V, the allocation 797 of the set of assets is identified in Jack's asset profile as an asset allocation percentage that indicates percentage ownership amount in each of the set of assets (e.g., “Yangtze, Inc.” 43%, “Coolcars, Inc.” 32%, and “Others” 25%). In particular examples, the user 102A may create and customize her own asset profile in this way, based at least in part on a selection by the user 102A of an interactive element 795 corresponding to a particular other user, and a subsequent request to mirror the asset allocation of that selected user. The user interface 799 of FIG. 7 W shows the user's 102A new asset allocation based on the investment of the specified value amount (e.g., $100) and the request to mirror Jack's asset allocation. The user interface 789 of FIG. 7X shows a comparison of the user's 102A investment performance to the investment performance of a group (e.g., a community of investors 760). It is to be appreciated that the user 102A may navigate to the user interface 789 in order to compare the user's 102A investment performance to any suitable entity's investment performance (e.g., another individual user's investment performance), another portfolio, another group of users, another standard (e.g., a stock market, etc.), or the like.

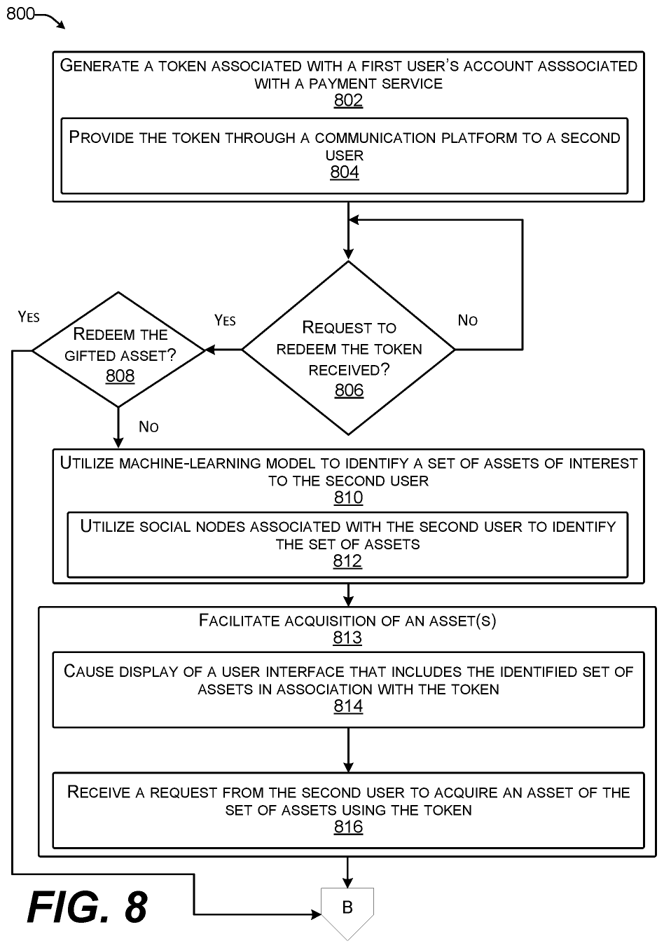

FIG. 8 illustrates a flow diagram of a method 800 for providing a token that may be shared publicly, activated for redemption, or applied to purchase one or more assets, in accordance with presently disclosed examples. The method 800 may be performed utilizing server(s) 110 that may include hardware (e.g., a general purpose processor, a graphic processing unit (GPU), an application-specific integrated circuit (ASIC), a system-on-chip (SoC), a microcontroller, a field-programmable gate array (FPGA), a central processing unit (CPU), an application processor (AP), a visual processing unit (VPU), a neural processing unit (NPU), a neural decision processor (NDP), or any other processing device(s) that may be suitable for processing image data), software (e.g., instructions running/executing on one or more processors), firmware (e.g., microcode), or some combination thereof.

The method 800 may begin at block 802 with server(s) 110 generating a token associated with a first user's account associated with a payment service. The token generated at block 802 may be a data structure that is stored in memory (e.g., in the data store 112 of the payment service computing platform 108). This data structure that represents the token may include data or metadata including, without limitation, an amount (e.g., $25), account(s) with which the token is currently associated, a number of transfers permitted, an expiration date or lifespan of the token, or other metadata. The token may be generated at block 802 in response to a trigger event, such as a first user associated with the first account requesting to gift the token to a second user or a group of users, a user accruing a reward threshold that causes the payment service computing platform 108 to generate the token automatically as a reward, in association with a transaction (e.g., as a “round-up” or “cash back” offer) or the like. In some examples, the token generated at block 802 is provided, at sub-block 804, through a communication platform to a second user. In some examples, the communication platform can be associated with the payment service computing platform 108. In some examples, the communication platform can be associated with a third-party computing platform 119. The communication platform may be any suitable communication platform, such as an application (e.g., a payment application) platform, an electronic mail (email) platform, a peer-to-peer communication platform, a text messaging platform, a push notification platform, multimedia messaging, social media posting, social media ephemeral content, AR/VR/XR object interactions, and so forth. In some examples, the token may be shared through such a communication platform in a variety of suitable formats, including, for example, dynamic webpage links, alphanumeric identifiers, images, videos, NFTs, QR codes, and one or more AR objects, VR objects, or XR objects, or other instances. The token may be used by the payment service computing platform 108 to grow its user base, by individual users to send gifts, by brands to incentivize asset ownership, by users on the payment service computing platform 108 to increase their following on the payment service computing platform 108, and so forth. In some examples, providing the token through the communication platform at block 802 includes providing the token through an application or a service external to the payment service computing platform 108, such as a third-party social networking platform. In some examples, providing the token through the communication platform at block 802 includes sending the token from a server computer to an electronic device of the second user. In other examples, providing the notification through the communication platform at block 802 includes sending a notification to the electronic device of the second user with information about where to access the token (e.g., a hyperlink, a payment application, an inbox, etc.).

The method 800 may then continue at decision block 806 with the server(s) 110 monitoring whether a request to redeem the amount associated with the token has been received, such as by determining an interaction with an interactive element or the like by the second user to redeem the token. In some examples, the token can be associated with a particular asset. In some examples, the user may know the asset for which they want to redeem the token. In some examples, when the token is redeemed, redemption, as described below, can occur automatically, without further input from the recipient. If a request to redeem the amount associated with the token has not been received, the method 800 may continue monitoring for receipt of the request at block 806 by following the NO route from decision block 806. In some examples, in response to determining that the request to redeem the amount associated with the token is received from an electronic device of the second user, the method 800 may then continue at decision block 808 with the server(s) 110 determining whether the redemption request is a request to redeem the asset that was gifted using (or designated for) for the token. In other words, the gifting user (or sender of the token) may designate a particular asset (e.g., a particular stock) that is associated with the token, and the second user who wishes to redeem the token may have the option of redeeming the amount associated with the particular asset (e.g., buying gifted stock in the amount associated with the token).

If the redemption request received is not a request to redeem the asset that was gifted using the token, the method 800 may then continue at block 810 with the server(s) 110 utilizing one or more machine-learning models to identify a set of assets to be recommended to the second user. In some examples, the machine-learning model(s) may be trained to infer a preference of at least one of the first user or the second user based on data input to the machine-learning model(s). Such input data may include, without limitation, a transaction history of the second user, user interactions of the second user, one or more third users associated with the second user (e.g., contacts of the second user, users who have interacted with (e.g., conducted payment transactions with) the second user, etc.) or data associated with the third user(s), and the like. In particular examples, the payment service computing platform 108 may utilize one or more machine-learning models to infer a preference of at least one of the first user or the second user and recommend or surface assets to which the token may be applied by analyzing user data, transaction data, or third-party data associated with users on the payment service computing platform 108 already having asset profiles to identify and recommend assets, asset profiles, or asset profiles to the second user upon redemption of the token. In particular examples, recommendations may be based on, for example, a transaction history of or involving the second user on the payment service computing platform 108, friends or contacts of the second user who are members of the payment service computing platform 108, the asset profile of the friends or contacts of the second user and other user's similar to the second user, and so forth. In some examples, the identifying of the set of assets at block 810 may include utilizing, at sub-block 812, utilizing one or more social nodes associated with the second user to identify the set of assets. In these examples, the one or more social nodes, as described herein, may represent nodes (e.g., other users, transaction history data points, data objects, metadata, objects of interests, user interactions, and so forth) of a social network of users on the payment service computing platform 108 that may indicate a social relationship between various users on the payment service computing platform 108, such as the second user and one or more third users, or a first user who gifted the token to the second user. In some examples, the social node(s) is/are determined based at least in part on a transaction history of the second user, a user interaction(s) of the second user, or the like. In some examples, the set of assets identified at block 810 may be determined by the second user (e.g., the second user selecting assets of interest from a menu or the like).

The method 800 may then continue at block 813 with the server(s) 110 facilitating acquisition of one or more assets for the second user, such as an asset(s) determined by the second user or an asset(s) determined based at least in part on the machine-learning model. Facilitating the acquisition of the asset(s) for the second user at block 813 may include, at block 814, the server(s) 110 causing a user interface of a payment application executing on the electronic device of the second user to display the identified set of assets of interest to the second user in association with the amount associated with the token. Causing display of the set of assets identified using the machine-learning model facilitates more efficient discovery of assets of interest to the second user, as compare to the second user having to iteratively search for assets of interest and consume computational resources of the payment service computing platform 108 to do so. This also provides a customized recommendation of a set of assets to which the token may be applied so that the redemption of the token can be personalized to the second user without the gifting user having to determine the interests of the second user.

Facilitating the acquisition of the asset(s) for the second user at block 813 may include, at block 816, the server(s) 110 receiving a request, from the electronic device of the second user, to acquire an asset of the set of assets displayed in association with the token at block 814. For example, the second user may select an interactive element associated with a particular asset of the identified set of assets or an icon that represents the asset the second user desires to acquire. In these examples, the token is redeemable to acquire the asset, regardless of the asset's base price. In some examples, the payment service computing platform 108 may automatically purchase the asset(s) on behalf of the second user who was gifted the token in response to the request to redeem the token received at block 806. That is, facilitating the acquisition of the asset(s) for the second user at block 813 may, in some examples, not involve any further input from the second user (or the user who gifted the token to the second user). In some examples, the payment service computing platform 108 may analyze transaction data and user interaction data associated with users on the payment service computing platform 108 already having asset profiles to automatically identify and facilitate acquisition of an asset(s) for the second user.

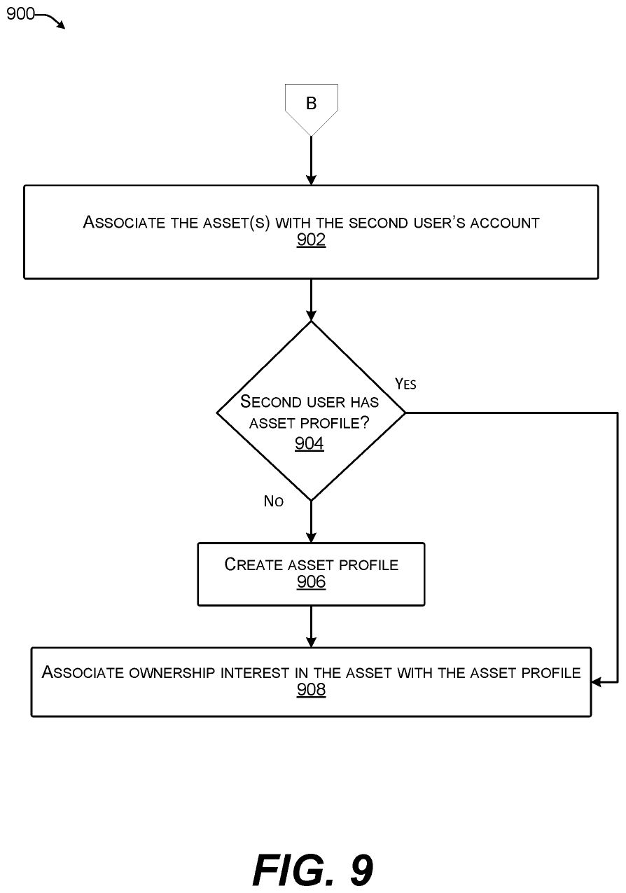

FIG. 9 illustrates a flow diagram of a method 900 for associating ownership interest in an asset based on a redeemed token or associating the ownership interested in the asset with an asset profile, in accordance with presently disclosed examples. The method 900 may be performed utilizing server(s) 110 that may include hardware (e.g., a general purpose processor, a graphic processing unit (GPU), an application-specific integrated circuit (ASIC), a system-on-chip (SoC), a microcontroller, a field-programmable gate array (FPGA), a central processing unit (CPU), an application processor (AP), a visual processing unit (VPU), a neural processing unit (NPU), a neural decision processor (NDP), or any other processing device(s) that may be suitable for processing image data), software (e.g., instructions running/executing on one or more processors), firmware (e.g., microcode), or some combination thereof. As shown by the off-page reference “B” in FIGS. 8 and 9, the method 900 may continue from block 808 or 816 of the method 800. In one implementation, the transfer of ownership can be automatically executed via smart contracts on satisfying a condition, e.g., when a specific asset profile or user profile is identified.

The method 900 may begin at block 902 with server(s) 110 associating the asset(s) with the second account. In the scenario where the redemption request received from the second user is a request to redeem the amount of the particular asset gifted using (or designated for) the token by the sending user, an ownership interest in the asset(s) associated at block 902 may be the ownership interest in the particular asset gifted using the token. For example, if a first (sending) user requested to gift the token to the second (recipient) user by gifting $25 in Company A's stock, ownership interest in Company A's stock may be transferred in the amount of $25 to the second user's account. If, on the other hand, the redemption request is not a redemption request to redeem the amount of the particular asset gifted using the token, and after the second user requested to acquire one of the assets identified using the machine-learning model(s), an ownership interest in the asset(s) associated at block 902 may be the ownership interest in the asset(s) identified using the machine-learning model(s) and subsequently selected by the second user.

In some examples, an ownership interest can be transferred from the first user's account to an account of the payment service and from an account of the payment service to the second user's account. In some examples, such transfers can be of the same assets. For instance, an amount of cryptocurrency can be transferred from the first user's account to an account of the payment service and from an account of the payment service to the second user's account. In such examples, adjustments to the ledger system can be made to reflect the transfer of ownership. In some examples, such transfers can involve a first asset that is used to purchase a second asset. For instance, fiat currency can be withdrawn from the first user's account and transferred to an account of the payment service. The payment service can use the fiat currency to purchase shares of stock, cryptocurrency, or a gift card. The shares of stock, cryptocurrency, or the gift card can be transferred or otherwise associated with the second user's account. In some examples, the fiat currency can be transferred from the payment service to the second user's account, and the shares of stock, cryptocurrency, or the gift card can be purchased with such transferred funds.

In particular examples, the method 900 may then continue at decision 904 with the server(s) 110 determining whether the second user has an asset profile on the payment service computing platform. For example, the processing device(s) may check the data store 112 for any record of an asset profile associated with the second user (e.g., based on an identifier of the second user). If the second user does not already have an asset profile on the payment service computing platform, the method 900 may continue at block 906 with the server(s) 110 creating (or provisioning) an asset profile for the second user. In this way, the present examples may prompt and encourage users of the payment service computing platform 108 that do not yet have an asset profile or one or more external entities to interact and engage with the payment service computing platform 108 more frequently and more purposefully. This may further streamline the processing workload of the server(s) 110 and data store 112 management on the payment service computing platform 108 by limiting advertisements and communications to only targeted users 102A, for example, determined based on inferred user 102A interests and the determined likelihood that the targeted user 102A may interact and engage with the payment service computing platform 108. Following the creation of the asset profile, or a determination at decision block 904 that the second user already has an asset profile on the payment service computing platform, the method 900 at block 908 with the server(s) 110 associating the asset with the asset profile of the second user. It is to be appreciated that token redemption may cause an asset(s) in the amount associated with the token to be automatically purchased. For example, redeemable tokens can be used for purchasing assets, or portions thereof, automatically without further input from recipient users. That is, a user can transfer assets or funds for acquiring assets to other users via the payment service computing platform 108 or via a social network computing platform on acceptance of the gift via application of a token. In some examples, the acceptance of a token (or interaction therewith) can cause the transfer or purchase of an asset(s) associated therewith automatically (without further interaction or input from the recipient), such as by a direct interaction with a blockchain to purchase the asset(s). The attributes of assets that are to be purchased may be same or similar to the profile of the receiving user or giving user, or dictated by the attributes of the token.

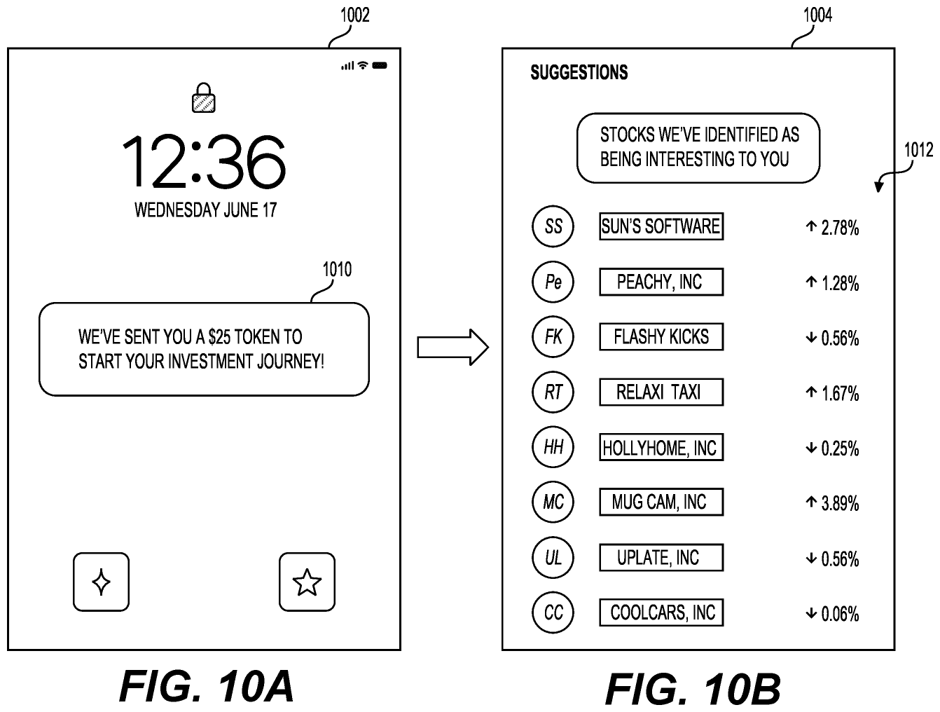

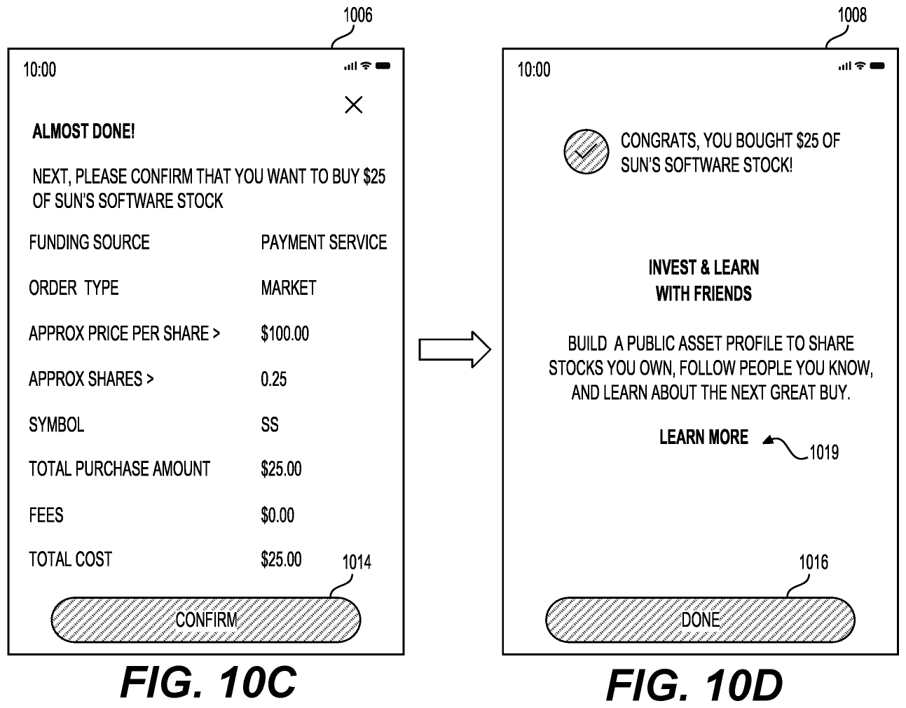

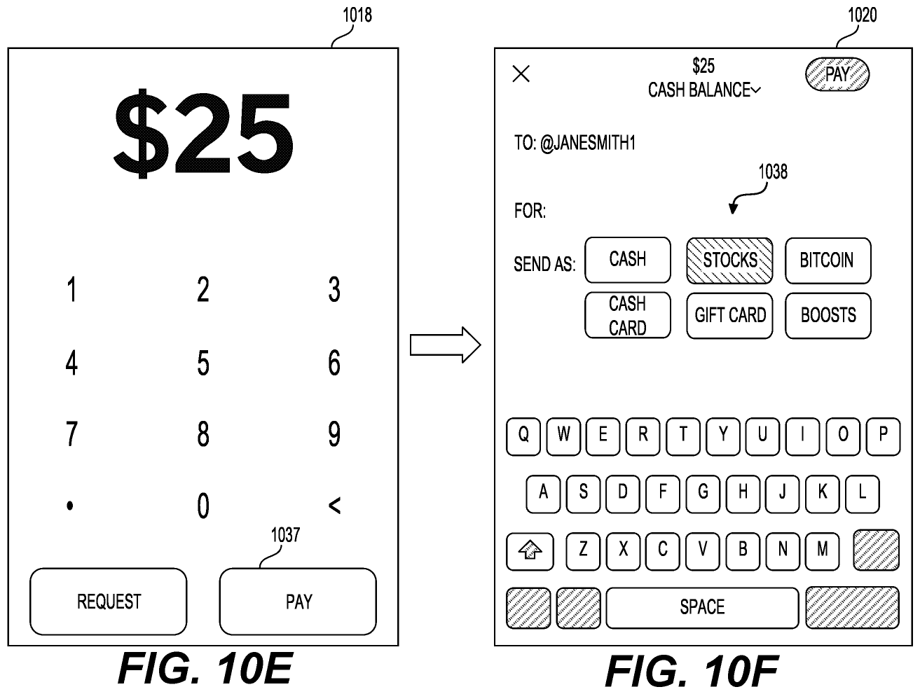

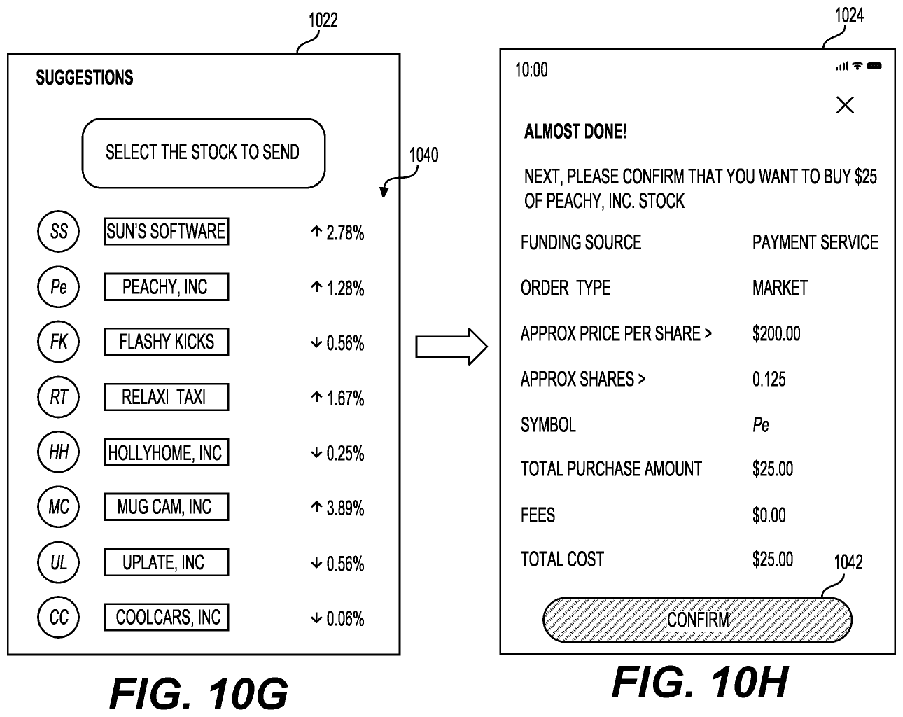

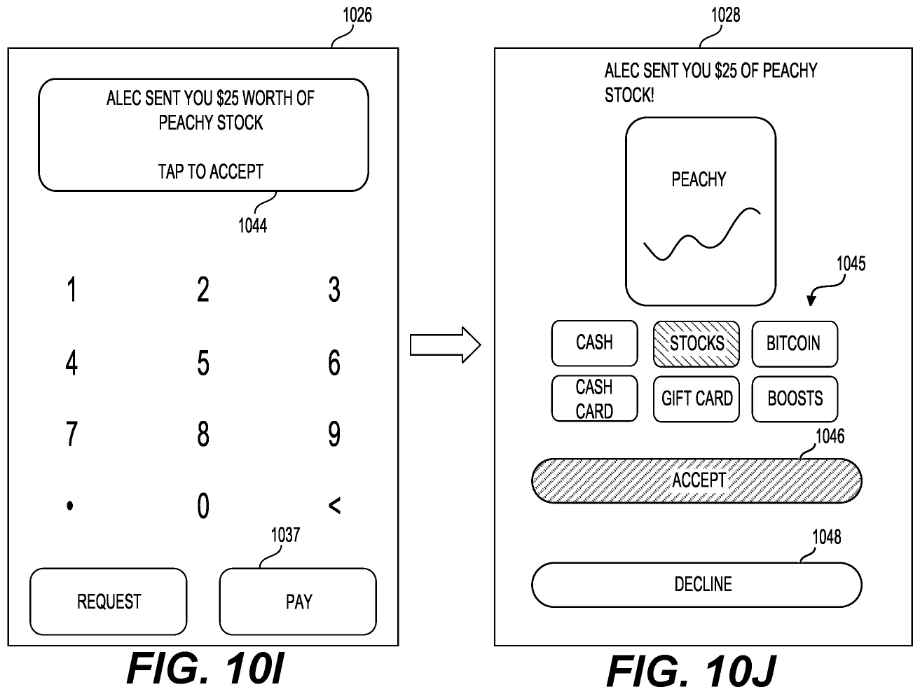

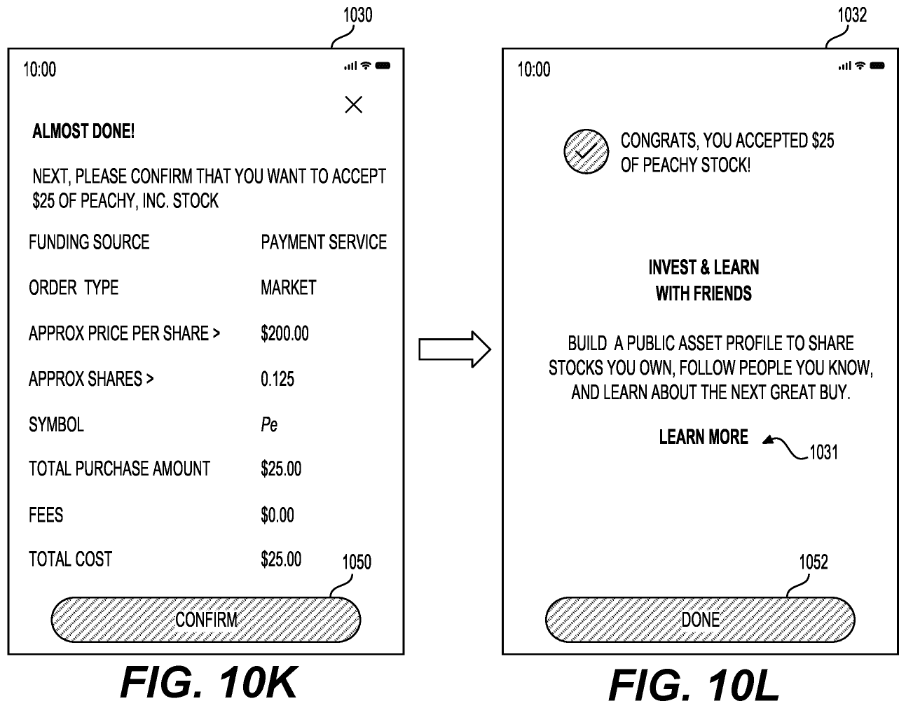

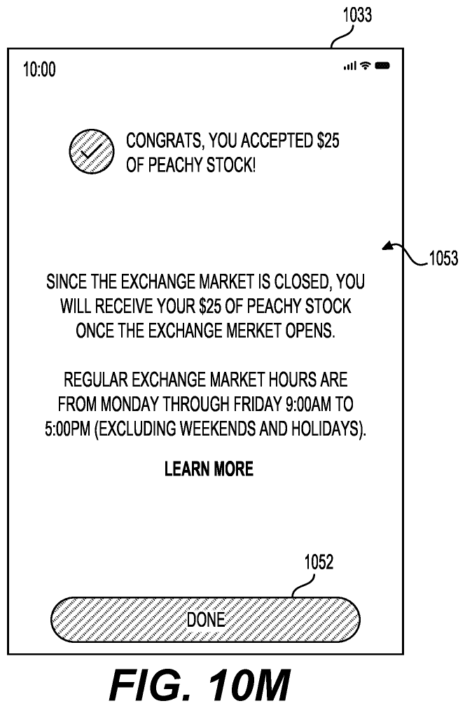

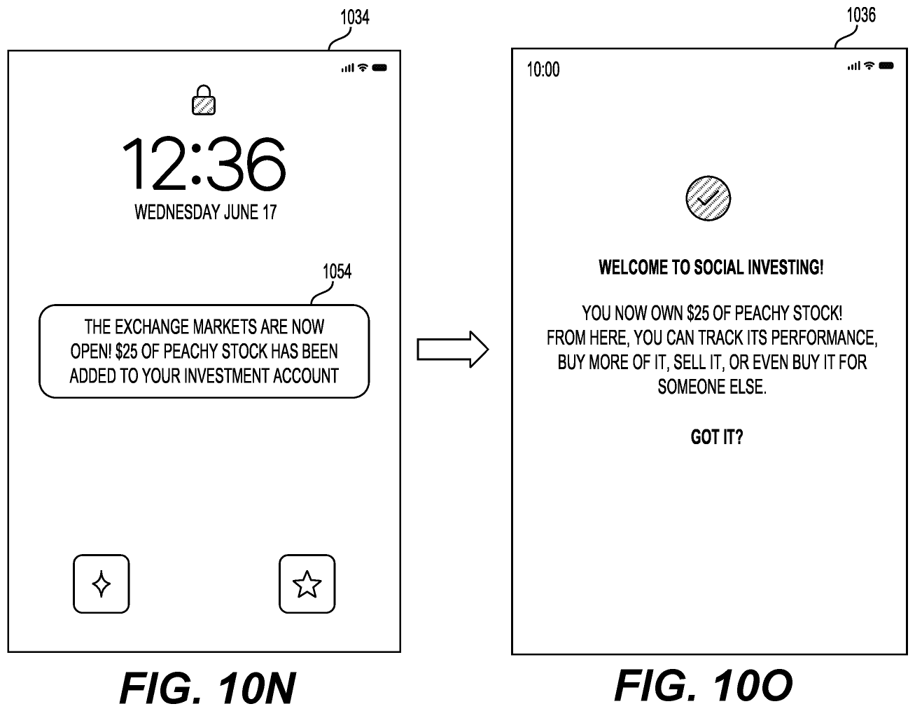

FIGS. 10A-100 illustrate one or more running examples of the present techniques for providing a token that may be shared publicly, activated for redemption, or applied to purchase one or more assets, as discussed above with respect to FIGS. 8 and 9. Specifically, FIGS. 10A-10D depicts respective user interfaces 1002, 1004, 1006, and 1008 that may be caused (e.g., by the payment service computing platform 108) to be displayed on a user electronic device (e.g., user electronic device 104A). For example, the user interface 1002 of FIG. 10A illustrates a selectable notification 1010, which indicates that the user 102A, for example, has received a token of $25 value. In some examples, the token can be sent from another user or the payment service. The user interface 1004 of FIG. 10B illustrates the resulting user interface in response to a user selection of the selectable notification 1010. In some examples, sending the notification 1010 to the electronic device 104A for display via the user interface 1002 may be an example of providing the token through a communication platform at block 804 of the method 800. Further, a selection of the selectable notification 1010 may cause the payment service computing platform 108 to receive a request to redeem the token at decision block 806 of the method 800.

For example, as depicted by the user interface 1004, the payment service computing platform 108, for example, may utilize one or more machine-learning models to identify and suggest a set of assets (e.g., “Sun's Software,” “Peachy, Inc,” “Flashy Kicks,” “Relaxi Taxi,” “HollyHome, Inc,” and so forth) determined to be of interest to the user 102A. The user interface 1004 can include representations 1012 of the set of assets suggested or recommended to the user 102A. In some examples, individual assets in the set of assets can be determined based on the user 102A transaction history, user 102A interactions, social nodes associating the user 102A with one or more other nodes, and so forth. In particular examples, the payment service computing platform 108 may utilize one or more machine-learning models to infer interests of the user 102A and recommend or surface assets to which the token may be applied by analyzing user data, transaction data, or third-party data associated with users on the payment service computing platform 108 already having asset profiles to identify and recommend assets, asset profiles, or asset profiles to the user 102A upon redemption of the token. In particular examples, recommendations may be based on, for example, a transaction history of or involving the second user on the payment service computing platform 108, friends or contacts of the second user who are members of the payment service computing platform 108, the asset profile of the friends or contacts of the second user and other user's similar to the second user, and so forth. The set of assets suggested via the user interface 1004 may be identified based on one or more social nodes associated with the user 102A, as described herein. In some examples, the set of assets suggested via the user interface 1004 are identified at block 810 of the method 800.

Although the set of assets suggested via the user interface 1004 are illustrated as stocks, it is to be appreciated that any other suitable type of asset (e.g., fiat currency (i.e., “cash”), cryptocurrency (e.g., Bitcoin), gift cards, cash cards, boosts, etc.) can be identified utilizing machine-learning model(s) and suggested via the user interface. In these examples, the amount of the $25 associated with the token can be converted to any suitable type of asset that the user 102A wishes to acquire through redemption of the token.

The user interface 1006 of FIG. 10C illustrates the resulting user interface in response to a user selection of the representation 1012 of Sun's Software stock in the user interface 1004 of FIG. 10B. In some examples, this selection of the representation 1012 of Sun's Software stock may cause a request to acquire Sun's Software stock to be received at block 816 of the method 800. In the example of FIG. 10C, the request to acquire Sun's Software stock is a request to acquire a fractional unit of “Sun's Software” stock because of the amount associated with the token and the approximate share price of Sun's Software stock. That is, in the illustrative example, Sun's Software stock is purchasable for $100 per share, and the token gifted to the user 102A is a $25 token. Accordingly, the request to acquire the asset is a request to acquire a 0.25 share of the asset (Sun's Software stock, in this example). In some examples, the user interface 1006 includes an interactive element 1014 for the user 102A to confirm the purchase. In some examples, a selection of the interactive element 1014 may cause a request to acquire Sun's Software stock to be received at block 816 of the method 800, if the selection of the representation 1012 of Sun's Software stock in the user interface 1004 did not otherwise cause such a request to be received.

The user interface 1008 of FIG. 10D illustrates the resulting user interface in response to a user selection of the interactive element 1014 to confirm the purchase, in which the user interface 1008 includes a notification indicating to the user 102A that a $25 fractional unit of Sun's Software stock was purchased, and that ownership interest in the acquired asset has been transferred to the user's account. The user may then select an interactive element 1016 (e.g., “Done”) to confirm completion of the electronic payment. For example, the payment service computing platform 108 may update a ledger that indicates a withdrawal of an ownership interest from a first account and a deposit of the ownership interest to the purchasing user's account. The user interface 1008 may also include an interactive element 1019 (“Learn More”) to prompt the user 102A to create an asset profile or join an investor community, as described herein. In some examples, a selection of the interactive element 1019 may take the user 102A through a series of steps to create an asset profile or join an investor community, as described herein (e.g., See FIGS. 7A-7T). At least some of these steps may be performed at block 906 of the method 900 to create an asset profile for the user 102A so that the acquired asset (e.g., Sun's Software stock) can be associated with the asset profile of the user 102A.

In some examples, the token can indicate a particular asset which can be redeemed via an acceptance of the gift. In such an example, the recommendation and/or selection described in FIG. 10B can be omitted.

FIGS. 10E-100 illustrate one or more running examples of the present techniques for providing a token that may be shared privately between users by one or more users and activated for redemption. Specifically, FIGS. 10E-100 depict respective user interfaces 1018, 1020, 1022, 1024, 1026, 1028, 1030, 1032, 1034, and 1036 that may be caused (e.g., by the payment service computing platform 108) to be displayed on a user electronic device (e.g., user electronic device 104A). For example, as depicted by the user interface 1018, a user 102A may select to pay interactive element 1037 to make an electronic payment to another user 102B.

At user interface 1020, the user 102A can provide terms of a payment or transfer of assets, such as what asset is to be transferred (e.g., fiat currency (i.e., “cash”), stocks, cryptocurrency (e.g., Bitcoin), gift cards, cash cards, boosts, etc.), an amount to be transferred, a funding source (e.g., which account of the sender's is the transfer to be withdrawn from), a recipient (which can be identified by a unique identifier, email address, phone number, etc.), or the like. In some examples, the user 102A may then select a user interface element of one or more user interface elements 1038 to send the asset amount as cash, stock, cryptocurrency, or the like. That is, the user interface 1020 can include one or more user interface elements 1038 that are representative of different types of assets, such as fiat currency (i.e., “cash”), stocks, cryptocurrency (e.g., Bitcoin), gift cards, cash cards, boosts, etc. In some examples, individual of the user interface element(s) 1038 can be personalized or customized based at least in part on user data or third-party data. For example, a “cash” user interface element can be presented in a fiat currency corresponding to a location of the sender or the recipient. In some examples, a “stock” user interface element can be presented as a particular stock, for example based on a selection by the sending user, preferences of the sender or recipient, previous transactions or gifts, or the like. In some examples, the order of the user interface elements 1038 can be determined based at least in part on user characteristics of the sender or recipient, preferences of the sender or recipient, characteristics of the transaction (e.g., amount), or other context. Each user interface element 1038 can be interactable such that a user can interact with it to indicate selection thereof.

The user interface 1022 may present a list 1040 of stocks to send to the other user 102B. Each of the stocks in the list 1040 may be selectable to send the corresponding stock. At user interface 1024, in reasons to selecting “Peachy, Inc.” stock from the list 1040 in the user interface 1022, the user 102A may confirm 1042 to send $25 of Peachy, Inc. stock to the other user 102B. At user interface 1026, the other user 102B may receive a selectable notification 1044 indicating that the other user has received $25 of Peachy, Inc. stock. Sending the selectable notification 1044 to the electronic device of the user 102B may be an example of providing the token through a communication platform at block 804 of the method 800. As illustrated in FIG. 10I, such a selectable notification 1044 can be presented in an activity feed. In some examples, such a selectable notification 1044 can be sent to the user as a text message, push notification, email, badge, or the like. A selection of the notification 1044 may cause the payment service computing platform 108 to receive a request to redeem the token at block 806 of the method 800. At user interface 1028, in response to a selection of the notification 1044 via the user interface 1026, the user 102B may select to either accept (via acceptance interactive element 1046) or decline (via decline interactive element 1048) the $25 of Peachy, Inc. stock received from the user 102A. While the transfer can be initiated in fiat currency, in at least one example, such fiat currency is not shown in a stored balance account associated with the user 102B. In at least one example, the fiat currency can be held by the payment service computing platform 108 until the intended asset (e.g., Peachy, Inc. stock) is purchased, at which time the user account is updated with the newly purchased asset. In particular examples, before selecting to accept the $25 of Peachy, Inc. stock received from the user 102A, the other user 102B may be presented with a set of options 1045 to select the manner (e.g., via cash, stock, Bitcoin, cash card, gift card, bargain boost, etc.) in which to receive the value amount of the $25 of Peachy, Inc. stock. The set of options 1045 presented via the user interface 1028 may be an example of a set of assets identified using a machine-learning model at block 810 of the method 800. Based on the selection of one of the options 1045 by the user 102B, the $25 of Peachy, Inc. stock may be issued as a stock, or converted to another form (e.g., cash, Bitcoin, cash card, gift card, bargain boost, and so forth) to be accepted by the user 102B at the discretion of the user 102B. A selection of an option 1045 followed by a selection of the interactive element 1046 may cause a request to acquire a corresponding asset to be received at block 816 of the method 800.

At user interface 1030, the other user 102B may then confirm (via confirmation interactive element 1050) receipt and acceptance of the $25 of Peachy, Inc. stock. In some examples, selection of the confirmation interactive element 1050 via the user interface 1030 may cause a request to acquire the asset (e.g., Peachy, Inc. stock) to be received at block 816 of the method 800, if selection of the interactive element 1046 via the user interface 1046 did not cause such a request to be received. In at least one example, based at least in part on a determination that the user 102B has accepted the $25 of Peachy, Inc. stock, the payment service computing platform 108 can purchase an amount of Peachy, Inc. stock on behalf of the user. At user interface 1032, the other user 102B may be provided a notification that the $25 of Peachy, Inc. stock has been added to her account, in which the other user 102B may acknowledged the notification via a done interactive element 1052. For example, the payment service computing platform 108 may update a ledger that indicates a withdrawal of an ownership interest from a first account and a deposit of the ownership interest to the purchasing user's account. The user interface 1032 may also include an interactive element 1031 (“Learn More”) to prompt the user 102B to create an asset profile or join an investor community, as described herein. In some examples, a selection of the interactive element 1031 may take the user 102B through a series of steps to create an asset profile or join an investor community, as described herein (e.g., See FIGS. 7A-7T). At least some of these steps may be performed at block 906 of the method 900 to create an asset profile for the user 102B so that the acquired asset (e.g., Peachy, Inc. stock) can be associated with the asset profile of the user 102B.

In some examples, a transfer can be accepted (e.g., via the interactive element 1050) but may not be immediately available to the user 102B. For example, the other user 102B may receive the $25 of Peachy, Inc. stock at a time in which the exchange markets are currently closed. In such an example, if an asset requires a purchase via an exchange that has hours during which assets can be bought or sold, the payment service computing platform 108 can wait until the exchange is open to complete the transaction and associate the asset (e.g., Peachy, Inc. stock) with the account of the user 102B. As illustrated in FIG. 10M, at user interface 1033, a notification 1053 that confirms that the other user 102B has indeed accepted e $25 of Peachy, Inc. stock, but that the exchange markets are currently closed is presented. The notification 1053 further notes that the other user 102B will receive the e $25 of Peachy, Inc. stock once the exchange markets are opened. The user interface 1034 may display a notification 1054 (e.g., after a time in which the other user 102B receives the $25 of Peachy, Inc. stock while the local or national exchange markets are currently closed, such as during the weekend or holiday). The notification 1054 in user interface 1034 indicates that the exchange markets are now open and that the other user 102B has received the $25 of Peachy, Inc. stock. In response to the other user 102B selecting the notification, the user interface 1036 may be displayed indicating that the other user now owns the $25 of Peachy, Inc. stock (e.g., received from the user 102A).

While FIGS. 8-100 refer to a transfer of stock via a token, techniques can be similarly applicable to any other asset, such as cryptocurrency, fiat currency, gift cards, or the like. Further, in some examples, when external networks (e.g., stock exchange, cryptocurrency exchange, etc.) are not used for transferring assets (e.g., ownership is transferred via modifications to a ledger system as described herein), such delay may not be encountered. That is, such a transfer can occur in real-time or near real-time without relying on whether the external networks are open or closed, or the time required to process a transfer (e.g., in cryptocurrency transfers).

It should be noted that in some examples, a sender can send “stock” to a recipient as described herein. In some examples, the stock is not existing stock that affects the sender's stock holdings. In some examples, the gift is initiated by a transfer of fiat currency, cryptocurrency, or the like that can be used to purchase stock on behalf of the recipient. In such examples, an account balance of the sender can be reduced by the amount of the gift, which can be used to purchase stocks, cryptocurrency, or the like on behalf of the recipient. The purchased stocks, cryptocurrency, or the like can be associated with an account of the recipient. In some examples, if the user 102B does not accept or otherwise claim the asset within a threshold period of time from when the transfer is initialized, the amount transferred can be associated with a stored balance of the user 102B. In other examples, if the user 102B does not accept or otherwise claim the asset within a threshold period of time from when the transfer is initialized, the payment service computing platform 108 can terminate the transfer or reverse the transfer back to the sender.

Techniques described herein can facilitate the transfer of assets between users. In some examples, such transfers can enable assets such as stocks and cryptocurrency to be treated as interchangeable and liquid similar to how fiat currency is treated in conventional technologies. That is, techniques described herein can enable users to transfer fiat currency to stocks or cryptocurrency, stocks or cryptocurrency to fiat currency, or the like. As described above, this can be completed “instantly” or in real-time, which can be accomplished by balancing one or more ledgers managed by the payment service computing platform 108. As such, techniques described herein offer an unconventional system that enables users to participate in peer-to-peer payments, which can include fiat currency or other assets, such as stocks, cryptocurrency, or the like.

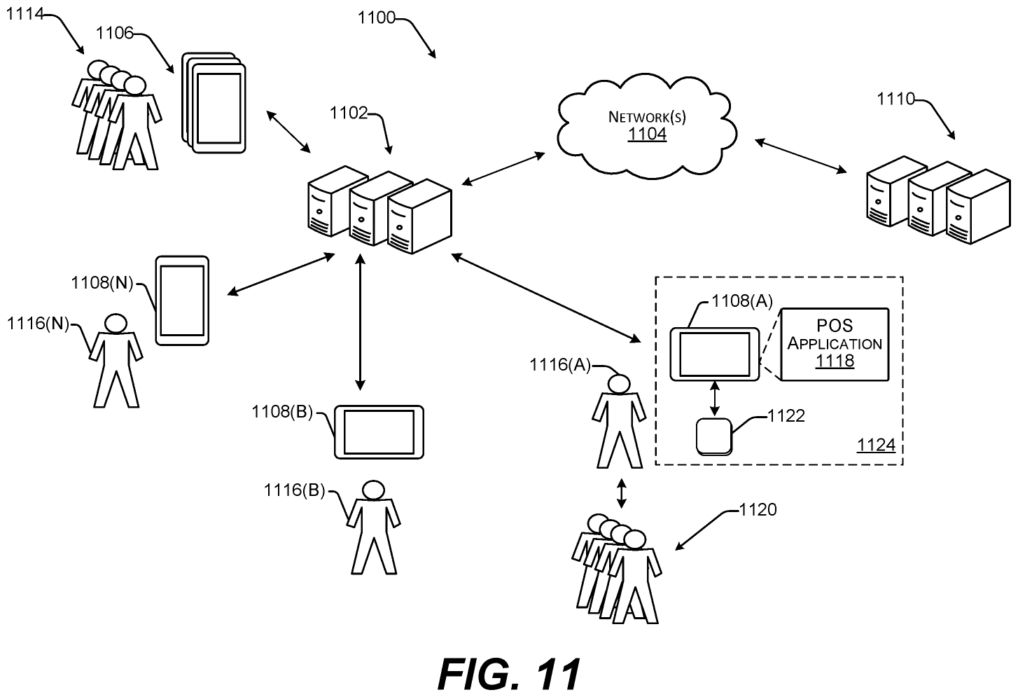

FIG. 11 illustrates an example environment 1100. The environment 1100 includes server(s) 1102 that can communicate over a network 1104 with user devices 1106 (which, in some examples can be merchant devices 1108 (individually, 1108(A)-1108(N))) and/or server(s) 1110 associated with third-party service provider(s). The server(s) 1102 can be associated with a service provider that can provide one or more services for the benefit of users 1114, as described below. Actions attributed to the service provider can be performed by the server(s) 1102.

In some examples, the user devices 1106 of FIG. 11 represent the user electronic devices 104 of FIGS. 1A-1C. In some examples, the merchant devices 1108 of FIG. 11 represent the user electronic devices 104 of FIGS. 1A-1C. In some examples, the server(s) 1102 of FIG. 11 represent the processing device(s) 110 (e.g., servers) of the payment service computing platform 108 of FIGS. 1A-1C. In some examples, the network(s) 1104 of FIG. 11 represent the network(s) 106 of FIGS. 1A-1C. In some examples, the server(s) 1110 of FIG. 11 represent the server(s) 121 of the third-party computing platform 119 depicted in FIG. 1A. Accordingly, in at least one example, the environment 1100 of FIG. 11 may represent the environment 100A of FIG. 1A to enable verified transactions through integrations of social network and payment service computing platforms. In this example, the user devices 1106 and/or the merchant devices 1108 can utilize respective payment applications 114, as described herein, the payment applications 114 allowing users 1114 and/or merchants 1116 and/or customers 1120 to navigate to the various user interfaces described herein to make electronic payments with other users. In an example, the described platform integrations facilitate generation of unalterable trust signals for improving the accuracy and security of payment transactions between users of the payment service computing platform. In at least one other example, the environment 1100 of FIG. 11 may represent the environment 100B of FIG. 1B to enable verified transactions through integrations of social network and payment service computing platforms. In this example, the user devices 1106 and/or the merchant devices 1108 can utilize respective payment applications 114, as described herein, the payment applications 114 allowing users 1114 and/or merchants 1116 and/or customers 1120 to purchase, or otherwise acquire, assets, to engage in social investing (e.g., mirroring asset allocations of other users). In an example, the described platform integrations facilitate the creation, customization, or sharing of asset profiles, which can enable users to quickly and effortlessly purchase assets based on other users' asset profiles. In at least one other example, the environment 1100 of FIG. 11 may represent the environment 100C of FIG. 1C to enable verified transactions through integrations of social network and payment service computing platforms. In this example, the user devices 1106 and/or the merchant devices 1108 can utilize respective payment applications 114 and/or third-party service applications 134, as described herein, the payment applications 114 and/or third-party service application 134 allowing users 1114 and/or merchants 1116 and/or customers 1120 to gift tokens 122 that are redeemable for assets. In an example, the described platform integrations enable transfers of ownership interests in assets using redeemable tokens that can be shared between users of the social network or payment service computing platforms.

The environment 1100 can include a plurality of user devices 1106, as described above. Each one of the plurality of user devices 1106 can be any type of computing device such as a tablet computing device, a smart phone or mobile communication device, a laptop, a netbook or other portable computer or semi-portable computer, a desktop computing device, a terminal computing device or other semi-stationary or stationary computing device, a dedicated device, a wearable computing device or other body-mounted computing device, an augmented reality device, a virtual reality device, an Internet of Things (IoT) device, etc. In some examples, individual ones of the user devices can be operable by users 1114. The users 1114 can be referred to as customers, buyers, merchants, sellers, borrowers, employees, employers, payors, payees, couriers and so on. The users 1114 can interact with the user devices 1106 via user interfaces presented via the user devices 1106. In at least one example, a user interface can be presented via a web browser, or the like. In other examples, a user interface can be presented via an application, such as a mobile application or desktop application, which can be provided by the service provider or which can be an otherwise dedicated application. In some examples, individual of the user devices 1106 can have an instance or versioned instance of an application, which can be downloaded from an application store, for example, which can present the user interface(s) described herein. In at least one example, a user 1114 can interact with the user interface via touch input, spoken input, or any other type of input.

As described above, in at least one example, the users 1114 can include merchants 1116 (individually, 1116(A)-1116(N)). In an example, the merchants 1116 can operate respective merchant devices 1108, which can be user devices 1106 configured for use by merchants 1116. For the purpose of this discussion, a “merchant” can be any entity that offers items (e.g., goods or services) for purchase or other means of acquisition (e.g., rent, borrow, barter, etc.). The merchants 1116 can offer items for purchase or other means of acquisition via brick-and-mortar stores, mobile stores (e.g., pop-up shops, food trucks, etc.), online stores, combinations of the foregoing, and so forth. In some examples, at least some of the merchants 1116 can be associated with a same entity but can have different merchant locations and/or can have franchise/franchisee relationships. In additional or alternative examples, the merchants 1116 can be different merchants. That is, in at least one example, the merchant 1116(A) is a different merchant than the merchant 1116(B) and/or the merchant 1116(C).

For the purpose of this discussion, “different merchants” can refer to two or more unrelated merchants. “Different merchants” therefore can refer to two or more merchants that are different legal entities (e.g., natural persons and/or corporate persons) that do not share accounting, employees, branding, etc. “Different merchants,” as used herein, have different names, employer identification numbers (EIN)s, lines of business (in some examples), inventories (or at least portions thereof), and/or the like. Thus, the use of the term “different merchants” does not refer to a merchant with various merchant locations or franchise/franchisee relationships. Such merchants—with various merchant locations or franchise/franchisee relationships—can be referred to as merchants having different merchant locations and/or different commerce channels.

Each merchant device 1108 can have an instance of a POS application 1118 stored thereon. The POS application 1118 can configure the merchant device 1108 as a POS terminal, which enables the merchant 1116(A) to interact with one or more customers 1120. As described above, the users 1114 can include customers, such as the customers 1120 shown as interacting with the merchant 1116(A). For the purpose of this discussion, a “customer” can be any entity that acquires items from merchants. While only two customers 1120 are illustrated in FIG. 11, any number of customers 1120 can interact with the merchants 1116. Further, while FIG. 11 illustrates the customers 1120 interacting with the merchant 1116(A), the customers 1120 can interact with any of the merchants 1116.

In at least one example, interactions between the customers 1120 and the merchants 1116 that involve the exchange of funds (from the customers 1120) for items (from the merchants 1116) can be referred to as “transactions.” In at least one example, the POS application 1118 can determine transaction data associated with the POS transactions. Transaction data can include payment information, which can be obtained from a reader device 1122 associated with the merchant device 1108(A), user authentication data, purchase amount information, point-of-purchase information (e.g., item(s) purchased, date of purchase, time of purchase, etc.), etc. The POS application 1118 can send transaction data to the server(s) 1102 such that the server(s) 1102 can track transactions of the customers 1120, merchants 1116, and/or any of the users 1114 over time. Furthermore, the POS application 1118 can present a UI to enable the merchant 1116(A) to interact with the POS application 1118 and/or the service provider via the POS application 1118.

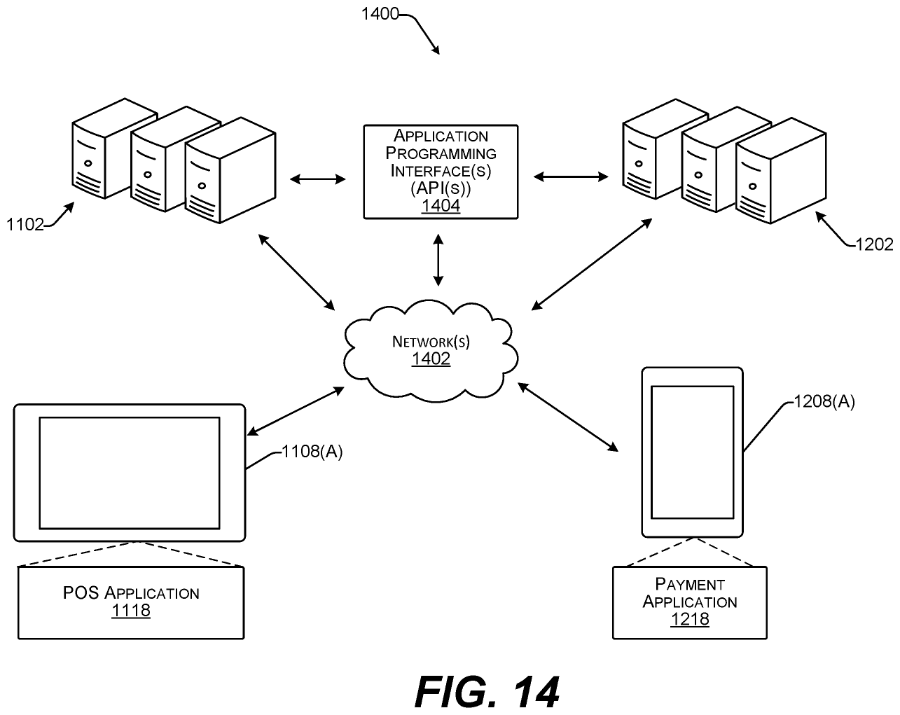

In at least one example, the merchant device 1108(A) can be a special-purpose computing device configured as a POS terminal (via the execution of the POS application 1118). In at least one example, the POS terminal may be connected to a reader device 1122, which is capable of accepting a variety of payment instruments, such as credit cards, debit cards, gift cards, short-range communication based payment instruments, and the like, as described below. In at least one example, the reader device 1122 can plug in to a port in the merchant device 1108(A), such as a microphone port, a headphone port, an audio-jack, a data port, or other suitable port. In additional or alternative examples, the reader device 1122 can be coupled to the merchant device 1108(A) via another wired or wireless connection, such as via a Bluetooth®, BLE, and so on. Additional details are described below with reference to FIG. 14. In some examples, the reader device 1122 can read information from alternative payment instruments including, but not limited to, wristbands and the like.

In some examples, the reader device 1122 may physically interact with payment instruments such as magnetic stripe payment cards, EMV payment cards, and/or short-range communication (e.g., near field communication (NFC), radio frequency identification (RFID), Bluetooth®, Bluetooth® low energy (BLE), etc.) payment instruments (e.g., cards or devices configured for tapping). The POS terminal may provide a rich user interface, communicate with the reader device 1122, and communicate with the server(s) 1102, which can provide, among other services, a payment processing service. The server(s) 1102 associated with the service provider can communicate with server(s) 1110, as described below. In this manner, the POS terminal and reader device 1122 may collectively process transaction(s) between the merchants 1116 and customers 1120. In some examples, POS terminals and reader devices can be configured in one-to-one pairings. In other examples, the POS terminals and reader devices can be configured in many-to-one pairings (e.g., one POS terminal coupled to multiple reader devices or multiple POS terminals coupled to one reader device). In some examples, there could be multiple POS terminal(s) connected to a number of other devices, such as “secondary” terminals, e.g., back-of-the-house systems, printers, line-buster devices, POS readers, and the like, to allow for information from the secondary terminal to be shared between the primary POS terminal(s) and secondary terminal(s), for example via short-range communication technology. This kind of arrangement may also work in an offline-online scenario to allow one device (e.g., secondary terminal) to continue taking user input, and synchronize data with another device (e.g., primary terminal) when the primary or secondary terminal switches to online mode. In other examples, such data synchronization may happen periodically or at randomly selected time intervals.

While the POS terminal and the reader device 1122 of the POS system 1124 are shown as separate devices, in additional or alternative examples, the POS terminal and the reader device 1122 can be part of a single device. In some examples, the reader device 1122 can have a display integrated therein for presenting information to the customers 1120. In additional or alternative examples, the POS terminal can have a display integrated therein for presenting information to the customers 1120. POS systems, such as the POS system 1124, may be mobile, such that POS terminals and reader devices may process transactions in disparate locations across the world. POS systems can be used for processing card-present transactions and card-not-present (CNP) transactions, as described below.

A card-present transaction is a transaction where both a customer 1120 and his or her payment instrument are physically present at the time of the transaction. Card-present transactions may be processed by swipes, dips, taps, or any other interaction between a physical payment instrument (e.g., a card), or otherwise present payment instrument, and a reader device 1122 whereby the reader device 1122 is able to obtain payment data from the payment instrument. A swipe is a card-present transaction where a customer 1120 slides a card, or other payment instrument, having a magnetic strip through a reader device 1122 that captures payment data contained in the magnetic strip. A dip is a card-present transaction where a customer 1120 inserts a payment instrument having an embedded microchip (i.e., chip) into a reader device 1122 first. The dipped payment instrument remains in the payment reader until the reader device 1122 prompts the customer 1120 to remove the card, or other payment instrument. While the payment instrument is in the reader device 1122, the microchip can create a one-time code which is sent from the POS system 1124 to the server(s) 1110 (which can be associated with third-party service providers that provide payment services, including but not limited to, an acquirer bank, an issuer, and/or a card payment network (e.g., Mastercard®, VISA®, etc.)) to be matched with an identical one-time code. A tap is a card-present transaction where a customer 1120 may tap or hover his or her payment instrument (e.g., card, electronic device such as a smart phone running a payment application, etc.) over a reader device 1122 to complete a transaction via short-range communication (e.g., NFC, RFID, Bluetooth®, BLE, etc.). Short-range communication enables the payment instrument to exchange information with the reader device 1122. A tap may also be called a contactless payment.

A CNP transaction is a transaction where a card, or other payment instrument, is not physically present at the POS such that payment data is required to be manually keyed in (e.g., by a merchant, customer, etc.), or payment data is required to be recalled from a card-on-file data store, to complete the transaction.

The POS system 1124, the server(s) 1102, and/or the server(s) 1110 may exchange payment information and transaction data to determine whether transactions are authorized. For example, the POS system 1124 may provide encrypted payment data, user authentication data, purchase amount information, point-of-purchase information, etc. (collectively, transaction data) to server(s) 1102 over the network(s) 1104. The server(s) 1102 may send the transaction data to the server(s) 1110. As described above, in at least one example, the server(s) 1110 can be associated with third-party service providers that provide payment services, including but not limited to, an acquirer bank, an issuer, and/or a card payment network (e.g., Mastercard®, VISA®, etc.)

For the purpose of this discussion, the “payment service providers” can be acquiring banks (“acquirer”), issuing banks (“issuer”), card payment networks, and the like. In an example, an acquirer is a bank or financial institution that processes payments (e.g., credit or debit card payments) and can assume risk on behalf of merchants(s). An acquirer can be a registered member of a card association (e.g., Visa®, MasterCard®), and can be part of a card payment network. The acquirer (e.g., the server(s) 1110 associated therewith) can send a fund transfer request to a server computing device of a card payment network (e.g., Mastercard®, VISA®, etc.) to determine whether the transaction is authorized or deficient. In at least one example, the service provider can serve as an acquirer and connect directly with the card payment network.

The card payment network (e.g., the server(s) 1110 associated therewith) can forward the fund transfer request to an issuing bank (e.g., “issuer”). The issuer is a bank or financial institution that offers a financial account (e.g., credit or debit card account) to a user. An issuer can issue payment cards to users and can pay acquirers for purchases made by cardholders to which the issuing bank has issued a payment card. The issuer (e.g., the server(s) 1110 associated therewith) can make a determination as to whether the customer has the capacity to absorb the relevant charge associated with the payment transaction. In at least one example, the service provider can serve as an issuer and/or can partner with an issuer. The transaction is either approved or rejected by the issuer and/or the card payment network (e.g., the server(s) 1110 associated therewith), and a payment authorization message is communicated from the issuer to the POS device via a path opposite of that described above, or via an alternate path.

As described above, the server(s) 1110, which can be associated with payment service provider(s), may determine whether the transaction is authorized based on the transaction data, as well as information relating to parties to the transaction (e.g., the customer 1120 and/or the merchant 1116(A)). The server(s) 1110 may send an authorization notification over the network(s) 1104 to the server(s) 1102, which may send the authorization notification to the POS system 1124 over the network(s) 1104 to indicate whether the transaction is authorized. The server(s) 1102 may also transmit additional information such as transaction identifiers to the POS system 1124. In one example, the server(s) 1102 may include a merchant application and/or other functional components for communicating with the POS system 1124 and/or the server(s) 1110 to authorize or decline transactions.

Based on the authentication notification that is received by the POS system 1124 from server(s) 1102, the merchant 1116(A) may indicate to the customer 1120 whether the transaction has been approved. In some examples, approval may be indicated at the POS system 1124, for example, at a display of the POS system 1124. In other examples, such as with a smart phone or watch operating as a short-range communication payment instrument, information about the approved transaction may be provided to the short-range communication payment instrument for presentation via a display of the smart phone or watch. In some examples, additional or alternative information can additionally be presented with the approved transaction notification including, but not limited to, receipts, special offers, coupons, or loyalty program information.

As mentioned above, the service provider can provide, among other services, payment processing services, inventory management services, catalog management services, business banking services, financing services, lending services, reservation management services, web-development services, payroll services, employee management services, appointment services, loyalty tracking services, restaurant management services, order management services, fulfillment services, onboarding services, identity verification (IDV) services, and so on. In some examples, the users 1114 can access all of the services of the service provider. In other examples, the users 1114 can have gradated access to the services, which can be based on risk tolerance, IDV outputs, subscriptions, and so on. In at least one example, access to such services can be availed to the merchants 1116 via the POS application 1118. In additional or alternative examples, each service can be associated with its own access point (e.g., application, web browser, etc.).

The service provider can offer payment processing services for processing payments on behalf of the merchants 1116, as described above. For example, the service provider can provision payment processing software, payment processing hardware and/or payment processing services to merchants 1116, as described above, to enable the merchants 1116 to receive payments from the customers 1120 when conducting POS transactions with the customers 1120. For instance, the service provider can enable the merchants 1116 to receive cash payments, payment card payments, and/or electronic payments from customers 1120 for POS transactions and the service provider can process transactions on behalf of the merchants 1116.

As the service provider processes transactions on behalf of the merchants 1116, the service provider can maintain accounts or balances for the merchants 1116 in one or more ledgers. For example, the service provider can analyze transaction data received for a transaction to determine an amount of funds owed to a merchant 1116(A) for the transaction. In at least one example, such an amount can be a total purchase price less fees charged by the service provider for providing the payment processing services. Based on determining the amount of funds owed to the merchant 1116(A), the service provider can deposit funds into an account of the merchant 1116(A). The account can have a stored balance, which can be managed by the service provider. The account can be different from a conventional bank account at least because the stored balance is managed by a ledger of the service provider and the associated funds are accessible via various withdrawal channels including, but not limited to, scheduled deposit, same-day deposit, instant deposit, and a linked payment instrument.

A scheduled deposit can occur when the service provider transfers funds associated with a stored balance of the merchant 1116(A) to a bank account of the merchant 1116(A) that is held at a bank or other financial institution (e.g., associated with the server(s) 1110). Scheduled deposits can occur at a prearranged time after a POS transaction is funded, which can be a business day after the POS transaction occurred, or sooner or later. In some examples, the merchant 1116(A) can access funds prior to a scheduled deposit. For instance, the merchant 1116(A) may have access to same-day deposits (e.g., wherein the service provider deposits funds from the stored balance to a linked bank account of the merchant on a same day as POS transaction, in some examples prior to the POS transaction being funded) or instant deposits (e.g., wherein the service provider deposits funds from the stored balance to a linked bank account of the merchant on demand, such as responsive to a request). Further, in at least one example, the merchant 1116(A) can have a payment instrument that is linked to the stored balance that enables the merchant to access the funds without first transferring the funds from the account managed by the service provider to the bank account of the merchant 1116(A).

In at least one example, the service provider may provide inventory management services. That is, the service provider may provide inventory tracking and reporting. Inventory management services may enable the merchant 1116(A) to access and manage a database storing data associated with a quantity of each item that the merchant 1116(A) has available (i.e., an inventory). Furthermore, in at least one example, the service provider can provide catalog management services to enable the merchant 1116(A) to maintain a catalog, which can be a database storing data associated with items that the merchant 1116(A) has available for acquisition (i.e., catalog management services). In at least one example, the catalog may include a plurality of data items and a data item of the plurality of data items may represent an item that the merchant 11121(A) has available for acquisition. The service provider can offer recommendations related to pricing of the items, placement of items on the catalog, and multi-party fulfilment of the inventory.

In at least one example, the service provider can provide business banking services, which allow the merchant 1116(A) to track deposits (from payment processing and/or other sources of funds) into an account of the merchant 1116(A), payroll payments from the account (e.g., payments to employees of the merchant 1116(A)), payments to other merchants (e.g., business-to-business) directly from the account or from a linked debit card, withdrawals made via scheduled deposit and/or instant deposit, etc. Furthermore, the business banking services can enable the merchant 1116(A) to obtain a customized payment instrument (e.g., credit card), check how much money they are earning (e.g., via presentation of available earned balance), understand where their money is going (e.g., via deposit reports (which can include a breakdown of fees), spend reports, etc.), access/use earned money (e.g., via scheduled deposit, instant deposit, linked payment instrument, etc.), feel in control of their money (e.g., via management of deposit schedule, deposit speed, linked instruments, etc.), etc. Moreover, the business banking services can enable the merchants 1116 to visualize their cash flow to track their financial health, set aside money for upcoming obligations (e.g., savings), organize money around goals, etc.

In at least one example, the service provider can provide financing services and products, such as via business loans, consumer loans, fixed term loans, flexible term loans, and the like. In at least one example, the service provider can utilize one or more risk signals to determine whether to extend financing offers and/or terms associated with such financing offers.

In at least one example, the service provider can provide financing services for offering and/or lending a loan to a borrower that is to be used for, in some instances, financing the borrower's short-term operational needs (e.g., a capital loan). For instance, a potential borrower that is a merchant can obtain a capital loan via a capital loan product in order to finance various operational costs (e.g., rent, payroll, inventory, etc.). In at least one example, the service provider can offer different types of capital loan products. For instance, in at least one example, the service provider can offer a daily repayment loan product, wherein a capital loan is repaid daily, for instance, from a portion of transactions processed by the payment processing service on behalf of the borrower. Additionally and/or alternatively, the service provider can offer a monthly repayment loan product, wherein a capital loan is repaid monthly, for instance, via a debit from a bank account linked to the payment processing service. The credit risk of the merchant may be evaluated using risk models that take into account factors, such as payment volume, credit risk of similarly situated merchants, past transaction history, seasonality, credit history, and so on.

Additionally or alternatively, the service provider can provide financing services for offering and/or lending a loan to a borrower that is to be used for, in some instances, financing the borrower's consumer purchase (e.g., a consumer loan). In at least one example, a borrower can submit a request for a loan to enable the borrower to purchase an item from a merchant, which can be one of the merchants 1116. The service provider can generate the loan based at least in part on determining that the borrower purchased or intends to purchase the item from the merchant. The loan can be associated with a balance based on an actual purchase price of the item and the borrower can repay the loan over time. In some examples, the borrower can repay the loan via installments, which can be paid via funds managed and/or maintained by the service provider (e.g., from payments owed to the merchant from payments processed on behalf of the merchant, funds transferred to the merchant, etc.). The service provider can offer specific financial products, such as payment instruments, tied specifically to the loan products. For example, in one implementation, the server provider 1112 associates capital to a merchant or customer's debit card, where the use of the debit card is defined by the terms of the loan. In some examples, the merchant may only use the debit card for making specific purchases. In other examples, the “installment” associated with the loan product is credited directly via the payment instrument. The payment instrument is thus customized to the loan and/or the parties associated with the loan.

The service provider can provide web-development services, which enable users 1114 who are unfamiliar with HTML, XML, Javascript, CSS, or other web design tools to create and maintain professional and aesthetically pleasing websites. Some of these web page editing applications allow users to build a web page and/or modify a web page (e.g., change, add, or remove content associated with a web page). Further, in addition to websites, the web-development services can create and maintain other online omni-channel presences, such as social media posts for example. In some examples, the resulting web page(s) and/or other content items can be used for offering item(s) for sale via an online/e-commerce platform. That is, the resulting web page(s) and/or other content items can be associated with an online store or offering by the one or more of the merchants 1116. In at least one example, the service provider can recommend and/or generate content items to supplement omni-channel presences of the merchants 1116. That is, if a merchant of the merchants 1116 has a web page, the service provider—via the web-development or other services—can recommend and/or generate additional content items to be presented via other channel(s), such as social media, email, etc.

Furthermore, the service provider can provide payroll services to enable employers to pay employees for work performed on behalf of employers. In at least one example, the service provider can receive data that includes time worked by an employee (e.g., through imported timecards and/or POS interactions), sales made by the employee, gratuities received by the employee, and so forth. Based on such data, the service provider can make payroll payments to employee(s) on behalf of an employer via the payroll service. For instance, the service provider can facilitate the transfer of a total amount to be paid out for the payroll of an employee from the bank of the employer to the bank of the service provider to be used to make payroll payments. In at least one example, when the funds have been received at the bank of the service provider, the service provider can pay the employee, such as by check or direct deposit, often a day, a week, or more after when the work was actually performed by the employee. In additional or alternative examples, the service provider can enable employee(s) to receive payments via same-day or instant deposit based at least in part on risk and/or reliability analyses performed by the service provider.

Moreover, in at least one example, the service provider can provide employee management services for managing schedules of employees. Further, the service provider can provide appointment services for enabling users 1114 to set schedules for scheduling appointments and/or users 1114 to schedule appointments.

In some examples, the service provider can provide restaurant management services to enable users 1114 to make and/or manage reservations, to monitor front-of-house and/or back-of-house operations, and so on. In such examples, the merchant device(s) 1108 and/or server(s) 1102 can be configured to communicate with one or more other computing devices, which can be located in the front-of-house (e.g., POS device(s)) and/or back-of-house (e.g., kitchen display system(s) (KDS)). In at least one example, the service provider can provide order management services and/or fulfillment services to enable restaurants to manage open tickets, split tickets, and so on and/or manage fulfillment services. In some examples, such services can be associated with restaurant merchants, as described above. In additional or alternative examples, such services can be any type of merchant.

In at least one example, the service provider can provide fulfilment services, which can use couriers for delivery, wherein couriers can travel between multiple locations to provide delivery services, photography services, etc. Couriers can be users 1114 who can travel between locations to perform services for a requesting user 1114 (e.g., deliver items, capture images, etc.). In some examples, the courier can receive compensation from the service provider. The courier can employ one or more vehicles, such as automobiles, bicycles, scooters, motorcycles, buses, airplanes, helicopters, boats, skateboards, etc. Although, in other instances the courier can travel by foot or otherwise without a vehicle. Some examples discussed herein enable people to participate as couriers in a type of crowdsourced service economy. Here, essentially any person with a mobile device is able to immediately become a courier, or cease to be a courier, in a courier network that provides services as described herein. In at least one example, the couriers can be unmanned aerial vehicles (e.g., drones), autonomous vehicles, or any other type of vehicle capable of receiving instructions for traveling between locations. In some examples, the service provider can receive requests for courier services, automatically assign the requests to active couriers, and communicate dispatch instructions to couriers via user interface (e.g., application, web browser, or other access point) presented via respective devices 1106.

In some examples, the service provider can provide omni-channel fulfillment services. For instance, if a customer places an order with a merchant and the merchant cannot fulfill the order because one or more items are out of stock or otherwise unavailable, the service provider can leverage other merchants and/or sales channels that are part of the platform of the service provider to fulfill the customer's order. That is, another merchant can provide the one or more items to fulfill the order of the customer. Furthermore, in some examples, another sales channel (e.g., online, brick-and-mortar, etc.) can be used to fulfill the order of the customer.

In some examples, the service provider can enable conversational commerce via conversational commerce services, which can use one or more machine learning mechanisms to analyze messages exchanged between two or more users 1114, voice inputs into a virtual assistant or the like, to determine intents of user(s) 1114. In some examples, the service provider can utilize determined intents to automate customer service, offer promotions, provide recommendations, or otherwise interact with customers in real-time. In at least one example, the service provider can integrate products and services, and payment mechanisms into a communication platform (e.g., messaging, etc.) to enable customers to make purchases, or otherwise transact, without having to call, email, or visit a web page or other channel of a merchant. That is, conversational commerce alleviates the need for customers to toggle back and forth between conversations and web pages to gather information and make purchases.

In at least one example, a user 1114 may be new to the service provider such that the user 1114 that has not registered (e.g., subscribed to receive access to one or more services offered by the service provider) with the service provider. The service provider can offer onboarding services for registering a potential user 1114 with the service provider. In some examples, onboarding can involve presenting various questions, prompts, and the like to a potential user 1114 to obtain information that can be used to generate a profile for the potential user 1114. In at least one example, the service provider can provide limited or short-term access to its services prior to, or during, onboarding (e.g., a user of a peer-to-peer payment service can transfer and/or receive funds prior to being fully onboarded, a merchant can process payments prior to being fully onboarded, etc.). In at least one example, responsive to the potential user 1114 providing all necessary information, the potential user 1114 can be onboarded to the service provider. In such an example, any limited or short-term access to services of the service provider can be transitioned to more permissive (e.g., less limited) or longer-term access to such services.

The service provider can be associated with IDV services, which can be used by the service provider for compliance purposes and/or can be offered as a service, for instance to third-party service providers (e.g., associated with the server(s) 1110). That is, the service provider can offer IDV services to verify the identity of users 1114 seeking to use or using their services. Identity verification requires a customer (or potential customer) to provide information that is used by compliance departments to prove that the information is associated with an identity of a real person or entity. In at least one example, the service provider can perform services for determining whether identifying information provided by a user 1114 accurately identifies the customer (or potential customer) (i.e., Is the customer who they say they are?).

The service provider is capable of providing additional or alternative services and the services described above are offered as a sampling of services. In at least one example, the service provider can exchange data with the server(s) 1110 associated with third-party service providers. Such third-party service providers can provide information that enables the service provider to provide services, such as those described above. In additional or alternative examples, such third-party service providers can access services of the service provider. That is, in some examples, the third-party service providers can be subscribers, or otherwise access, services of the service provider.

Techniques described herein can be configured to operate in both real-time/online and offline modes. “Online” modes refer to modes when devices are capable of communicating with the service provider (e.g., the server(s) 1102) and/or the server(s) 1110 via the network(s) 1104. In some examples, the merchant device(s) 1108 are not capable of connecting with the service provider (e.g., the server(s) 1102) and/or the server(s) 1110, due to a network connectivity issue, for example. In additional or alternative examples, the server(s) 1102 are not capable of communicating with the server(s) 1110 due to network connectivity issue, for example. In such examples, devices may operate in “offline” mode where at least some payment data is stored (e.g., on the merchant device(s) 1108) and/or the server(s) 1102 until connectivity is restored and the payment data can be transmitted to the server(s) 1102 and/or the server(s) 1110 for processing.

In at least one example, the service provider can be associated with a hub, such as an order hub, an inventory hub, a fulfillment hub and so on, which can enable integration with one or more additional service providers (e.g., associated with the additional server(s) 1110). In some examples, such additional service providers can offer additional or alternative services and the service provider can provide an interface or other computer-readable instructions to integrate functionality of the service provider into the one or more additional service providers.

Techniques described herein are directed to services provided via a distributed system of user devices 1106 that are in communication with one or more server computing devices 1102 of the service provider. That is, techniques described herein are directed to a specific implementation—or, a practical application—of utilizing a distributed system of user devices 1106 that are in communication with one or more server computing devices 1102 of the service provider to perform a variety of services, as described above. The unconventional configuration of the distributed system described herein enables the server(s) 1102 that are remotely-located from end-users (e.g., users 1114) to intelligently offer services based on aggregated data associated with the end-users, such as the users 1114 (e.g., data associated with multiple, different merchants and/or multiple, different buyers), in some examples, in near-real time. Accordingly, techniques described herein are directed to a particular arrangement of elements that offer technical improvements over conventional techniques for performing payment processing services and the like. For small business owners in particular, the business environment is typically fragmented and relies on unrelated tools and programs, making it difficult for an owner to manually consolidate and view such data. The techniques described herein constantly or periodically monitor disparate and distinct merchant accounts, e.g., accounts within the control of the service provider, and those outside of the control of the service provider, to track the business standing (payables, receivables, payroll, invoices, appointments, capital, etc.) of the merchants. The techniques herein provide a consolidated view of a merchant's cash flow, predict needs, preemptively offer recommendations or services, such as capital, coupons, etc., and/or enable money movement between disparate accounts (merchant's, another merchant's, or even payment service's) in a frictionless and transparent manner.

As described herein, artificial intelligence, machine learning, and the like can be used to dynamically make determinations, recommendations, and the like, thereby adding intelligence and context-awareness to an otherwise one-size-fits-all scheme for providing payment processing services and/or additional or alternative services described herein. In some implementations, the distributed system is capable of applying the intelligence derived from an existing user base to a new user, thereby making the onboarding experience for the new user personalized and frictionless when compared to traditional onboarding methods. Thus, techniques described herein improve existing technological processes.

As described above, various graphical user interfaces (GUIs) can be presented to facilitate techniques described herein. Some of the techniques described herein are directed to user interface features presented via GUIs to improve interaction between users 1114 and user devices 1106. Furthermore, such features are changed dynamically based on the profiles of the users involved interacting with the GUIs. As such, techniques described herein are directed to improvements to computing systems.

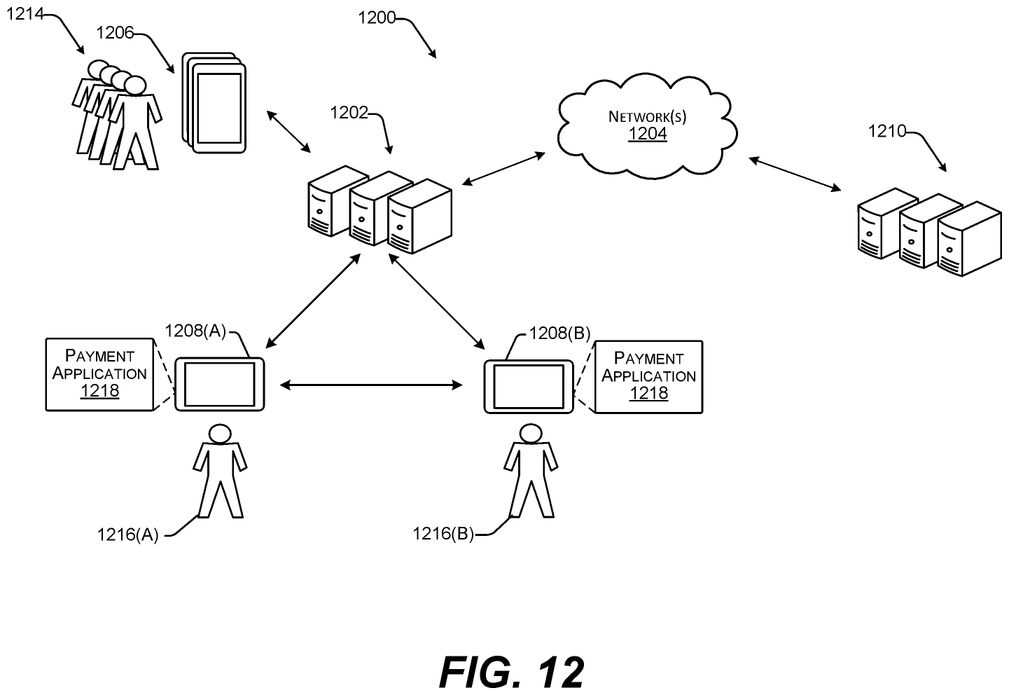

FIG. 12 illustrates an example environment 1200. The environment 1200 includes server(s) 1202 that can communicate over a network 1204 with user devices 1206 (which, in some examples can be user devices 1208 (individually, 1208(A), 1208(B)) and/or server(s) 1210 associated with third-party service provider(s). The server(s) 1202 can be associated with a service provider that can provide one or more services for the benefit of users 1214, as described below. Actions attributed to the service provider can be performed by the server(s) 1202. In some examples, the service provider referenced in FIG. 11 can be the same or different than the service provider referenced in FIG. 12.

In some examples, the user devices 1206, 1208 of FIG. 12 represent the user electronic devices 104 of FIGS. 1A-1C. In some examples, the server(s) 1202 of FIG. 12 represent the processing device(s) 110 (e.g., servers) of the payment service computing platform 108 of FIGS. 1A-1C. In some examples, the network(s) 1204 of FIG. 12 represent the network(s) 106 of FIGS. 1A-1C. In some examples, the server(s) 1210 of FIG. 12 represent the server(s) 121 of the third-party computing platform 119 depicted in FIG. 1A. Accordingly, in at least one example, the environment 1200 of FIG. 12 may represent the environment 100A of FIG. 1A to enable verified transactions through integrations of social network and payment service computing platforms. In this example, the user devices 1206, 1208 can utilize respective payment applications 1218 (which may represent the payment applications 114 of FIGS. 1A-1C), as described herein, the payment applications 1218 allowing users 1214, 1216 to navigate to the various user interfaces described herein to make electronic payments with other users. In an example, the described platform integrations facilitate generation of unalterable trust signals for improving the accuracy and security of payment transactions between users of the payment service computing platform. In at least one other example, the environment 1200 of FIG. 12 may represent the environment 100B of FIG. 1B to enable verified transactions through integrations of social network and payment service computing platforms. In this example, the user devices 1206, 1208 can utilize respective payment applications 1218, as described herein, the payment applications 1218 allowing users 1214, 1216 to purchase, or otherwise acquire, assets, to engage in social investing (e.g., mirroring asset allocations of other users). In an example, the described platform integrations facilitate the creation, customization, or sharing of asset profiles, which can enable users to quickly and effortlessly purchase assets based on other users' asset profiles. In at least one other example, the environment 1200 of FIG. 12 may represent the environment 100C of FIG. 1C to enable verified transactions through integrations of social network and payment service computing platforms. In this example, the user devices 1206, 1208 can utilize respective payment applications 1218 and/or third-party service applications 134, as described herein, the payment applications 1218 and/or third-party service application 134 allowing users 1214, 1216 to gift tokens 122 that are redeemable for assets. In an example, the described platform integrations enable transfers of ownership interests in assets using redeemable tokens that can be shared between users of the social network or payment service computing platforms.

The environment 1200 can include a plurality of user devices 1206, as described above. Each one of the plurality of user devices 1206 can be any type of computing device such as a tablet computing device, a smart phone or mobile communication device, a laptop, a netbook or other portable computer or semi-portable computer, a desktop computing device, a terminal computing device or other semi-stationary or stationary computing device, a dedicated device, a wearable computing device or other body-mounted computing device, an augmented reality device, a virtual reality device, an Internet of Things (IoT) device, etc. In some examples, individual ones of the user devices can be operable by users 1214. The users 1214 can be referred to as customers, buyers, merchants, sellers, borrowers, employees, employers, payors, payees, couriers and so on. The users 1214 can interact with the user devices 1206 via user interfaces presented via the user devices 1206. In at least one example, a user interface can be presented via a web browser, or the like. In other examples, a user interface can be presented via an application, such as a mobile application or desktop application, which can be provided by the service provider or which can be an otherwise dedicated application. In some examples, individual of the user devices 1206 can have an instance or versioned instance of an application, which can be downloaded from an application store, for example, which can present the user interface(s) described herein. In at least one example, a user 1214 can interact with the user interface via touch input, spoken input, or any other type of input.

In at least one example, the service provider can provide a peer-to-peer payment service that enables peer-to-peer payments between two or more users 1214. Two users, user 1216(A) and user 1216(B) are illustrated in FIG. 12 as “peers” in a peer-to-peer payment. In at least one example, the service provider can communicate with instances of a payment application 1218 (or other access point) installed on devices 1206 configured for operation by users 1214. In an example, an instance of the payment application 1218 executing on a first device 1208(A) operated by a payor (e.g., user 1216(A)) can send a request to the service provider to transfer an asset (e.g., fiat currency, non-fiat currency, cryptocurrency, securities, gift cards, and/or related assets) from the payor to a payee (e.g., user 1216(B)) via a peer-to-peer payment. In some examples, assets associated with an account of the payor are transferred to an account of the payee. In some examples, assets can be held at least temporarily in an account of the service provider prior to transferring the assets to the account of the payee.

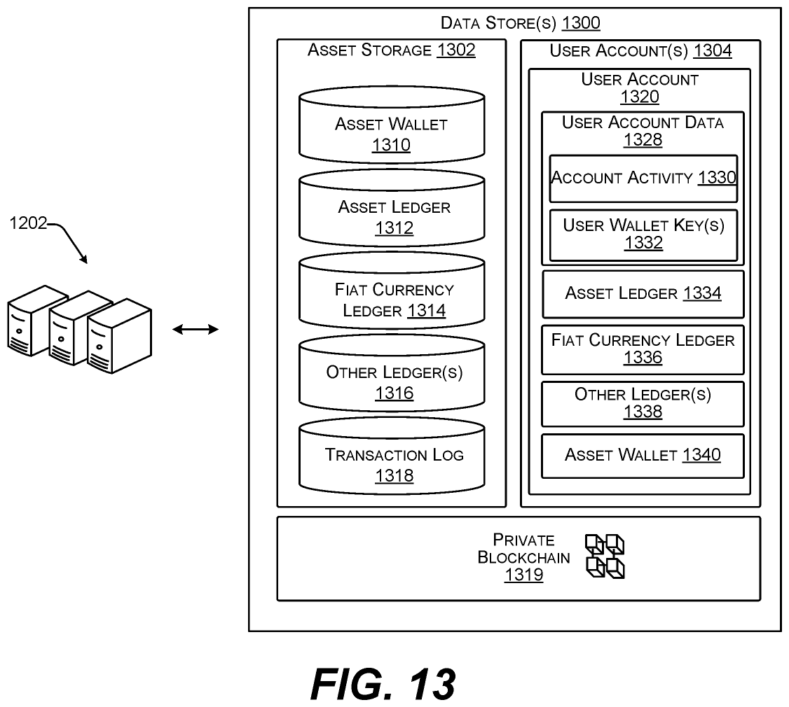

In some examples, the service provider can utilize a ledger system to track transfers of assets between users 1206. FIG. 13, below, provides additional details associated with such a ledger system. The ledger system can enable users 1206 to own fractional shares of assets that are not conventionally available. For instance, a user can own a fraction of a Bitcoin or a stock. Additional details are described herein.

In at least one example, the service provider can facilitate transfers and can send notifications related thereto to instances of the payment application 1218 executing on user device(s) of payee(s). As an example, the service provider can transfer assets from an account of user 1216(A) to an account of the user 1216(B) and can send a notification to the user device 1208(B) of the user 1216(B) for presentation via a user interface. The notification can indicate that a transfer is in process, a transfer is complete, or the like. In some examples, the service provider can send additional or alternative information to the instances of the payment application 1218 (e.g., low balance to the payor, current balance to the payor or the payee, etc.). In some examples, the payor and/or payee can be identified automatically, e.g., based on context, proximity, prior transaction history, and so on. In other examples, the payee can send a request for funds to the payor prior to the payor initiating the transfer of funds. In some embodiments, the service provider funds the request to payee on behalf of the payor, to speed up the transfer process and compensate for any lags that may be attributed to the payor's financial network.

In some examples, the service provider can trigger the peer-to-peer payment process through identification of a “payment proxy” having a particular syntax. For example, the syntax can include a monetary currency indicator prefixing one or more alphanumeric characters (e.g., $Cash). The currency indicator operates as the tagging mechanism that indicates to the server(s) 1202 to treat the inputs as a request from the payor to transfer assets, where detection of the syntax triggers a transfer of assets. The currency indicator can correspond to various currencies including but not limited to, dollar ($), euro (€), pound (£), rupee ( [symbol] ), yuan (¥), etc. Although use of the dollar currency indicator ($) is used herein, it is to be understood that any currency symbol could equally be used. In some examples, additional or alternative identifiers can be used to trigger the peer-to-peer payment process. For instance, email, telephone number, social media handles, and/or the like can be used to trigger and/or identify users of a peer-to-peer payment process.

In some examples, the peer-to-peer payment process can be initiated through instances of the payment application 1218 executing on the user devices 1206. In at least some embodiments, the peer-to-peer process can be implemented within a landing page associated with a user and/or an identifier of a user. The term “landing page,” as used here, refers to a virtual location identified by a personalized location address that is dedicated to collect payments on behalf of a recipient associated with the personalized location address. The personalized location address that identifies the landing page can include a payment proxy discussed above. The service provider can generate the landing page to enable the recipient to conveniently receive one or more payments from one or more senders. In some examples, the personalized location address identifying the landing page can be a uniform resource locator (URL) that incorporates the payment proxy. In such examples, the landing page can be a web page, e.g., www.cash.me/$Cash.

In some examples, the peer-to-peer payment process can be implemented within a forum. The term “forum,” as used here, refers to a content provider's media channel (e.g., a social networking platform, a microblog, a blog, video sharing platform, a music sharing platform, etc.) that enables user interaction and engagement through comments, posts, messages on electronic bulletin boards, messages on a social networking platform, and/or any other types of messages. In some examples, the content provider can be the service provider as described with reference to FIG. 12 or a third-party service provider associated with the server(s) 1210. In examples where the content provider is a third-party service provider, the server(s) 1210 can be accessible via one or more APIs or other integrations. The forum can be employed by a content provider to enable users of the forum to interact with one another (e.g., through creating messages, posting comments, etc.). In some examples, “forum” may also refer to an application or webpage of an e-commerce or retail organization that offers products and/or services. Such web sites can provide an online “form” to complete before or after the products or services are added to a virtual cart. The online form may include one or more fields to receive user interaction and engagement. Examples include name and other identification of the user, shipping address of the user, etc. Some of these fields may be configured to receive payment information, such as a payment proxy, in lieu of other kinds of payment mechanisms, such as credit cards, debit cards, prepaid cards, gift cards, virtual wallets, etc.

In some embodiments, the peer-to-peer process can be implemented within a communication application, such as a messaging application. The term “messaging application,” as used here, refers to any messaging application that enables communication between users (e.g., sender and recipient of a message) over a wired or wireless communications network, through use of a communication message. The messaging application can be employed by the service provider referenced in FIG. 12. For instance, the service provider can offer messaging services that provides a communication service to users via a messaging application (e.g., chat or messaging capability). The messaging application can include, for example, a text messaging application for communication between phones (e.g., conventional mobile telephones or smartphones), or a cross-platform instant messaging application for smartphones and phones that use the Internet for communication. The messaging application can be executed on a user device 1206 (e.g., mobile device or conventional personal computer (PC)) based on instructions transmitted to and from the server(s) 1202 (which, in such an example can be called a “messaging server”). In some instances, the messaging application can include a payment application with messaging capability that enables users of the payment application to communicate with one another. In such instances, the payment application can be executed on a user device 1206 based on instructions transmitted to and from the server(s) 1202 (e.g., the payment service discussed in this description or another payment service that supports payment transactions). In some examples, the messaging application can be provided by a third-party service provider associated with the server(s) 1210. In examples where the messaging application is a third-party service provider, the server(s) 1210 can be accessible via one or more APIs or other integrations.

As described above, the service provider can facilitate peer-to-peer transactions, which can enable users 1206 to transfer fiat currency, non-fiat currency, cryptocurrency, securities, or other assets, or portions thereof, to other users 1206. In at least one example, individual users can be associated with user accounts. Additional details associated with user accounts and the transfer of assets between users 1206 are described below with reference to FIG. 13.

Furthermore, the service provider of FIG. 12 can enable users 1206 to perform banking transactions via instances of the payment application 1218. For example, users can configure direct deposits or other deposits for adding assets to their various ledgers/balances. Further, users 1206 can configure bill pay, recurring payments, and/or the like using assets associated with their accounts. In addition to sending and/or receiving assets via peer-to-peer transactions, users 1206 buy and/or sell assets via asset networks such as cryptocurrency networks, securities networks, and/or the like.

FIG. 13 illustrates example data store(s) 1300 that can be associated with the server(s) 1202. The data store(s) 1300 of FIG. 13 may represent the data store(s) 112 of FIGS. 1A-1C, in some examples. Accordingly, the data store(s) 1300 may be used to enable verified transactions through integrations of social network and payment service computing platforms, as described herein. For example, the data store(s) 1300 can be used to facilitate generation of unalterable trust signals for improving the accuracy and security of payment transactions between users of the payment service computing platform, to facilitate the creation, customization, or sharing of asset profiles, which can enable users to quickly and effortlessly purchase assets based on other users' asset profiles, and/or to enable transfers of ownership interests in assets using redeemable tokens that can be shared between users of the social network or payment service computing platforms, as described herein.

In at least one example, the data store(s) 1300 can store assets in an asset storage 1302, as well as data in user account(s) 1304, merchant account(s) 1306, and/or customer account(s) 1308. In at least one example, the asset storage 1302 can be used to store assets managed by the service provider of FIG. 12. In at least one example, the asset storage 1302 can be used to record whether individual of the assets are registered to users. For example, the asset storage 1302 can include an asset wallet 1310 for storing records of assets owned by the service provider of FIG. 12, such as cryptocurrency, securities, or the like, and communicating with one or more asset networks, such as cryptocurrency networks, securities networks, or the like. In some examples, the asset network can be a first-party network or a third-party network, such as a cryptocurrency exchange or the stock market. In examples where the asset network is a third-party network, the server(s) 1210 can be associated therewith. In some examples, the asset wallet 1310 can communication with the asset network via one or more components associated with the server(s) 1202.

The asset wallet 1310 can be associated with one or more addresses and can vary addresses used to acquire assets (e.g., from the asset network(s)) so that its holdings are represented under a variety of addresses on the asset network. In examples where the service provider of FIG. 12 has its own holdings of cryptocurrency (e.g., in the asset wallet 1310), a user can acquire cryptocurrency directly from the service provider of FIG. 12. In some examples, the service provider of FIG. 12 can include logic for buying and selling cryptocurrency to maintain a desired level of cryptocurrency. In some examples, the desired level can be based on a volume of transactions over a period of time, balances of collective cryptocurrency ledgers, exchange rates, or trends in changing of exchange rates such that the cryptocurrency is trending towards gaining or losing value with respect to the fiat currency. In all of these scenarios, the buying and selling of cryptocurrency, and therefore the associated updating of the public ledger of asset network can be separate from any customer-merchant transaction or peer-to-peer transaction, and therefore not necessarily time-sensitive. This can enable batching transactions to reduce computational resources and/or costs. The service provider can provide the same or similar functionality for securities or other assets.

The asset storage 1302 may contain ledgers that store records of assignments of assets to users 1206. Specifically, the asset storage 1302 may include asset ledger 1310, fiat currency ledger 1314, and other ledger(s) 1316, which can be used to record transfers of assets between users 1206 of the service provider and/or one or more third-parties (e.g., merchant network(s), payment card network(s), ACH network(s), equities network(s), the asset network, securities networks, etc.). In doing so, the asset storage 1302 can maintain a running balance of assets managed by the service provider of FIG. 12. The ledger(s) of the asset storage 1302 can further indicate some of the running balance for each of the ledger(s) stored in the asset storage 1302 is assigned or registered to one or more user account(s) 1304.

In at least one example, the asset storage 1302 can include transaction logs 1318, which can include records of past transactions involving the service provider of FIG. 12. In at least one example, transaction data, as described herein, can be stored in association with the transaction logs 1318.

In some examples, the data store(s) 1300 can store a private blockchain 1319. A private blockchain 1319 can function to record sender addresses, recipient addresses, public keys, values of cryptocurrency transferred, and/or can be used to verify ownership of cryptocurrency tokens to be transferred. In some examples, the service provider of FIG. 12 can record transactions taking place within the service provider of FIG. 12 involving cryptocurrency until the number of transactions has exceeded a determined limit (e.g., number of transactions, storage space allocation, etc.). Based at least in part on determining that the limit has been reached, the service provider of FIG. 12 can publish the transactions in the private blockchain 1319 to a public blockchain (e.g., associated with the asset network), where miners can verify the transactions and record the transactions to blocks on the public blockchain. In at least one example, the service provider of FIG. 12 can participate as miner(s) at least for its transactions to be posted to the public blockchain.

In at least one example, the data store(s) 1300 can store and/or manage accounts, such as user account(s) 1304, merchant account(s) 1306, and/or customer account(s) 1308. In at least one example, the user account(s) 1304 may store records of user accounts associated with the users 1206. In at least one example, the user account(s) 1304 can include a user account 1320, which can be associated with a user (of the users 1206). Other user accounts of the user account(s) 1304 can be similarly structured to the user account 1320, according to some examples. In other examples, other user accounts may include more or less data and/or account information than that provided by the user account 1320. In at least one example, the user account 1320 can include user account data 1328, which can include, but is not limited to, data associated with user identifying information (e.g., name, phone number, address, etc.), user identifier(s) (e.g., alphanumeric identifiers, etc.), user preferences (e.g., learned or user-specified), purchase history data (e.g., identifying one or more items purchased (and respective item information), linked payment sources (e.g., bank account(s), stored balance(s), etc.), payment instruments used to purchase one or more items, returns associated with one or more orders, statuses of one or more orders (e.g., preparing, packaging, in transit, delivered, etc.), etc.), appointments data (e.g., previous appointments, upcoming (scheduled) appointments, timing of appointments, lengths of appointments, etc.), payroll data (e.g., employers, payroll frequency, payroll amounts, etc.), reservations data (e.g., previous reservations, upcoming (scheduled) reservations, reservation duration, interactions associated with such reservations, etc.), inventory data, user service data, loyalty data (e.g., loyalty account numbers, rewards redeemed, rewards available, etc.), risk indicator(s) (e.g., level(s) of risk), etc.

In at least one example, the user account data 1328 can include account activity 1330 and user wallet key(s) 1332. The account activity 1330 may include a transaction log for recording transactions associated with the user account 1320. In some examples, the user wallet key(s) 1332 can include a public-private key-pair and a respective address associated with the asset network or other asset networks. In some examples, the user wallet key(s) 1332 may include one or more key pairs, which can be unique to the asset network or other asset networks.

In addition to the user account data 1328, the user account 1320 can include ledger(s) for account(s) managed by the service provider of FIG. 12, for the user. For example, the user account 1320 may include an asset ledger 1334, a fiat currency ledger 1336, and/or one or more other ledgers 1338. The ledger(s) can indicate that a corresponding user utilizes the service provider of FIG. 12 to manage corresponding accounts (e.g., a cryptocurrency account, a securities account, a fiat currency account, etc.). It should be noted that in some examples, the ledger(s) can be logical ledger(s) and the data can be represented in a single database. In some examples, individual of the ledger(s), or portions thereof, can be maintained by the service provider of FIG. 12.

In some examples, the asset ledger 1334 can store a balance for each of one or more cryptocurrencies (e.g., Bitcoin, Ethereum, Litecoin, etc.) registered to the user account 1320. In at least one example, the asset ledger 1334 can further record transactions of cryptocurrency assets associated with the user account 1320. For example, the user account 1320 can receive cryptocurrency from the asset network using the user wallet key(s) 1332. In some examples, the user wallet key(s) 1332 may be generated for the user upon request. User wallet key(s) 1332 can be requested by the user in order to send, exchange, or otherwise control the balance of cryptocurrency held by the service provider of FIG. 12 (e.g., in the asset wallet 1310) and registered to the user. In some examples, the user wallet key(s) 1332 may not be generated until a user account requires such. This on-the-fly wallet key generation provides enhanced security features for users, reducing the number of access points to a user account's balance and, therefore, limiting exposure to external threats.

Each account ledger can reflect a positive balance when funds are added to the corresponding account. An account can be funded by transferring currency in the form associated with the account from an external account (e.g., transferring a value of cryptocurrency to the service provider of FIG. 12 and the value is credited as a balance in asset ledger 1334), by purchasing currency in the form associated with the account using currency in a different form (e.g., buying a value of cryptocurrency from the service provider of FIG. 12 using a value of fiat currency reflected in fiat currency ledger 206, and crediting the value of cryptocurrency in asset ledger 1334), or by conducting a transaction with another user (customer or merchant) of the service provider of FIG. 12 wherein the account receives incoming currency (which can be in the form associated with the account or a different form, in which the incoming currency may be converted to the form associated with the account). In some examples, the user account data 1328 can include preferences for maintaining balances of individual of the ledgers. For example, the service provider of FIG. 12 can automatically debit the fiat currency ledger 1336 to increase the asset ledger 1334, or another account associated with the user whenever the cryptocurrency balance (e.g., of the asset ledger 1334) falls below a stated level (e.g., a threshold). Conversely, in some embodiments, the service provider of FIG. 12 can automatically credit the fiat currency ledger 1336 to decrease the asset ledger 1334 whenever cryptocurrency balance rises above a stated level (e.g., a threshold). In some examples, automatic transactions can be further defined by an exchange rate between the cryptocurrency and the fiat currency such that transactions to buy or sell cryptocurrency can occur when exchange rates are favorable.

With specific reference to funding a cryptocurrency account, a user may have a balance of cryptocurrency stored in another cryptocurrency wallet. In some examples, the other cryptocurrency wallet can be associated with a third-party (e.g., associated with the third-party server(s) 120) unrelated to the service provider of FIG. 12 (i.e., an external account). In at least one example, the user can transfer all or a portion of a balance of the cryptocurrency stored in the third-party cryptocurrency wallet to the service provider of FIG. 12. Such a transaction can require the user to transfer an amount of the cryptocurrency in a message signed by user's private key to an address provided by the service provider of FIG. 12. In at least one example, the transaction can be sent to miners to bundle the transaction into a block of transactions and to verify the authenticity of the transactions in the block. Once a miner has verified the block, the block is written to a public, distributed blockchain where the service provider of FIG. 12 can then verify that the transaction has been confirmed and can credit the user's asset ledger 1334 with the transferred amount. When an account is funded by transferring cryptocurrency from a third-party cryptocurrency wallet, an update can be made to the public blockchain. Importantly, this update of the public blockchain need not take place at a time critical moment, such as when a transaction is being processed by a merchant in store or online.

In some examples, a user can purchase cryptocurrency to fund their cryptocurrency account. In some examples, the user can purchase cryptocurrency through services offered by the service provider of FIG. 12. As described above, in some examples, the service provider of FIG. 12 can acquire cryptocurrency from a third-party source (e.g., associated with the third-party server(s) 118). In such examples, the asset wallet 1310 can be associated with different addresses and can vary addresses used to acquire cryptocurrency so that its holdings are represented under a variety of addresses on a blockchain. When the service provider of FIG. 12 has their own holdings of cryptocurrency, users can acquire cryptocurrency directly from the service provider of FIG. 12. In some examples, the service provider of FIG. 12 can include logic for buying and selling cryptocurrency in order to maintain a desired level of cryptocurrency. The desired level can be based on a volume of transactions over a period, balances of collective user profiles cryptocurrency ledgers, exchange rates, or trends in changing of exchange rates such that the cryptocurrency is trending towards gaining or losing value with respect to the fiat currency. In all of these examples, the buying and selling of cryptocurrency, and therefore the associated updating of the public ledger can be separate from any customer-merchant transaction, and therefore not necessarily time-sensitive.

In examples where the service provider of FIG. 12 has its own cryptocurrency assets, cryptocurrency transferred in a transaction (e.g., data with address provided for receipt of transaction and a balance of cryptocurrency transferred in the transaction) can be stored in the asset wallet 1310. In at least one example, the service provider of FIG. 12 can credit the asset ledger 1334 of the user. Additionally, while the service provider of FIG. 12 recognizes that the user retains the value of the transferred cryptocurrency through crediting the asset ledger 1334, any person that inspects the blockchain will see the cryptocurrency as having been transferred to the service provider of FIG. 12. In some examples, the asset wallet 1310 can be associated with many different addresses. In such examples, any person that inspects the blockchain may not easily associate all cryptocurrency stored in asset wallet 1310 as belonging to the same entity. It is this presence of a private ledger that is used for real-time transactions and maintained by the service provider of FIG. 12, combined with updates to the public ledger at other times, that allows for extremely fast transactions using cryptocurrency to be achieved. In some examples, the “private ledger” can refer to the asset ledger 1310, which in some examples, can utilize the private blockchain 1319, as described herein. The “public ledger” can correspond to a public blockchain associated with the asset network.

In at least one example, a user's asset ledger 1334, fiat currency ledger 1336, or the like can be credited when conducting a transaction with another user (customer or merchant) wherein the user receives incoming currency. In some examples, a user can receive cryptocurrency in the form of payment for a transaction with another user. In at least one example, such cryptocurrency can be used to fund the asset ledger 1334. In some examples, a user can receive fiat currency or another currency in the form of payment for a transaction with another user. In at least one example, at least a portion of such funds can be converted into cryptocurrency by the service provider of FIG. 12 and used to fund the asset ledger 1334 of the user.

As addressed above, in some examples, users can also have other accounts maintained by the service provider of FIG. 12. For example, a user can also have an account in U.S. dollars, which can be tracked, for example, via the fiat currency ledger 1336. Such an account can be funded by transferring money from a bank account at a third-party bank to an account maintained by the service provider of FIG. 12 as is conventionally known. In some examples, a user can receive fiat currency in the form of payment for a transaction with another user. In such examples, at least a portion of such funds can be used to fund the fiat currency ledger 1336.

In some examples, a user can have one or more internal payment cards registered with the service provider of FIG. 12. Internal payment cards can be linked to one or more of the accounts associated with the user account 1320. In some embodiments, options with respect to internal payment cards can be adjusted and managed using an application (e.g., the payment application 1218).

In at least one example, as described above, each ledger can correspond to an account of the user that is managed by the service provider of FIG. 12. In at least one example, individual of the accounts can be associated with a wallet or a stored balance for use in payment transactions, peer-to-peer transactions, payroll payments, etc.

In at least one example, the user account 1320 can be associated with an asset wallet 1340. The asset wallet 1340 of the user can be associated with account information that can be stored in the user account data 1328 and, in some examples, can be associated with the user wallet key(s) 1332. In at least one example, the asset wallet 1340 can store data indicating an address provided for receipt of a cryptocurrency transaction. In at least one example, the balance of the asset wallet 1340 can be based at least in part on a balance of the asset ledger 1334. In at least one example, funds availed via the asset wallet 1340 can be stored in the asset wallet 1340 or the asset wallet 1310. Funds availed via the asset wallet 1310 can be tracked via the asset ledger 1334. The asset wallet 1340, however, can be associated with additional cryptocurrency funds.

In at least one example, when the service provider of FIG. 12 includes a private blockchain 1319 for recording and validating cryptocurrency transactions, the asset wallet 1340 can be used instead of, or in addition to, the asset ledger 1334. For example, at least one example, a merchant can provide the address of the asset wallet 1340 for receiving payments. In an example where a customer is paying in cryptocurrency and the customer has their own cryptocurrency wallet account associated with the service provider of FIG. 12, the customer can send a message signed by its private key including its wallet address (i.e., of the customer) and identifying the cryptocurrency and value to be transferred to the merchant's asset wallet 1340. The service provider of FIG. 12 can complete the transaction by reducing the cryptocurrency balance in the customer's cryptocurrency wallet and increasing the cryptocurrency balance in the merchant's asset wallet 1340. In addition to recording the transaction in the respective cryptocurrency wallets, the transaction can be recorded in the private blockchain 1319 and the transaction can be confirmed. A user can perform a similar transaction with cryptocurrency in a peer-to-peer transaction as described above. In at least one example, the cryptocurrency wallet account 1330 can be funded by a balance transfer from a third-party cryptocurrency wallet, as described above. Such a transaction can require a user to transfer an amount of cryptocurrency in a message signed by the user's private key to an address of the cryptocurrency wallet account 1330. The transferred amount of cryptocurrency can then be within the cryptocurrency wallet account 1330 for use in later transactions.

While the asset ledger 1334 and/or asset wallet 1340 are each described above with reference to cryptocurrency, the asset ledger 1334 and/or asset wallet 1340 can alternatively be used in association with securities. In some examples, different ledgers and/or wallets can be used for different types of assets. That is, in some examples, a user can have multiple asset ledgers and/or asset wallets for tracking cryptocurrency, securities, or the like.

It should be noted that user(s) having accounts managed by the service provider of FIG. 12 is an aspect of the technology disclosed that enables technical advantages of increased processing speed and improved security.

FIG. 14 illustrates an example environment 1400 wherein the environment 1100 and the environment 1200 can be integrated to enable payments at the point-of-sale using assets associated with user accounts in the peer-to-peer environment of FIG. 12. As illustrated, each of the components can communicate with one another via one or more networks 1402. In some examples, one or more APIs 1404 or other functional components can be used to facilitate such communication. In some examples, the network(s) 1402 of FIG. 14 represent the network(s) 106 of FIGS. 1A-1C, and the API(s) 1404 may be used to enable verified transactions through integrations of social network and payment service computing platforms, as described herein. Accordingly, in at least one example, the environment 1400 of FIG. 14 may represent the environment 100A of FIG. 1A, the environment 100B of FIG. 1B, or the environment 100C of FIG. 1C to enable verified transactions through integrations (e.g., using the API(s) 1404) of social network and payment service computing platforms.

In at least one example, the example environment 1100 can enable contactless payments, via integration of peer-to-peer payment, or other payment making, platform(s) and payment processing platform(s), are described herein. For the purpose of FIG. 14, the environment 1100 can refer to a payment processing platform and the environment 1200 can refer to a peer-to-peer payment, or payment making, platform. In an example, such an integration can enable a customer to participate in a transaction via their own computing device instead of interacting with a merchant device of a merchant, such as the merchant device 1108(k). In such an example, the PUS application 1118, associated with a payment processing platform and executable by the merchant device 1108(A) of the merchant, can present a Quick Response (QR) code, or other code that can be used to identify a transaction (e.g., a transaction code), in association with a transaction between the customer and the merchant. The QR code, or other transaction code, can be provided to the POS application 1118 via an API associated with the peer-to-peer payment platform. In an example, the customer can utilize their own computing device, such as the user device 1208(A), to capture the QR code, or the other transaction code, and to provide an indication of the captured QR code, or other transaction code, to server(s) 1102 and/or server(s) 1202.

Based at least in part on the integration of the peer-to-peer payment platform and the payment processing platform (e.g., via the API), the server(s) 1102 and/or 1202 associated with each can exchange communications with each other and with a payment application 1218 associated with the peer-to-peer payment platform and/or the POS application 1118 to process payment for the transaction using a peer-to-peer payment where the customer is a first “peer” and the merchant is a second “peer.” In at least one example, the peer-to-peer payment platform can transfer funds from an account of the customer, maintained by the peer-to-peer payment platform, to an account of the merchant, maintained by the payment processing platform, thereby facilitating a contactless (peer-to-peer) payment for the transaction. That is, based at least in part on receiving an indication of which payment method a user (e.g., customer or merchant) intends to use for a transaction, techniques described herein utilize an integration between a peer-to-peer payment platform and payment processing platform (which can be a first- or third-party integration) such that a QR code, Or other transaction code, specific to the transaction can be used for providing transaction details, location details, customer details, or the like to a computing device of the customer, such as the user device 1208(A), to enable a contactless (peer-to-peer) payment for the transaction.

In at least one example, techniques described herein can offer improvements to conventional payment technologies at both brick-and-mortar points of sale and online points of sale. For example, at brick-and-mortar points of sale, techniques described herein can enable customers to “scan to pay,” by using their computing devices to scan QR codes, or other transaction codes, encoded with data as described herein, to remit payments for transactions. In such a “scan to pay” example, a customer computing device, such as the user device 1208(A), can be specially configured as a buyer-facing device that can enable the customer to view cart building in near real-time, interact with a transaction during cart building using the customer computing device, authorize payment via the customer computing device, apply coupons or other incentives via the customer computing device, add gratuity, loyalty information, feedback, or the like via the customer computing device, etc. In another example, merchants can “scan for payment” such that a customer can present a QR code, or other transaction code, that can be linked to a payment instrument or stored balance. Funds associated with the payment instrument or stored balance can be used for payment of a transaction.

As described above, techniques described herein can offer improvements to conventional payment technologies at online points of sale, as well as brick-and-mortar points of sale. For example, multiple applications can be used in combination during checkout. That is, the POS application 1118 and the payment application 1218, as described herein, can process a payment transaction by routing information input via the merchant application to the payment application for completing a “frictionless” payment. This can be referred to as “in-application payment.” In another example of “in-application payment,” the payment application described herein can be created or modified via a software developer kit (SDK) to enable in-application payment.

Returning to the “scan to pay” examples described herein, QR codes, or other transaction codes, can be presented in association with a merchant web page or ecommerce web page. In at least one example, techniques described herein can enable customers to “scan to pay,” by using their computing devices to scan or otherwise capture QR codes, or other transaction codes, encoded with data, as described herein, to remit payments for online/ecommerce transactions. In such a “scan to pay” example, a customer computing device, such as the user device 1208(A), can be specially configured as a buyer-facing device that can enable the customer to view cart building in near real-time, interact with a transaction during cart building using the customer computing device, authorize payment via the customer computing device, apply coupons or other incentives via the customer computing device, add gratuity, loyalty information, feedback, or the like via the customer computing device, etc.

In an example, a customer can desire to purchase items from a merchant. When the customer approaches the merchant to check out, the merchant (e.g., a worker associated therewith) can add indications of the items to a virtual cart via the POS application 1118, associated with a payment processing platform, on the merchant device 1108(A). In an example, the merchant can use the payment processing platform to process payments, and the payment processing platform can process payments for the merchant, as well as other merchants. That is, the payment processing platform can be an aggregator. After adding the first item, or otherwise providing an indication to start a transaction, a display of the merchant device 1108(A) can present a QR code, or other transaction code, that can be associated with a peer-to-peer payment platform. The customer can use a camera associated with the user device 1208(A) to scan, or otherwise capture, the QR code. If the customer is already associated with the peer-to-peer payment platform (e.g., has an existing account, previously onboarded, etc.), the peer-to-peer platform can provide an indication of the scanned QR code to the payment processing platform. This interaction between the customer computing device and the QR code can trigger communications between the peer-to-peer payment platform and the payment processing platform (e.g., via an API) to facilitate a transfer of funds from a stored balance of the customer, that is managed and/or maintained by the peer-to-peer payment platform, to a stored balance of the merchant, that is managed and/or maintained by the payment processing platform. As such, the customer can use such funds for contactless payment of the transaction. Such a payment can be structured as a peer-to-peer payment wherein the customer is the first “peer” and the payment processing platform is the second “peer.” The payment processing platform can deposit funds received from the peer-to-peer payment platform in an account of the merchant to settle the transaction on behalf of the merchant. In some examples, the payment processing platform can deposit funds into an account of the merchant to settle the transaction prior to receiving funds from the peer-to-peer payment platform.

As an additional or alternative example, a customer can desire to purchase items from a merchant. When the customer approaches the merchant to check out, the merchant (e.g., a worker associated therewith) can add indications of the items to a virtual cart via the POS application 1118, associated with a payment processing platform, on the merchant device 1108(A). In an example, the merchant can use the payment processing platform to process payments, and the payment processing platform can process payments for the merchant, as well as other merchants. That is, the payment processing platform can be an aggregator. After adding the first item, or otherwise providing an indication to start a transaction, the POS application 1118 can cause a text message with a resource locator (e.g., uniform resource locator (URL)) that can be associated with a peer-to-peer payment platform to be sent to the user device 1208(A). The customer can interact with the resource locator and, if the customer is already associated with the peer-to-peer payment platform (e.g., has an existing account, previously onboarded, etc.), the peer-to-peer payment platform can provide an indication of the interaction with the resource locator to the payment processing platform. This interaction between the customer and the resource locator presented via the customer computing device can trigger communications between the peer-to-peer payment platform and the payment processing platform (e.g., via an API) to facilitate a transfer of funds from a stored balance of the customer, that is managed and/or maintained by the peer-to-peer payment platform, to a stored balance of the merchant, that is managed and/or maintained by the payment processing platform. As such, the customer can use such funds for contactless payment of the transaction. As described above, such a payment can be structured as a peer-to-peer payment wherein the customer is the first “peer” and the payment processing platform is the second “peer.” The payment processing platform can deposit funds received from the peer-to-peer payment platform in an account of the merchant to settle the transaction on behalf of the merchant. In some examples, the payment processing platform can deposit funds into an account of the merchant to settle the transaction prior to receiving funds from the peer-to-peer payment platform.

The same or similar techniques can be applicable in online and/or ecommerce selling channels as well. In such an example, a QR code, or other transaction code, can be presented via an online store/ecommerce web page of a merchant. The customer can use a camera associated with a customer computing device, such as the user device 1208(A), to scan, or otherwise capture, the QR code. If the customer is already associated with the peer-to-peer payment platform (e.g., has an existing account, previously onboarded, etc.), the peer-to-peer platform can provide an indication of the scanned QR code to the payment processing platform. This interaction between the customer computing device and the QR code can trigger communications between the peer-to-peer payment platform and the payment processing platform (e.g., via an API) to facilitate a transfer of funds from a stored balance of the customer, that is managed and/or maintained by the peer-to-peer payment platform, to a stored balance of the merchant, that is managed and/or maintained by the payment processing platform. As such, the customer can use such funds for contactless payment of the transaction. Such a payment can be structured as a peer-to-peer payment wherein the customer is the first “peer” and the payment processing platform is the second “peer.” The payment processing platform can deposit funds received from the peer-to-peer payment platform in an account of the merchant to settle the transaction on behalf of the merchant. In some examples, the payment processing platform can deposit funds into an account of the merchant to settle the transaction prior to receiving funds from the peer-to-peer payment platform.

As described above, techniques described herein offer improvements to conventional payment technologies. In an example, techniques described herein can enable transaction data to be sent from a POS application 1118 of a merchant device 1108(A) at a brick-and-mortar store of a merchant to a payment application 1218 of a user device 1208(A) of a customer to enable the customer to participate in a transaction via their own computing device. For instance, in a “scan to pay” example as described above, based at least in part on capturing the QR code, or other transaction code, via the user device 1208(A), the payment processing platform can provide transaction data to the peer-to-peer payment platform for presentation via the payment application 1218 on the user device 1208(A). In some examples, the customer can watch items being added to their cart (e.g., via a user interface presented via the payment application). As an item is added to a virtual cart by the merchant via the POS application 1118 on the merchant device 1108(A) of the merchant the customer can see the item in their virtual cart on their own computing device in near-real time. In another example, the peer-to-peer payment platform can analyze transaction data as it is received to determine whether an incentive (e.g., a discount, a loyalty reward, prioritized access or booking, etc.) is applicable to the transaction and can automatically apply the incentive or send a recommendation to the payment application 1218 for presentation via a user interface associated therewith. In addition to enabling a customer to participate in a transaction during cart building, techniques described herein can enable a customer to complete a transaction, and in some examples, provide gratuity (i.e., a tip), feedback, loyalty information, or the like, via the user device 1208(A) during or after payment of the transaction.

In some examples, based at least in part on capturing the QR code, or other transaction code, the payment processing platform can provide transaction data to the peer-to-peer payment platform for presentation via the payment application 1218 on the computing device of the customer, such as the user device 1208(A), to enable the customer to complete the transaction via their own computing device. In some examples, in response to receiving an indication that the QR code, or other transaction code, has been captured or otherwise interacted with via the customer computing device, the peer-to-peer payment platform can determine that the customer authorizes payment of the transaction using funds associated with a stored balance of the customer that is managed and/or maintained by the peer-to-peer payment platform. Such authorization can be implicit such that the interaction with the transaction code can imply authorization of the customer. In some examples, in response to receiving an indication that the QR code, or other transaction code, has been captured or otherwise interacted with via the customer computing device, the peer-to-peer payment platform can request authorization to process payment for the transaction using the funds associated with the stored balance and the customer can interact with the payment application to authorize the settlement of the transaction. A response to such a request can provide an express authorization of the customer. In some examples, such an authorization (implicit or express) can be provided prior to a transaction being complete and/or initialization of a conventional payment flow. That is, in some examples, such an authorization can be provided during cart building (e.g., adding item(s) to a virtual cart) and/or prior to payment selection. In some examples, such an authorization can be provided after payment is complete (e.g., via another payment instrument). Based at least in part on receiving an authorization to use funds associated with the stored balance (e.g., implicitly or explicitly) of the customer, the peer-to-peer payment platform can transfer funds from the stored balance of the customer to the payment processing platform. In at least one example, the payment processing platform can deposit the funds, or a portion thereof, into a stored balance of the merchant that is managed and/or maintained by the payment processing platform. That is, techniques described herein enable the peer-to-peer payment platform to transfer funds to the payment processing platform to settle payment of the transaction. In such an example, the payment processing platform can be a “peer” to the customer in a peer-to-peer transaction.

In some examples, techniques described herein can enable the customer to interact with the transaction after payment for the transaction has been settled. For example, in at least one example, the payment processing platform can cause a total amount of a transaction to be presented via a user interface associated with the payment application 1218 such that the customer can provide gratuity, feedback, loyalty information, or the like, via an interaction with the user interface. In some examples, because the customer has already authorized payment via the peer-to-peer payment platform, if the customer inputs a tip, the peer-to-peer payment platform can transfer additional funds, associated with the tip, to the payment processing platform. This pre-authorization (or maintained authorization) of sorts can enable faster, more efficient payment processing when the tip is received. Further, the customer can provide feedback and/or loyalty information via the user interface presented by the payment application, which can be associated with the transaction.

As described above and also below techniques described herein enable contactless payments. That is, by integrating the payment processing platform with the peer-to-peer payment platform, merchants and customers can participate in transactions via their own computing devices without needing to touch, or otherwise be in contact, with one another. By moving aspects of a transaction that are traditionally performed on a computing device of a merchant to a computing device of a customer, customers can have more control over the transaction and can have more privacy. That is, customers can monitor items that are added to their cart to ensure accuracy. Further, customers can authorize payments, use rewards, claim incentives, add gratuity, or the like without being watched by the merchant or other customers.

In some examples, such as when the QR code, or other transaction code, is captured by the computing device of the customer prior to a payment selection user interface being presented via the POS application 1118, payment for the transaction can be pre-authorized such that when the time comes to complete the transaction, neither the payment processing platform nor the peer-to-peer payment platform need to re-authorize payment at that time. That is, techniques described herein can enable faster, more efficient transactions. Further, in some examples, when a customer adds a tip after payment for a transaction has been settled, in some examples, because the peer-to-peer payment platform has already been authorized, the peer-to-peer payment platform and the payment processing platform may not need to obtain another authorization to settle funds associated with the tip. That is, in such examples, fewer data transmissions are required and thus, techniques described herein can conserve bandwidth and reduce network congestion. Moreover, as described above, funds associated with tips can be received faster and more efficiently than with conventional payment technologies.

In addition to the improvements described above, techniques described herein can provide enhanced security in payment processing. In some examples, if a camera, or other sensor, used to capture a QR code, or other transaction code, is integrated into a payment application 1218 (e.g., instead of a native camera, or other sensor), techniques described herein can utilize an indication of the QR code, or other transaction code, received from the payment application for two-factor authentication to enable more secure payments.

It should be noted that, while techniques described herein are directed to contactless payments using QR codes or other transaction codes, in additional or alternative examples, techniques described herein can be applicable for contact payments. That is, in some examples, instead of scanning, capturing, or otherwise interacting with a QR code or transaction code, a customer can swipe a payment instrument e.g., a credit card, a debit card, or the like) via a reader device associated with a merchant device, dip a payment instrument into a reader device associated with a merchant computing device, tap a payment instrument with a reader device associated with a merchant computing device, or the like, to initiate the provisioning of transaction data to the customer computing device. For example, based at least in part on detecting a dip, tap, swipe, or the like, the payment processing platform can associate a customer with a transaction and provide at least a portion of transaction data associated with the transaction to a customer computing device associated therewith. In some examples, the payment instrument can be associated with the peer-to-peer payment platform as described herein (e.g., a debit card linked to a stored balance of a customer) such that when the payment instrument is caused to interact with a payment reader, the payment processing platform can exchange communications with the peer-to-peer payment platform to authorize payment for a transaction and/or provision associated transaction data to a computing device of the customer associated with the transaction.

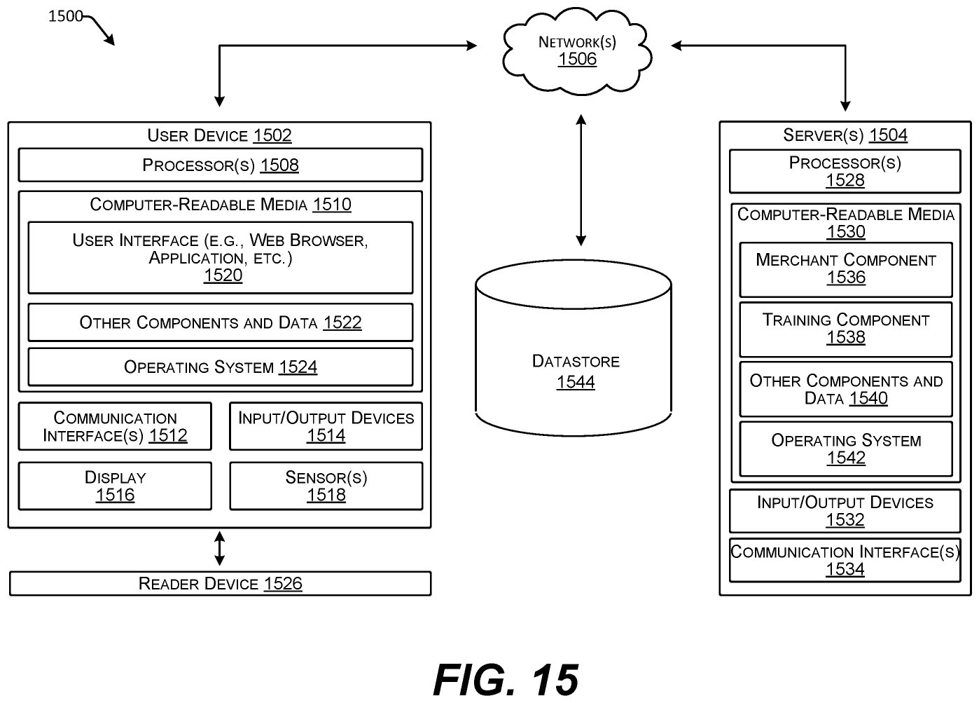

FIG. 15 depicts an illustrative block diagram illustrating a system 1500 for performing techniques described herein. The system 1500 includes a user device 1502, that communicates with server computing device(s) (e.g., server(s) 1504) via network(s) 1506 (e.g., the Internet, cable network(s), cellular network(s), cloud network(s), wireless network(s) (e.g., Wi-Fi) and wired network(s), as well as close-range communications such as Bluetooth®, Bluetooth® low energy (BLE), and the like). While a single user device 1502 is illustrated, in additional or alternate examples, the system 1500 can have multiple user devices, as described above with reference to FIG. 6.

In some examples, the user device 1502 of FIG. 15 represents an individual of the user electronic devices 104 of FIGS. 1A-1C. In some examples, the server(s) 1504 of FIG. 15 represents an individual of the processing device(s) 110 (e.g., servers) of the payment service computing platform 108 of FIGS. 1A-1C or an individual of the server(s) 121 of the third-party computing platform 119 depicted in FIG. 1A. In some examples, the network(s) 1506 of FIG. 15 represent the network(s) 106 of FIGS. 1A-1C. In some examples, the data store 1544 of FIG. 15 represents the data store(s) 112 of FIGS. 1A-1C. Accordingly, in at least one example, the user device 1502 can utilize a payment application 114, as described herein, the payment application 114 allowing a user of the user device 1502 to navigate to the various user interfaces described herein to make electronic payments with other users, and may facilitate generation of unalterable trust signals for improving the accuracy and security of payment transactions between users of the payment service computing platform. In at least one other example, the user device 1502 can utilize a payment application 114, as described herein, the payment application 114 allowing a user of the user device 1502 to purchase, or otherwise acquire, assets, to engage in social investing (e.g., mirroring asset allocations of other users), and may facilitate the creation, customization, or sharing of asset profiles, which can enable users to quickly and effortlessly purchase assets based on other users' asset profiles. In at least one other example, the user devices 1502 can utilize a payment application 114 and/or third-party service application 134, as described herein, the payment application 114 and/or third-party service application 134 allowing a user of the user device 1502 to gift tokens 122 that are redeemable for assets, and may enable transfers of ownership interests in assets using redeemable tokens that can be shared between users of the social network or payment service computing platforms.

In at least one example, the user device 1502 can be any suitable type of computing device, e.g., portable, semi-portable, semi-stationary, or stationary. Some examples of the user device 1502 can include, but are not limited to, a tablet computing device, a smart phone or mobile communication device, a laptop, a netbook or other portable computer or semi-portable computer, a desktop computing device, a terminal computing device or other semi-stationary or stationary computing device, a dedicated device, a wearable computing device or other body-mounted computing device, an augmented reality device, a virtual reality device, an Internet of Things (IoT) device, etc. That is, the user device 1502 can be any computing device capable of sending communications and performing the functions according to the techniques described herein. The user device 1502 can include devices, e.g., payment card readers, or components capable of accepting payments, as described below.

In the illustrated example, the user device 1502 includes one or more processors 1508, one or more computer-readable media 1510, one or more communication interface(s) 1512, one or more input/output (I/O) devices 1514, a display 1516, and sensor(s) 1518.

In at least one example, each processor 1508 can itself comprise one or more processors or processing cores. For example, the processor(s) 1508 can be implemented as one or more microprocessors, microcomputers, microcontrollers, digital signal processors, central processing units, state machines, logic circuitries, and/or any devices that manipulate signals based on operational instructions. In some examples, the processor(s) 1508 can be one or more hardware processors and/or logic circuits of any suitable type specifically programmed or configured to execute the algorithms and processes described herein. The processor(s) 1508 can be configured to fetch and execute computer-readable processor-executable instructions stored in the computer-readable media 1510.

Depending on the configuration of the user device 1502, the computer-readable media 1510 can be an example of tangible non-transitory computer storage media and can include volatile and nonvolatile memory and/or removable and non-removable media implemented in any type of technology for storage of information such as computer-readable processor-executable instructions, data structures, program components or other data. The computer-readable media 1510 can include, but is not limited to, RAM, ROM, EEPROM, flash memory, solid-state storage, magnetic disk storage, optical storage, and/or other computer-readable media technology. Further, in some examples, the user device 1502 can access external storage, such as RAID storage systems, storage arrays, network attached storage, storage area networks, cloud storage, or any other medium that can be used to store information and that can be accessed by the processor(s) 1508 directly or through another computing device or network. Accordingly, the computer-readable media 1510 can be computer storage media able to store instructions, components or components that can be executed by the processor(s) 1508. Further, when mentioned, non-transitory computer-readable media exclude media such as energy, carrier signals, electromagnetic waves, and signals per se.

The computer-readable media 1510 can be used to store and maintain any number of functional components that are executable by the processor(s) 1508. In some implementations, these functional components comprise instructions or programs that are executable by the processor(s) 1508 and that, when executed, implement operational logic for performing the actions and services attributed above to the user device 1502. Functional components stored in the computer-readable media 1510 can include a user interface 1520 to enable users to interact with the user device 1502, and thus the server(s) 1504 and/or other networked devices. In at least one example, the user interface 1520 can be presented via a web browser, or the like. In other examples, the user interface 1520 can be presented via an application, such as a mobile application or desktop application, which can be provided by a service provider 612 associated with the server(s) 1504, or which can be an otherwise dedicated application. In some examples, the user interface 1520 can be any of the user interfaces 116A, 116B, 116C, 116D, 124A, 124B, 124C, 124D, 138A, 138B, 138C, 138D, 402, 404, 406, 408, 410, 412, 414, 416, 418, 702, 704, 706, 708, 710, 712, 714, 716, 718, 720, 722, 724, 726, 728, 730, 732, 734, 736, 738, 740, 796, 798, 799, 1002, 1004, 1006, 1008, 1018, 1020, 1022, 1024, 1026, 1028, 1030, 1032, 1033, 1034, or 1036, as described herein. In at least one example, a user can interact with the user interface via touch input, spoken input, gesture, or any other type of input. The word “input” is also used to describe “contextual” input that may not be directly provided by the user via the user interface 1520. For example, user's interactions with the user interface 1520 are analyzed using, e.g., natural language processing techniques, to determine context or intent of the user, which may be treated in a manner similar to “direct” user input.

Depending on the type of the user device 1502, the computer-readable media 1510 can also optionally include other functional components and data, such as other components and data 1522, which can include programs, drivers, etc., and the data used or generated by the functional components. In addition, the computer-readable media 1510 can also store data, data structures and the like, that are used by the functional components. Further, the user device 1502 can include many other logical, programmatic and physical components, of which those described are merely examples that are related to the discussion herein.

In at least one example, the computer-readable media 1510 can include additional functional components, such as an operating system 1524 for controlling and managing various functions of the user device 1502 and for enabling basic user interactions.

The communication interface(s) 1512 can include one or more interfaces and hardware components for enabling communication with various other devices, such as over the network(s) 1506 or directly. For example, communication interface(s) 1512 can enable communication through one or more network(s) 1506, which can include, but are not limited any type of network known in the art, such as a local area network or a wide area network, such as the Internet, and can include a wireless network, such as a cellular network, a cloud network, a local wireless network, such as Wi-Fi and/or close-range wireless communications, such as Bluetooth®, BLE, NFC, RFID, a wired network, or any other such network, or any combination thereof. Accordingly, network(s) 1506 can include both wired and/or wireless communication technologies, including Bluetooth®, BLE, Wi-Fi and cellular communication technologies, as well as wired or fiber optic technologies. Components used for such communications can depend at least in part upon the type of network, the environment selected, or both. Protocols for communicating over such networks are well known and will not be discussed herein in detail.

Embodiments of the disclosure may be provided to users through a cloud computing infrastructure. Cloud computing refers to the provision of scalable computing resources as a service over a network, to enable convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

The user device 1502 can further include one or more input/output (I/O) devices 1514. The I/O devices 1514 can include speakers, a microphone, a camera, and various user controls (e.g., buttons, a joystick, a keyboard, a keypad, etc.), a haptic output device, and so forth. The I/O devices 1514 can also include attachments that leverage the accessories (audio-jack, USB-C, Bluetooth, etc.) to connect with the user device 1502.

In at least one example, user device 1502 can include a display 1516. Depending on the type of computing device(s) used as the user device 1502, the display 1516 can employ any suitable display technology. For example, the display 1516 can be a liquid crystal display, a plasma display, a light emitting diode display, an OLED (organic light-emitting diode) display, an electronic paper display, or any other suitable type of display able to present digital content thereon. In at least one example, the display 1516 can be an augmented reality display, a virtually reality display, or any other display able to present and/or project digital content. In some examples, the display 1516 can have a touch sensor associated with the display 1516 to provide a touchscreen display configured to receive touch inputs for enabling interaction with a graphic interface presented on the display 1516. Accordingly, implementations herein are not limited to any particular display technology. Alternatively, in some examples, the user device 1502 may not include the display 1516, and information can be presented by other means, such as aurally, hapticly, etc.

In addition, the user device 1502 can include sensor(s) 1518. The sensor(s) 1518 can include a GPS device able to indicate location information. Further, the sensor(s) 1518 can include, but are not limited to, an accelerometer, gyroscope, compass, proximity sensor, camera, microphone, and/or a switch.

In some example, the GPS device can be used to identify a location of a user. In at least one example, the location of the user can be used by the service provider 612, described above, to provide one or more services. That is, in some examples, the service provider 612 can implement geofencing to provide particular services to users. As an example, with a lending service, location can be used to confirm that a stated purpose of a loan corresponds to evidence of use (e.g., Is the user using the loan consistent with what he or she said he or she was going to use it for?). Furthermore, in some examples, location can be used for payroll purposes. As an example, if a contractor completes a project, the contractor can provide a geo-tagged image (e.g., tagged based on location information availed by the GPS device). In some examples, location can be used for facilitating peer-to-peer payments between nearby users 614 and/or for sending users 614 notifications regarding available appointments with merchant(s) located proximate to the users 614. In at least one example, location can be used for taking payments from nearby customers when they leave a geofence, or location can be used to initiate an action responsive to users 614 enter a brick-and-mortar store of a merchant. Location can be used in additional or alternative ways as well.

Additionally, the user device 1502 can include various other components that are not shown, examples of which include removable storage, a power source, such as a battery and power control unit, a barcode scanner, a printer, a cash drawer, and so forth.

In addition, in some examples, the user device 1502 can include, be connectable to, or otherwise be coupled to a reader device 1526, for reading payment instruments and/or identifiers associated with payment objects. In some examples, as described above, the reader device 1526 can plug in to a port in the user device 1502, such as a microphone port, a headphone port, an audio-jack, a data port, or other suitable port. In additional or alternative examples, the reader device 1526 can be coupled to the user device 1502 via another wired or wireless connection, such as via a Bluetooth®, BLE, and so on. The reader device 1526 can include a read head for reading a magnetic strip of a payment card, and further can include encryption technology for encrypting the information read from the magnetic strip. Additionally or alternatively, the reader device 1526 can be an EMV payment reader, which in some examples, can be embedded in the user device 1502. Moreover, numerous other types of readers can be employed with the user device 1502 herein, depending on the type and configuration of the user device 1502.

The reader device 1526 may be a portable magnetic stripe card reader, optical scanner, smartcard (card with an embedded IC chip) reader (e.g., an EMV-compliant card reader or short-range communication-enabled reader), RFID reader, or the like, configured to detect and obtain data off any payment instrument. Accordingly, the reader device 1526 may include hardware implementation, such as slots, magnetic tracks, and rails with one or more sensors or electrical contacts to facilitate detection and acceptance of a payment instrument. That is, the reader device 1526 may include hardware implementations to enable the reader device 1526 to interact with a payment instrument via a swipe (i.e., a card-present transaction where a customer slides a card having a magnetic strip through a payment reader that captures payment data contained in the magnetic strip), a dip (i.e., a card-present transaction where a customer inserts a card having an embedded microchip (i.e., chip) into a payment reader first until the payment reader prompts the customer to remove the card), or a tap (i.e., a card-present transaction where a customer may tap or hover his or her electronic device such as a smart phone running a payment application over a payment reader to complete a transaction via short-range communication) to obtain payment data associated with a customer. Additionally or optionally, the reader device 1526 may also include a biometric sensor to receive and process biometric characteristics and process them as payment instruments, given that such biometric characteristics are registered with the payment service system and connected to a financial account with a bank server.

The reader device 1526 may include processing unit(s), computer-readable media, a reader chip, a transaction chip, a timer, a clock, a network interface, a power supply, and so on. The processing unit(s) of the reader device 1526 may execute one or more components and/or processes to cause the reader device 1526 to perform a variety of functions, as set forth above and explained in further detail in the following disclosure. In some examples, the processing unit(s) may include a central processing unit (CPU), a graphics processing unit (GPU), a CPU and a GPU, or processing units or components known in the art. Additionally, each of the processing unit(s) may possess its own local memory, which also may store program components, program data, and/or one or more operating systems. Depending on the exact configuration and type of the reader device 1526, the computer-readable media may include volatile memory (such as RAM), non-volatile memory (such as ROM, flash memory, miniature hard drive, memory card, or the like), or some combination thereof. In at least one example, the computer-readable media of the reader device 1526 may include at least one component for performing various functions as described herein.

The reader chip may perform functionalities to control the operations and processing of the reader device 1526. That is, the reader chip may perform functionalities to control payment interfaces (e.g., a contactless interface, a contact interface, etc.), a wireless communication interface, a wired interface, a user interface (e.g., a signal condition device (FPGA)), etc. Additionally, the reader chip may perform functionality to control the timer, which may provide a timer signal indicating an amount of time that has lapsed following a particular event (e.g., an interaction, a power-down event, etc.). Moreover, the reader chip may perform functionality to control the clock 1512, which may provide a clock signal indicating a time. Furthermore, the reader chip may perform functionality to control the network interface, which may interface with the network(s) 1506, as described below.

Additionally, the reader chip may perform functionality to control the power supply. The power supply may include one or more power supplies such as a physical connection to AC power or a battery. Power supply may include power conversion circuitry for converting AC power and generating a plurality of DC voltages for use by components of reader device 1526. When power supply includes a battery, the battery may be charged via a physical power connection, via inductive charging, or via any other suitable method.

The transaction chip may perform functionalities relating to processing of payment transactions, interfacing with payment instruments, cryptography, and other payment-specific functionality. That is, the transaction chip may access payment data associated with a payment instrument and may provide the payment data to a POS terminal, as described above. The payment data may include, but is not limited to, a name of the customer, an address of the customer, a type (e.g., credit, debit, etc.) of a payment instrument, a number associated with the payment instrument, a verification value (e.g., PIN Verification Key Indicator (PVKI), PIN Verification Value (PVV), Card Verification Value (CVV), Card Verification Code (CVC), etc.) associated with the payment instrument, an expiration data associated with the payment instrument, a primary account number (PAN) corresponding to the customer (which may or may not match the number associated with the payment instrument), restrictions on what types of charges/debts may be made, etc. Additionally, the transaction chip may encrypt the payment data upon receiving the payment data.

It should be understood that in some examples, the reader chip may have its own processing unit(s) and computer-readable media and/or the transaction chip may have its own processing unit(s) and computer-readable media. In other examples, the functionalities of reader chip and transaction chip may be embodied in a single chip or a plurality of chips, each including any suitable combination of processing units and computer-readable media to collectively perform the functionalities of reader chip and transaction chip as described herein.

While, the user device 1502, which can be a POS terminal, and the reader device 1526 are shown as separate devices, in additional or alternative examples, the user device 1502 and the reader device 1526 can be part of a single device, which may be a battery-operated device. In such an example, components of both the user device 1502 and the reader device 1526 may be associated with the single device. In some examples, the reader device 1526 can have a display integrated therewith, which can be in addition to (or as an alternative of) the display 1516 associated with the user device 1502.

The server(s) 1504 can include one or more servers or other types of computing devices that can be embodied in any number of ways. For example, in the example of a server, the components, other functional components, and data can be implemented on a single server, a cluster of servers, a server farm or data center, a cloud-hosted computing service, a cloud-hosted storage service, and so forth, although other computer architectures can additionally or alternatively be used.

Further, while the figures illustrate the components and data of the server(s) 1504 as being present in a single location, these components and data can alternatively be distributed across different computing devices and different locations in any manner. Consequently, the functions can be implemented by one or more server computing devices, with the various functionality described above distributed in various ways across the different computing devices. Multiple server(s) 1504 can be located together or separately, and organized, for example, as virtual servers, server banks and/or server farms. The described functionality can be provided by the servers of a single merchant or enterprise, or can be provided by the servers and/or services of multiple different customers or enterprises.

In the illustrated example, the server(s) 1504 can include one or more processors 1528, one or more computer-readable media 1530, one or more I/O devices 1532, and one or more communication interfaces 1534. Each processor 1528 can be a single processing unit or a number of processing units, and can include single or multiple computing units or multiple processing cores. The processor(s) 1528 can be implemented as one or more microprocessors, microcomputers, microcontrollers, digital signal processors, central processing units, state machines, logic circuitries, and/or any devices that manipulate signals based on operational instructions. For example, the processor(s) 1528 can be one or more hardware processors and/or logic circuits of any suitable type specifically programmed or configured to execute the algorithms and processes described herein. The processor(s) 1528 can be configured to fetch and execute computer-readable instructions stored in the computer-readable media 1530, which can program the processor(s) 1528 to perform the functions described herein.

The computer-readable media 1530 can include volatile and nonvolatile memory and/or removable and non-removable media implemented in any type of technology for storage of information, such as computer-readable instructions, data structures, program components, or other data. Such computer-readable media 1530 can include, but is not limited to, RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the server(s) 1504, the computer-readable media 1530 can be a type of computer-readable storage media and/or can be a tangible non-transitory media to the extent that when mentioned, non-transitory computer-readable media exclude media such as energy, carrier signals, electromagnetic waves, and signals per se.

The computer-readable media 1530 can be used to store any number of functional components that are executable by the processor(s) 1528. In many implementations, these functional components comprise instructions or programs that are executable by the processors 1528 and that, when executed, specifically configure the one or more processors 1528 to perform the actions attributed above to the service provider and/or payment processing service. Functional components stored in the computer-readable media 1530 can optionally include a merchant component 1536, a training component 1538, and one or more other components and data 1540.

The computer-readable media 1510 and/or the computer-readable media 1530 can include one or more components to enable verified transactions through integrations of social network and payment service computing platforms, as described herein. For example, the computer-readable media 1510 and/or the computer-readable media 1530 can include components to facilitate generation of unalterable trust signals for improving the accuracy and security of payment transactions between users of the payment service computing platform, to facilitate the creation, customization, or sharing of asset profiles, which can enable users to quickly and effortlessly purchase assets based on other users' asset profiles, and/or to enable transfers of ownership interests in assets using redeemable tokens that can be shared between users of the social network or payment service computing platforms, as described herein.

The merchant component 1536 can be configured to receive transaction data from POS systems, such as the POS system 1124 described above with reference to FIG. 11. The merchant component 1536 can transmit requests (e.g., authorization, capture, settlement, etc.) to payment service server computing device(s) to facilitate POS transactions between merchants and customers. The merchant component 1536 can communicate the successes or failures of the POS transactions to the POS systems.

The training component 1538 can be configured to train models using machine-learning mechanisms. For example, a machine-learning mechanism can analyze training data to train a data model that generates an output, which can be a recommendation, a score, and/or another indication. Machine-learning mechanisms can include, but are not limited to supervised learning algorithms (e.g., artificial neural networks, Bayesian statistics, support vector machines, decision trees, classifiers, k-nearest neighbor, etc.), unsupervised learning algorithms (e.g., artificial neural networks, association rule learning, hierarchical clustering, cluster analysis, etc.), semi-supervised learning algorithms, deep learning algorithms, etc.), statistical models, etc. In at least one example, machine-trained data models can be stored in a data store associated with the user device(s) 1502 and/or the server(s) 1504 for use at a time after the data models have been trained (e.g., at runtime).

The one or more other components and data 1540 can include one or more components and data to enable verified transactions through integrations of social network and payment service computing platforms, the functionality of which is described, at least partially, above. For example, the one or more other components and data 1540 can include components and data to facilitate generation of unalterable trust signals for improving the accuracy and security of payment transactions between users of the payment service computing platform, to facilitate the creation, customization, or sharing of asset profiles, which can enable users to quickly and effortlessly purchase assets based on other users' asset profiles, and/or to enable transfers of ownership interests in assets using redeemable tokens that can be shared between users of the social network or payment service computing platforms, as described herein. Further, the one or more other components and data 1540 can include programs, drivers, etc., and the data used or generated by the functional components. Further, the server(s) 1504 can include many other logical, programmatic and physical components, of which those described above are merely examples that are related to the discussion herein.

The one or more “components” referenced herein may be implemented as more components or as fewer components, and functions described for the components may be redistributed depending on the details of the implementation. The term “component,” as used herein, refers broadly to software stored on non-transitory storage medium (e.g., volatile or non-volatile memory for a computing device), hardware, or firmware (or any combination thereof) components. Modules are typically functional such that they that may generate useful data or other output using specified input(s). A component may or may not be self-contained. An application program (also called an “application”) may include one or more components, or a component may include one or more application programs that can be accessed over a network or downloaded as software onto a device (e.g., executable code causing the device to perform an action). An application program (also called an “application”) may include one or more components, or a component may include one or more application programs. In additional and/or alternative examples, the component(s) may be implemented as computer-readable instructions, various data structures, and so forth via at least one processing unit to configure the computing device(s) described herein to execute instructions and to perform operations as described herein.

In some examples, a component may include one or more application programming interfaces (APIs) to perform some or all of its functionality (e.g., operations). In at least one example, a software developer kit (SDK) can be provided by the service provider to allow third-party developers to include service provider functionality and/or avail service provider services in association with their own third-party applications. Additionally or alternatively, in some examples, the service provider can utilize a SDK to integrate third-party service provider functionality into its applications. That is, API(s) and/or SDK(s) can enable third-party developers to customize how their respective third-party applications interact with the service provider or vice versa.

The computer-readable media 1530 can additionally include an operating system 1542 for controlling and managing various functions of the server(s) 1504.

The communication interface(s) 1534 can include one or more interfaces and hardware components for enabling communication with various other devices, such as over the network(s) 1506 or directly. For example, communication interface(s) 1534 can enable communication through one or more network(s) 1506, which can include, but are not limited any type of network known in the art, such as a local area network or a wide area network, such as the Internet, and can include a wireless network, such as a cellular network, a local wireless network, such as Wi-Fi and/or close-range wireless communications, such as Bluetooth®, BLE, NFC, RFID, a wired network, or any other such network, or any combination thereof. Accordingly, network(s) 1502 can include both wired and/or wireless communication technologies, including Bluetooth®, BLE, Wi-Fi and cellular communication technologies, as well as wired or fiber optic technologies. Components used for such communications can depend at least in part upon the type of network, the environment selected, or both. Protocols for communicating over such networks are well known and will not be discussed herein in detail.

The server(s) 1504 can further be equipped with various I/O devices 1532. Such I/O devices 1532 can include a display, various user interface controls (e.g., buttons, joystick, keyboard, mouse, touch screen, biometric or sensory input devices, etc.), audio speakers, connection ports and so forth.

In at least one example, the system 1500 can include a data store 1544 that can be configured to store data that is accessible, manageable, and updatable. In some examples, the data store 1544 can be integrated with the user device 1502 and/or the server(s) 1504. In other examples, as shown in FIG. 15, the data store 1544 can be located remotely from the server(s) 1504 and can be accessible to the server(s) 1504. The data store 1544 can comprise multiple databases and/or servers connected locally and/or remotely via the network(s) 1506.

In at least one example, the data store 1544 can store user profiles, which can include merchant profiles, customer profiles, and so on. The user profiles can include user identifier that can vary dynamically for example as the user performs transactions. The user profiles can be associated with dynamically changing images, videos, NFTs, audio, etc. The user profiles can vary based on the other user that is interacting with the user. So,

Merchant profiles can store, or otherwise be associated with, data associated with merchants. For instance, a merchant profile can store, or otherwise be associated with, information about a merchant (e.g., name of the merchant, geographic location of the merchant, operating hours of the merchant, employee information, etc.), a merchant category classification (MCC), item(s) offered for sale by the merchant, hardware (e.g., device type) used by the merchant, transaction data associated with the merchant (e.g., transactions conducted by the merchant, payment data associated with the transactions, items associated with the transactions, descriptions of items associated with the transactions, itemized and/or total spends of each of the transactions, parties to the transactions, dates, times, and/or locations associated with the transactions, etc.), loan information associated with the merchant (e.g., previous loans made to the merchant, previous defaults on said loans, etc.), risk information associated with the merchant (e.g., indications of risk, instances of fraud, chargebacks, etc.), appointments information (e.g., previous appointments, upcoming (scheduled) appointments, timing of appointments, lengths of appointments, etc.), payroll information (e.g., employees, payroll frequency, payroll amounts, etc.), employee information, reservations data (e.g., previous reservations, upcoming (scheduled) reservations, interactions associated with such reservations, etc.), inventory data, customer service data, etc. The merchant profile can securely store bank account information as provided by the merchant. Further, the merchant profile can store payment information associated with a payment instrument linked to a stored balance of the merchant, such as a stored balance maintained in a ledger by the service provider 612.

Customer profiles can store customer data including, but not limited to, customer information (e.g., name, phone number, address, banking information, etc.), customer preferences (e.g., learned or customer-specified), purchase history data (e.g., identifying one or more items purchased (and respective item information), payment instruments used to purchase one or more items, returns associated with one or more orders, statuses of one or more orders (e.g., preparing, packaging, in transit, delivered, etc.), etc.), appointments data (e.g., previous appointments, upcoming (scheduled) appointments, timing of appointments, lengths of appointments, etc.), payroll data (e.g., employers, payroll frequency, payroll amounts, etc.), reservations data (e.g., previous reservations, upcoming (scheduled) reservations, reservation duration, interactions associated with such reservations, etc.), inventory data, customer service data, etc.

In at least one example, the account(s) 118, described above with reference to FIG. 1, can include or be associated with the merchant profiles and/or customer profiles described above.

Furthermore, in at least one example, the data store 1544 can store inventory database(s) and/or catalog database(s). As described above, an inventory can store data associated with a quantity of each item that a merchant has available to the merchant. Furthermore, a catalog can store data associated with items that a merchant has available for acquisition. The data store 1544 can store additional or alternative types of data as described herein.

The phrases “in some examples,” “according to various examples,” “in the examples shown,” “in one example,” “in other examples,” “various examples,” “some examples,” and the like generally mean the particular feature, structure, or characteristic following the phrase is included in at least one example of the present invention, and may be included in more than one example of the present invention. In addition, such phrases do not necessarily refer to the same examples or to different examples.

If the specification states a component or feature “can,” “may,” “could,” or “might” be included or have a characteristic, that particular component or feature is not required to be included or have the characteristic.

Further, the aforementioned description is directed to devices and applications that are related to payment technology. However, it will be understood, that the technology can be extended to any device and application. Moreover, techniques described herein can be configured to operate irrespective of the kind of payment object reader, POS terminal, web applications, mobile applications, POS topologies, payment cards, computer networks, and environments.

Various figures included herein are flowcharts showing example methods involving techniques as described herein. The methods illustrated are described with reference to components described in the figures for convenience and ease of understanding. However, the methods illustrated are not limited to being performed using components described the figures and such components are not limited to performing the methods illustrated herein.

Furthermore, the methods described above are illustrated as collections of blocks in logical flow graphs, which represent sequences of operations that can be implemented in hardware, software, or a combination thereof. In the context of software, the blocks represent computer-executable instructions stored on one or more computer-readable storage media that, when executed by processor(s), perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the processes. In some embodiments, one or more blocks of the process can be omitted entirely. Moreover, the methods can be combined in whole or in part with each other or with other methods.

### EXAMPLE CLAUSES

1. A computer-implemented method comprising:
receiving, by a payment service computing platform, and from a payment application associated with the payment service computing platform and executing on an electronic device associated with a first user, a request from the first user to view a user profile associated with a second user, wherein the first user and the second user have accounts with the payment service computing platform, and wherein the request is received in association with a payment transaction;
retrieving, by the payment service computing platform, and from a data store maintained by the payment service computing platform, user profiles of other users having an existing relationship with the first user;
identifying, by the payment service computing platform, and based on the user profiles retrieved from the data store, social nodes between the first user and the second user, wherein individual ones of the social nodes corresponds to one or more previous interactions between the second user and another user of the other users;
determining, by the payment service computing platform and based on the social nodes, a trust signal associated with the second user; and
causing, by the payment service computing platform, a first user interface to be displayed via the payment application executing on the electronic device associated with the first user, wherein the first user interface presents the user profile associated with a second user and comprises an indication of an identity of the second user and an indication of the trust signal associated with the second user to enable the first user to confirm the identity of the second user prior to initiating the payment transaction.

2. The computer-implemented method of Clause 1, wherein the indication of the trust signal comprises a number of the other users that have made at least one payment to the second user.

3. The computer-implemented method of Clause 2, wherein the trust signal is a first trust signal, the computer-implemented method further comprising determining, by the payment service computing platform, a second trust signal associated with the second user and a third trust signal associated with the second user, wherein the first user interface further comprises:
an indication of the second trust signal comprising a date on which the second user joined the payment service computing platform by setting up an account with the payment service computing platform; and
an indication of the third trust signal indicating whether the second user is included in a list of contacts associated with the first user.

4. The computer-implemented method of any one of Clauses 1 to 3, wherein the first user interface further comprises a first interactive element for initiating the payment transaction between the first user and the second user, the computer-implemented method further comprising:
determining, by the payment service computing platform, a selection of the first interactive element by the first user; and
in response to determining the selection of the first interactive element, transferring, by the payment service computing platform, a payment amount corresponding to the payment transaction from a first account of the first user to a second account of the second user.

5. A computer-implemented method comprising:
retrieving, by a payment service computing platform, and from a data store maintained by the payment service computing platform, one or more profiles of users having a relationship with a first user, wherein the retrieving is based at least in part on a request received from the first user in the context of a payment transaction with a second user;
determining, by the payment service computing platform, and based at least in part on the one or more profiles, an indirect relationship between the first user and the second user;
determining, by the payment service computing platform, and based at least in part on the determination of the indirect relationship, a trust signal associated with the second user; and
causing, by the payment service computing platform, a user interface to be displayed via a payment application executing on an electronic device associated with the first user, wherein the user interface comprises an indication of an identity of the second user and an indication of the trust signal.

6. The computer-implemented method of Clause 5, further comprising determining, based at least in part on the one or more profiles, a set of social nodes associated with the second user, wherein individual social nodes of the set of social nodes correspond to a payment made between the second user and at least one of the users.

7. The computer-implemented method of Clause 6, wherein the user interface further comprises an interactive element for initiating the payment transaction between the first user and the second user, the computer-implemented method further comprising:
generating a social trust score based at least in part on the set of social nodes;
determining a selection of the interactive element;
determining that the social trust score meets or exceeds a threshold; and
transferring, by the payment service computing platform, and based at least in part on the social trust score meeting or exceeding the threshold, a payment amount corresponding to the payment transaction from a first account of the first user to a second account of the second user.

8. The computer-implemented method of Clause 6, wherein the user interface further comprises an interactive element for initiating the payment transaction between the first user and the second user, the computer-implemented method further comprising:
generating a social trust score based at least in part on the set of social nodes;
determining a selection of the interactive element;
determining that the social trust score does not meet or exceed a threshold; and
preventing, by the payment service computing platform, and based at least in part on the social trust score failing to meet or exceed the threshold, a payment amount corresponding to the payment transaction from being transferred from a first account of the first user to a second account of the second user.

9. The computer-implemented method of any one of Clauses 5 to 8, wherein the trust signal is a first trust signal comprising at least one of:
a number of the users that have made a payment to, or received a payment from, the second user; or
a number of payments made between the second user and at least one of the users.

10. The computer-implemented method of Clause 9, further comprising determining a second trust signal associated with the second user, the second trust signal comprising a date on which the second user established an account with the payment service computing platform, wherein the user interface further comprises an indication of the second trust signal.

11. The computer-implemented method of Clause 9, further comprising determining a second trust signal associated with the second user, the second trust signal comprising an indication of whether the second user is included in a list of contacts associated with the first user, wherein the user interface further comprises an indication of the second trust signal.

12. The computer-implemented method of any one of Clauses 5 to 11, wherein the indication of the trust signal comprises a read-only indication of the trust signal.

13. The computer-implemented method of any one of Clauses 5 to 12, wherein the request comprises a request to view a profile associated with the second user, the computer-implemented method further comprising receiving the request prior to retrieving the one or more profiles from the data store.

14. The computer-implemented method of Clause 13, wherein the second user is a merchant, and the profile is a merchant profile.

15. The computer-implemented method of any one of Clauses 5 to 14, wherein each profile of the one or more profiles comprises at least one of a user purchase history, a user attribute, a user credit history, a user asset, or a combination thereof.

16. A payment service computing platform comprising:
one or more non-transitory computer-readable storage media including instructions; and
one or more processors coupled to the storage media, the one or more processors configured to execute the instructions to:
   retrieve, from a data store maintained by the payment service computing platform, one or more profiles of users having a relationship with a first user, wherein retrieving the one or more profiles is based at least in part on a request received from the first user in the context of a payment transaction with a second user;
   determine, based at least in part on the one or more profiles, an indirect relationship between the first user and the second user;
   determine, based at least in part on the determination of the indirect relationship, a trust signal associated with the second user; and
   cause a user interface to be displayed via a payment application executing on an electronic device associated with the first user, wherein the user interface comprises an indication of an identity of the second user and an indication of the trust signal.

17. The payment service computing platform of Clause 16, wherein the indication of the trust signal indicates one or more payments made between the second user and at least one user of the users, and wherein the at least one user is anonymized in the indication of the trust signal.

18. The payment service computing platform of Clause 16 or 17, wherein:
the trust signal is a first trust signal comprising a number of payments made between the second user and at least one of the users;
the one or more processors are further configured to execute the instructions to determine a second trust signal associated with the second user, the second trust signal comprising a date on which the second user established an account with the payment service computing platform; and
the user interface further comprises an indication of the second trust signal.

19. The payment service computing platform of any one of Clauses 16 to 18, wherein:
the trust signal is a first trust signal comprising a number of payments made between the second user and at least one of the users;
the one or more processors are further configured to execute the instructions to determine a second trust signal associated with the second user, the second trust signal comprising an indication of whether the second user is included in a list of contacts associated with the first user; and
the user interface further comprises an indication of the second trust signal.

20. The payment service computing platform of any one of Clauses 16 to 19, wherein the indication of the trust signal comprises a read-only trust signal.

21. A computer-implemented method comprising:
determining, by a payment service computing platform and based on interaction data associated with a first user and a plurality of users, a relationship between the first user and the plurality of users, wherein each of the plurality of users has an asset profile serviced by a payment service associated with the payment service computing platform;
causing, by the payment service computing platform, a first user interface of a payment application executing on an electronic device of the first user to display a plurality of interactive elements corresponding respectively to the plurality of users;
in response to determining an interaction with a first interactive element of the plurality of interactive elements corresponding to a second user of the plurality of users, and based on a setting that authorizes the first user to view a second asset profile of the second user, causing, by the payment service computing platform, a second user interface of the payment application to display the second asset profile and a second interactive element to request to purchase assets that substantially mirrors at least a portion of a set of assets owned by the second user and maintained by the payment service computing platform, wherein the second asset profile identifies the set of assets and the portion, and wherein the portion comprises an ownership amount in each of the set of assets;
determining, by the payment service computing platform, an interaction with the second interactive element and a specified value amount of the assets to be purchased;
determining, by the payment service computing platform, and based on the portion, units for each of the assets to be purchased in accordance with the specified value amount; and
assigning, by the payment service computing platform, ownership interest of the units to an account associated with the first user.

22. The computer-implemented method of Clause 21, wherein determining the relationship comprises utilizing, by the payment service computing platform, a machine-learning model to identify the plurality of users based on the interaction data.

23. The computer-implemented method of Clause 21 or 22, wherein the plurality of users comprises one or more influencer-marketing users, one or more users in a contacts list of the first user, one or more users having interests associated with the first user, one or more users owning assets associated with the first user, or one or more users associated with a currently trending asset.

24. The computer-implemented method of any one of Clauses 21 to 23, wherein each asset profile comprises one or more of a performance metric, an asset owned, a particular asset allocation percentage, an asset time held metric, or a listing of one or more assets with which a respective user previously interacted.

25. A computer-implemented method comprising:
determining, by a payment service computing platform, and based at least in part on interaction data associated with a first user and one or more users, a relationship between the one or more users and the first user, wherein each of the one or more users has an asset profile serviced by a payment service associated with the payment service computing platform;
in response to determining an interaction with a first interactive element corresponding to a second user of the one or more users, causing, by the payment service computing platform, a payment application associated with the payment service and executing on an electronic device of the first user to display a second asset profile of the second user and a second interactive element to request to purchase assets that correspond to an allocation of a set of assets owned by the second user and maintained by the payment service computing platform, wherein the second asset profile identifies the set of assets and the allocation of the set of assets, wherein the allocation of the set of assets comprises an ownership amount in each of the set of assets;
receiving, by the payment service computing platform, a request to purchase a subset of the set of assets based at least in part on an interaction with the second interactive element;
determining, by the payment service computing platform, and based at least in part on the allocation of the set of assets, units for each of the assets of the subset to be purchased in accordance with a specified value amount of the subset to be purchased; and
assigning, by the payment service computing platform, ownership interest of the units to an account associated with the first user.

26. The computer-implemented method of Clause 25, wherein determining the relationship comprises utilizing, by the payment service computing platform, a machine-learning model to identify the one or more users based at least in part on the interaction data.

27. The computer-implemented method of Clause 25 or 26, wherein the one or more users comprises one or more influencer-marketing users, one or more users in a contacts list of the first user, one or more users having interests associated with the first user, one or more users owning assets associated with the first user, or one or more users associated with a currently trending asset.

28. The computer-implemented method of any one of Clauses 25 to 27, wherein each asset profile comprises one or more of a performance metric, an asset owned, an asset allocation percentage, an asset time held metric, or a listing of one or more assets with which a respective user previously interacted.

29. The computer-implemented method of any one of Clauses 25 to 28, further comprising:
receiving, by the payment service computing platform, and from the payment application executing on the electronic device of the first user, a request to view one or more asset profiles of users associated with the first user; and
subsequent to determining the relationship based at least in part on the request to view the one or more asset profiles, causing, by the payment service computing platform, a user interface of the payment application executing on the electronic device of the first user to display one or more interactive elements corresponding respectively to the one or more users, wherein the one or more interactive elements include the first interactive element, and wherein each of the one or more interactive elements are configured to be interacted with to view a corresponding asset profile of a corresponding user of the one or more users.

30. The computer-implemented method of Clause 29, further comprising:
receiving, by the payment service computing platform, and from a second payment application associated with the payment service and executing on a second electronic device associated with the second user, a second request to view the second asset profile; and
determining, by the payment service computing platform, a user selection corresponding to a request to restrict access to one or more of the set of assets, the allocation of the set of assets, or additional asset data associated with the second asset profile.

31. The computer-implemented method of Clause 30, wherein the request to restrict access comprises a request to enable a paywall restricting access to the one or more of the set of assets, the allocation of the set of assets, or the additional asset data associated with the second asset profile based at least in part on a subscription status of the first user.

32. The computer-implemented method of Clause 30, further comprising:
receiving, by the payment service computing platform, and from the second payment application executing on the second electronic device associated with the second user, a third request to share an instance corresponding to the second asset profile; and
in response to receiving the third request, sharing, by the payment service computing platform, the instance corresponding to the second asset profile via the payment application executing on the electronic device of the first user.

33. The computer-implemented method of Clause 32, wherein sharing the instance corresponding to the second asset profile comprises sharing the instance via a service external to the payment service computing platform.

34. The computer-implemented method of Clause 29, wherein, in response to determining the interaction with the first interactive element corresponding to the second user, the computer-implemented method further comprises:
causing, by the payment service computing platform, a second user interface of the payment application executing on the electronic device of the first user to display the second asset profile based at least in part on a determination that the first user follows the second user.

35. The computer-implemented method of Clause 29, wherein, in response to determining the interaction with the first interactive element corresponding to the second user, the computer-implemented method further comprises:
causing, by the payment service computing platform, a second user interface of the payment application executing on the electronic device of the first user to display the second asset profile based at least in part on a determination that the first user is authorized to view the second asset profile.

36. The computer-implemented method of any one of Clauses 25 to 35, wherein the one or more users comprises a predetermined group of users sharing at least one characteristic.

37. The computer-implemented method of any one of Clauses 25 to 36, further comprising assigning, by the payment service computing platform, additional ownership interest of the units to respective accounts associated with each of the one or more users.

38. The computer-implemented method of any one of Clauses 25 to 37, wherein the units comprise fractional units.

39. A payment service computing platform comprising:
one or more non-transitory computer-readable storage media including instructions; and
one or more processors coupled to the storage media, the one or more processors configured to execute the instructions to:
   determine, based at least in part on interaction data associated with a first user and one or more users, a relationship between the one or more users and the first user, wherein each of the one or more users has an asset profile serviced by a payment service associated with the payment service computing platform;
   in response to determining an interaction with a first interactive element corresponding to a second user of the one or more users, cause a payment application associated with the payment service and executing on an electronic device of the first user to display a second asset profile of the second user and a second interactive element to request to purchase assets that correspond to an allocation of a set of assets owned by the second user and maintained by the payment service computing platform, wherein the second asset profile identifies the set of assets and an allocation of the set of assets, wherein the allocation the set of assets comprises an ownership amount in each of the set of assets;
   receive a request to purchase a subset of the set of assets based at least in part on an interaction with the second interactive element;
   determine, based at least in part on the allocation of the set of assets, units for each of the assets of the subset to be purchased in accordance with a specified value amount of the subset to be purchased; and
   assign ownership interest of the units to an account associated with the first user.

40. The payment service computing platform of Clause 39, wherein the one or more processors are further configured to execute the instructions to:
receive from a second payment application associated with the payment service and executing on a second electronic device associated with the second user, a second request from the second user to view the second asset profile; and
determine a user selection corresponding to a request to restrict access to one or more of the set of assets, the allocation of the set of assets, or additional asset data associated with the second asset profile.

41. A computer-implemented method comprising:
generating, by a payment service computing platform, a token associated with a first account associated with a payment service associated with the payment service computing platform, the token being configured to facilitate a transfer of an amount from the first account to a second account of a second user;
providing, by the payment service computing platform, the token through a communication platform to the second user;
receiving, by the payment service computing platform, a first request, from an electronic device of the second user associated with the second account, to redeem the amount associated with the token;
in response to receiving the first request, and without further input from the second user:
   identifying, by the payment service computing platform, and utilizing a machine-learning model trained to infer a preference of at least one of the first user or the second user, an asset to be acquired via redemption of the token;
   facilitating, by the payment service computing platform, acquisition of the asset; and
   associating, by the payment service computing platform, ownership interest in the asset in the amount associated with the token with the second account.

42. The computer-implemented method of Clause 41, wherein identifying the asset comprises identifying the asset based at least in part on one or more social nodes associated with the second user, wherein the one or more social nodes are determined based at least in part on a transaction history of the second user or a user interaction of the second user.

43. The computer-implemented method of Clause 41 or 42, further comprising:
determining, by the payment service computing platform, that the second user does not have an asset profile associated with the payment service;
creating, by the payment service computing platform, the asset profile of the second user; and
associating, by the payment service computing platform, the ownership interest in the asset with the asset profile of the second user.

44. The computer-implemented method of any one of Clauses 41 to 43, wherein providing the token through the communication platform comprises providing, by the payment service computing platform, the token through an application or a service external to the payment service computing platform.

45. The computer-implemented method of any one of Clauses 41 to 44, wherein associating the ownership interest in the asset in the amount associated with the token comprises:
determining corresponding fractional units for the asset to be purchased in association with the amount associated with the token; and
associating the fractional units with the second account.

46. A computer-implemented method comprising:
generating, by a payment service computing platform, a token associated with a first account associated with a payment service associated with the payment service computing platform, the token being configured to facilitate a number of transfers of an amount from the first account to one or more second accounts;
receiving, by the payment service computing platform, a first request, from an electronic device of a second user associated with the one or more second accounts, to redeem the amount associated with the token;
facilitating, by the payment service computing platform, acquisition of one or more assets for the second user, wherein the one or more assets are determined by the second user or automatically based at least in part on a machine-learning model trained to infer a preference of at least one of the first user or the second user; and
associating, by the payment service computing platform, the one or more assets with a second account of the second user.

47. The computer-implemented method of Clause 46, wherein the one or more assets comprise fractional units of assets that equal the amount associated with the token.

48. The computer-implemented method of Clause 46 or 47, further comprising determining, by the payment service computing platform, one or more third users associated with the second user based on a transaction history of the second user or a user interaction of the second user, wherein the machine-learning model is trained to infer the preference of the second user based at least in part on the one or more third users.

49. The computer-implemented method of any one of Clauses 46 to 48, wherein facilitating the acquisition of the one or more assets for the second user comprises:
causing, by the payment service computing platform, a user interface of a payment application executing on the electronic device of the second user to display the one or more assets in association with the amount associated with the token; and
determining, by the payment service computing platform, an interaction corresponding to a second request from the second user to acquire the one or more assets.

50. The computer-implemented method of Clause 49, further comprising:
determining, by the payment service computing platform, that the second user does not have an asset profile associated with the payment service;
creating, by the payment service computing platform, the asset profile of the second user; and
associating, by the payment service computing platform, ownership interest in the one or more assets with the asset profile of the second user.

51. The computer-implemented method of any one of Clauses 46 to 50, further comprising providing, by the payment service computing platform, the token through a communication platform to the second user.

52. The computer-implemented method of Clause 51, wherein providing the token through the communication platform comprises providing, by the payment service computing platform, the token through an application or a service external to the payment service computing platform.

53. The computer-implemented method of any one of Clauses 46 to 52, wherein the one or more assets comprises one or more fiat currencies, one or more cryptocurrencies, one or more bonds, one or more stocks, one or more mutual funds, one or more non-fungible tokens (NFTs), or a combination thereof.

54. The computer-implemented method of any one of Clauses 46 to 53, wherein the one or more assets are determined by identifying the one or more assets based at least in part on one or more social nodes associated with the second user, wherein the one or more social nodes are determined based at least in part on a transaction history of the second user or a user interaction of the second user.

55. A payment service computing platform comprising:
one or more non-transitory computer-readable storage media including instructions; and
one or more processors coupled to the storage media, the one or more processors configured to execute the instructions to:
   generate a token associated with a first account associated with a payment service associated with the payment service computing platform, the token being configured to facilitate a number of transfers of an amount from the first account to one or more second accounts;
   receive a first request, from an electronic device of a second user associated with the one or more second accounts, to redeem the amount associated with the token;
   facilitate acquisition of one or more assets for the second user, wherein the one or more assets are determined by the second user or based at least in part on a machine-learning model trained to infer a preference of at least one of the first user or the second user; and
   associate the one or more assets with a second account of the second user.

56. The payment service computing platform of Clause 55, wherein the one or more assets comprise fractional units of assets that equal the amount associated with the token.

57. The payment service computing platform of Clause 55 or 56, wherein the one or more processors are further configured to execute the instructions to determine one or more third users associated with the second user based at least in part on a transaction history of the second user or a user interaction of the second user, wherein the machine-learning model is trained to infer the preference of the second user based at least in part on the one or more third users.

58. The payment service computing platform of any one of Clauses 55 to 57, wherein facilitating the acquisition of the one or more assets for the second user comprises:
causing a user interface of a payment application executing on the electronic device of the second user to display the one or more assets in association with the amount associated with the token; and
determining one or more user interactions corresponding to a second request from the second user to acquire the one or more assets.

59. The payment service computing platform of Clause 58, wherein the one or more processors are further configured to execute the instructions to:
determine that the second user does not have an asset profile associated with the payment service;
create the asset profile of the second user; and
associate ownership interest in the one or more assets with the asset profile of the second user.

60. The payment service computing platform of any one of Clauses 55 to 59, wherein the one or more assets are determined by identifying the one or more of assets based at least in part on one or more social nodes associated with the second user, wherein the one or more social nodes are determined based at least in part on a transaction history of the second user or a user interaction of the second user.

What is claimed is:

1. A computer-implemented method comprising:
generating, by a payment service computing platform, a token associated with a first account associated with a payment service associated with the payment service computing platform, the token being configured to facilitate a transfer of an amount from the first account to a second account of a second user;
providing, by the payment service computing platform, the token through a communication platform to the second user;
receiving, by the payment service computing platform, a first request, from an electronic device of the second user associated with the second account, to redeem the amount associated with the token;
in response to receiving the first request, and without further input from the second user:
identifying, by the payment service computing platform, and utilizing a machine-learning model trained to infer a preference of at least one of the first user or the second user, an asset to be acquired via redemption of the token;
facilitating, by the payment service computing platform, acquisition of the asset; and
associating, by the payment service computing platform, ownership interest in the asset in the amount associated with the token with the second account.

2. The computer-implemented method of claim 1, wherein identifying the asset comprises identifying the asset based at least in part on one or more social nodes associated with the second user, wherein the one or more social nodes are determined based at least in part on a transaction history of the second user or a user interaction of the second user.

3. The computer-implemented method of claim 1, further comprising:
determining, by the payment service computing platform, that the second user does not have an asset profile associated with the payment service;
creating, by the payment service computing platform, the asset profile of the second user; and
associating, by the payment service computing platform, the ownership interest in the asset with the asset profile of the second user.

4. The computer-implemented method of claim 1, wherein providing the token through the communication platform comprises providing, by the payment service computing platform, the token through an application or a service external to the payment service computing platform.

5. The computer-implemented method of claim 1, wherein associating the ownership interest in the asset in the amount associated with the token comprises:
determining corresponding fractional units for the asset to be purchased in association with the amount associated with the token; and
associating the fractional units with the second account.

6. A computer-implemented method comprising:
generating, by a payment service computing platform, a token associated with a first account associated with a payment service associated with the payment service computing platform, the token being configured to facilitate a number of transfers of an amount from the first account to one or more second accounts;
receiving, by the payment service computing platform, a first request, from an electronic device of a second user associated with the one or more second accounts, to redeem the amount associated with the token;
facilitating, by the payment service computing platform, acquisition of one or more assets for the second user, wherein the one or more assets are determined by the second user or automatically based at least in part on a machine-learning model trained to infer a preference of at least one of the first user or the second user; and
associating, by the payment service computing platform, the one or more assets with a second account of the second user.

7. The computer-implemented method of claim 6, wherein the one or more assets comprise fractional units of assets that equal the amount associated with the token.

8. The computer-implemented method of claim 6, further comprising determining, by the payment service computing platform, one or more third users associated with the second user based on a transaction history of the second user or a user interaction of the second user, wherein the machine-learning model is trained to infer the preference of the second user based at least in part on the one or more third users.

9. The computer-implemented method of claim 6, wherein facilitating the acquisition of the one or more assets for the second user comprises:
causing, by the payment service computing platform, a user interface of a payment application executing on the electronic device of the second user to display the one or more assets in association with the amount associated with the token; and
determining, by the payment service computing platform, an interaction corresponding to a second request from the second user to acquire the one or more assets.

10. The computer-implemented method of claim 9, further comprising:
determining, by the payment service computing platform, that the second user does not have an asset profile associated with the payment service;
creating, by the payment service computing platform, the asset profile of the second user; and
associating, by the payment service computing platform, ownership interest in the one or more assets with the asset profile of the second user.

11. The computer-implemented method of claim 6, further comprising providing, by the payment service computing platform, the token through a communication platform to the second user.

12. The computer-implemented method of claim 11, wherein providing the token through the communication platform comprises providing, by the payment service computing platform, the token through an application or a service external to the payment service computing platform.

13. The computer-implemented method of claim 6, wherein the one or more assets comprises one or more fiat currencies, one or more cryptocurrencies, one or more bonds, one or more stocks, one or more mutual funds, one or more non-fungible tokens (NFTs), or a combination thereof.

14. The computer-implemented method of claim 6, wherein the one or more assets are determined by identifying the one or more assets based at least in part on one or more social nodes associated with the second user, wherein the one or more social nodes are determined based at least in part on a transaction history of the second user or a user interaction of the second user.

15. A payment service computing platform comprising:
one or more non-transitory computer-readable storage media including instructions; and
one or more processors coupled to the storage media, the one or more processors configured to execute the instructions to:
generate a token associated with a first account associated with a payment service associated with the payment service computing platform, the token being configured to facilitate a number of transfers of an amount from the first account to one or more second accounts;
receive a first request, from an electronic device of a second user associated with the one or more second accounts, to redeem the amount associated with the token;
facilitate acquisition of one or more assets for the second user, wherein the one or more assets are determined by the second user or based at least in part on a machine-learning model trained to infer a preference of at least one of the first user or the second user; and
associate the one or more assets with a second account of the second user.

16. The payment service computing platform of claim 15, wherein the one or more assets comprise fractional units of assets that equal the amount associated with the token.

17. The payment service computing platform of claim 15, wherein the one or more processors are further configured to execute the instructions to determine one or more third users associated with the second user based at least in part on a transaction history of the second user or a user interaction of the second user, wherein the machine-learning model is trained to infer the preference of the second user based at least in part on the one or more third users.

18. The payment service computing platform of claim 15, wherein facilitating the acquisition of the one or more assets for the second user comprises:
causing a user interface of a payment application executing on the electronic device of the second user to display the one or more assets in association with the amount associated with the token; and
determining one or more user interactions corresponding to a second request from the second user to acquire the one or more assets.

19. The payment service computing platform of claim 18, wherein the one or more processors are further configured to execute the instructions to:
determine that the second user does not have an asset profile associated with the payment service;
create the asset profile of the second user; and
associate ownership interest in the one or more assets with the asset profile of the second user.

20. The payment service computing platform of claim 15, wherein the one or more assets are determined by identifying the one or more of assets based at least in part on one or more social nodes associated with the second user, wherein the one or more social nodes are determined based at least in part on a transaction history of the second user or a user interaction of the second user.
